(19) United States
(12) Patent Application Publication
(10) Pub. No.: US 2026/0317544 A1
(43) Pub. Date: Oct. 15, 2026

(54) BINDER COMPOSITIONS AND USE THEREOF

(71) Applicant: NILO LIMITED, Remuera, Auckland (NZ)

(72) Inventors: Simon David OAKLEY, Auckland (NZ); Philip Kenneth COVENY, Remuera, Auckland (NZ); Aditya Milind RUDRAKAR, Remuera, Auckland (NZ); Niko Robert FORLONG, Remuera, Auckland (NZ)

(73) Assignee: NILO LIMITED, Remuera, Auckland (NZ)

(21) Appl. No.: 18/877,958

(22) PCT Filed: Dec. 1, 2023
(86) PCT No.: PCT/IB2023/062113

§ 371 Date: Dec. 20, 2024

(30) Foreign Application Priority Data
Dec. 1, 2022 (AU) 2022279505

(51) Int. Cl. C08L 97/02; C08K 5/29; C08K 7/02; C08K 7/14; C08K 11/00; C08L 23/06; C08L 23/12

(52) U.S. Cl. CPC C08L 97/02; C08K 5/29; C08K 7/02; C08K 7/14; C08K 11/00; C08L 23/06; C08L 23/12

(57) ABSTRACT

Described is a method of producing a thermoplastic binder from virgin and/or waste plastic in an extruder and the use of the binder to produce a thermoplastic composite product, such as a composite board. A portion of the thermoplastic may be reacted with a coupling agent to produce a functionalised thermoplastic, and/or dispersed in water under agitation to produce a thermoplastic dispersion.

### FIELD OF THE INVENTION

The present invention relates to a method for making a binder and use therefore in the manufacture of a plastic composite product.

### BACKGROUND TO THE INVENTION

Plastic is a widely used material in both household and industrial items. Many countries are struggling to dispose or utilise the waste plastic in an economical and safe manner. The recycling of plastic into other goods is known, but requires energy and resources to wash the plastic, reduce it to a desired particle size from its original form and then re-utilise it in a recycled product.

Binders are used for a variety of applications for industrial and consumer applications. One such binder is urea-formaldehyde (UF) so named for its common synthesis pathway and overall structure. UF products are thermosetting resins or polymers which are used as binders/adhesives. However, UF binders have disadvantages such as volatile organic compound emissions which can cause deleterious health effects, energy-intensive production processes, and associated regulatory hurdles. Thus, there is a need for alternative binding agents. In addition, UF adhesives undergo a condensation reaction to bond materials which is reversible, especially under specific environmental conditions. In humid or wet areas, the UF bond can hydrolyze, meaning the bond can break down and revert to its original components. This hydrolysis leads to a reduction in bond strength and durability, making UF adhesives less suitable for use in environments where they are exposed to moisture, and leading to potential failures in the structural integrity of the bonded product.

Plastic waste poses a range of environmental, economic, and social challenges. These include environmental impacts arising from non-biodegradability such as marine pollution harming marine life, chemical leaching of harmful products and by-products into the food chain, microplastic pollution and air pollution where plastics are burned for energy. Thus there is a need to reduce, reuse and recycle plastic waste to extend its useful life, and reduce its deleterious effects on the environment.

It is an object of the present invention to provide a method for manufacturing a binder and optionally its use thereof, or to at least provide the public with a useful choice.

### SUMMARY OF THE INVENTION

According to a first aspect, there is described a method of producing a thermoplastic binder comprising
providing a source of thermoplastic,
introducing the thermoplastic into an inlet end of one or more extruders,
within the one or more extruders, substantially melting the thermoplastic to define a melt zone, wherein
a) at least a portion thereof of the thermoplastic is reacted with a coupling agent to produce a functionalised thermoplastic,
b) dispersing the thermoplastic in water under agitation to define an emulsification zone, to produce a thermoplastic dispersion, or
c) performing (a) and subsequently (b) to produce a functionalised thermoplastic dispersion.

According to a first aspect, there is described a method of producing a thermoplastic binder consisting of
providing a source of thermoplastic,
introducing the thermoplastic into an inlet end of one or more extruders,
within the one or more extruders, substantially melting the thermoplastic to define a melt zone, wherein
a) at least a portion thereof of the thermoplastic is reacted with a coupling agent to produce a functionalised thermoplastic,
b) dispersing the thermoplastic in water under agitation to define an emulsification zone, to produce a thermoplastic dispersion, or
c) performing (a) and subsequently (b) to produce a functionalised thermoplastic dispersion.

According to a first aspect, there is described a method of producing a thermoplastic binder consisting essentially of
providing a source of thermoplastic,
introducing the thermoplastic into an inlet end of one or more extruders,
within the one or more extruders, substantially melting the thermoplastic to define a melt zone, wherein
a) at least a portion thereof of the thermoplastic is reacted with a coupling agent to produce a functionalised thermoplastic,
b) dispersing the thermoplastic in water under agitation to define an emulsification zone, to produce a thermoplastic dispersion, or
c) performing (a) and subsequently (b) to produce a functionalised thermoplastic dispersion.

According to a first aspect, there is described a method of producing a thermoplastic binder comprising
providing a source of thermoplastic,
introducing the thermoplastic into an inlet end of one or more extruders,
within the one or more extruders, substantially melting the thermoplastic to define a melt zone, wherein
a) at least a portion thereof of the thermoplastic is reacted with a coupling agent to produce a functionalised thermoplastic,
b) dispersing the thermoplastic in water under agitation to define an emulsification zone, to produce a thermoplastic dispersion, or
c) performing (a) and subsequently (b) to produce a functionalised thermoplastic dispersion; and
   wherein
i) the source of thermoplastic comprises a ratio of high-melt thermoplastic to low-melt thermoplastic is from 1:4 to 4:1,
ii) the coupling agent, if present, is present at 3% to 10% by weight of the thermoplastic,
or
iii) moisture content??
iv) (i) and (ii).

According to another aspect, there is described a method of producing a binder comprising
obtaining a processed thermoplastic as
   a functionalised thermoplastic, the functionalised thermoplastic having been processed by substantially melting a thermoplastic in an extruder to define an extruder melt zone, and reacting the thermoplastic with a coupling agent in the extruder,
   a thermoplastic dispersion, the thermoplastic dispersion having been processed by substantially melting a thermoplastic in an extruder to define an extruder melt zone, and subsequently dispersing the thermoplastic in water under agitation in an extruder emulsification zone, or
   a functionalised thermoplastic dispersion, the functionalised thermoplastic dispersion having been processed by
      substantially melting a thermoplastic in an extruder to define an extruder melt zone,
      reacting the thermoplastic with a coupling agent in an extruder to produce a functionalised thermoplastic, and
      subsequently dispersing the functionalised thermoplastic in water under agitation in an extruder emulsification zone; and
subsequently adding a crosslinker to the processed thermoplastic to produce a binder.

According to another aspect, there is described a method of producing a thermoplastic composite product comprising
obtaining a binder as
   a functionalised thermoplastic,
   a thermoplastic dispersion, or
   a functionalised thermoplastic dispersion;
wherein the binder has been formed by introducing a thermoplastic into an inlet end of one or more extruders, and within the one or more extruders, substantially melting the thermoplastic,
mixing the binder with a substrate, in the form of a fibre, to form a composite mixture and applying heat and pressure to the composite mixture in a press or mould to form a thermoplastic composite product.

According to another aspect, there is described a method of producing a thermoplastic binder comprising
providing a source of thermoplastic,
introducing the thermoplastic into an inlet end of one or more extruders,
within the one or more extruders, substantially melting the thermoplastic to define a melt zone, wherein
a) at least a portion thereof of the thermoplastic is reacted with a coupling agent to produce a functionalised thermoplastic,
b) dispersing the thermoplastic in water under agitation to define an emulsification zone, to produce a thermoplastic dispersion, or
c) performing (a) and subsequently (b) to produce a functionalised thermoplastic dispersion
subsequently adding a crosslinker to the functionalised thermoplastic or thermoplastic dispersion, the crosslinker being added to the extruder, or to the extruded functionalised thermoplastic or thermoplastic dispersion, to produce a thermoplastic binder.

According to another aspect, there is described a method of producing a thermoplastic composite product comprising:
providing a source of thermoplastic,
introducing the thermoplastic into an inlet end of one or more extruders,
within the one or more extruders, substantially melting the thermoplastic to define a melt zone, wherein
a) at least a portion thereof of the thermoplastic is reacted with a coupling agent to produce a functionalised thermoplastic,
b) dispersing the thermoplastic in water under agitation to produce a thermoplastic dispersion, or
c) performing (a) and subsequently (b) to produce a functionalised thermoplastic dispersion; and
mixing the extruded functionalised thermoplastic or thermoplastic dispersion with a substrate, in the form of a fibre, to form a composite mixture and applying heat and pressure to the composite mixture in a press or mould to form a thermoplastic composite product.

According to another aspect, there is described a method of producing a thermoplastic composite product comprising:
providing a source of thermoplastic,
introducing the thermoplastic into an inlet end of one or more extruders,
within the one or more extruders, substantially melting the thermoplastic to define a melt zone, wherein
a) at least a portion thereof of the thermoplastic is reacted with a coupling agent to produce a functionalised thermoplastic,
b) dispersing the thermoplastic in water under agitation to produce a thermoplastic dispersion, or
c) performing (a) and subsequently (b) to produce a functionalised thermoplastic dispersion; and
subsequently adding a crosslinker to the functionalised thermoplastic or thermoplastic dispersion, the cross linker being added to the extruder, or to the extruded functionalised thermoplastic or thermoplastic dispersion, to produce a binder, and
mixing the binder with a substrate in the form of a fibre to form a composite mixture and applying heat and pressure to the composite mixture in a press or mould to form a thermoplastic composite product.

According to another aspect, there is described a composite board comprising:
waste thermoplastic;
lignocellulosic material; and
a cross-linker,
wherein the lignocellulosic material comprises at least 75% of the composite board.

According to another aspect, there is described a thermoplastic dispersion comprising functionalised waste thermoplastic and water, and
the thermoplastic comprises at least one of a high-melt thermoplastic such as poly-propylene, and a low melt thermoplastic such as polyethylene, and
wherein the water is present in the dispersion at between about 25% to 75%.

In another aspect there is described a method of producing a thermoplastic dispersion comprising
feeding a thermoplastic into one or more extruders, which may be modular, to melt the thermoplastic,
adding a coupling agent into the extruder to produce a functionalised thermoplastic,
emulsifying the functionalised thermoplastic with the addition of water and surfactant and the application of shear force, to produce a particularised functionalised thermoplastic dispersion.

In a further aspect there is described a method of producing a thermoplastic dispersion comprising
feeding a thermoplastic into one or more extruders, which may be modular, to melt the thermoplastic,
adding a coupling agent into the extruder to produce a functionalised thermoplastic,
emulsifying the functionalised thermoplastic with the addition of water and surfactant and the application of shear force, to produce a particularised functionalised thermoplastic dispersion,
adding one or more cross-linkers to the particularised functionalised thermoplastic dispersion which preferably bind with the functionalised thermoplastic of the particularised functionalised thermoplastic dispersion.

In a further aspect there is described a method of producing a plastic dispersion comprising
providing one or more extruders comprising
a housing having an inlet end and outlet end,
introducing thermoplastic into an inlet end of the one or more twin-screw extruders,
within the one or more twin-screw extruders substantially melting the thermoplastic to define a melt zone, and wherein at least a portion thereof of the thermoplastic has been, or is, reacted with a coupling agent selected from
a) a grafting compatibiliser, or
b) a reactive hydrogen provider,
c) or both (a) and (b),
provided that
   where the method comprises a single twin-screw extruder process, all of the processed thermoplastic is reacted with a coupling agent, or
   where the method comprises one or more twin-screw extruders used simultaneously or sequentially, to define a functionalising extruder process comprising a coupling agent and a non-functionalising extruder process excluding a coupling agent, at least 10% by weight of the thermoplastic is processed through the functionalising extruder process, to define a functionalised molten thermoplastic,
emulsifying the functionalised molten thermoplastic by mixing the functionalised molten thermoplastic with a first water amount and, a surfactant and with shear force and with a second water amount downstream of the first water amount, sufficient to form functionalised thermoplastic having an average particle size of less than 0.5 mm to define an emulsification zone, to produce a functionalised thermoplastic dispersion having the water as the continuous phase, and
extruding the dispersion via the outlet end of one of the one or more extruders, the dispersion comprising functionalised plastic particles with an average particle size of less than 0.5 mm.

In a further aspect there is described a method of producing a plastic dispersion comprising
providing one or more extruders comprising
a housing having an inlet end and outlet end,
introducing thermoplastic into an inlet end of the one or more extruders,
within the one or more twin-screw extruders substantially melting the thermoplastic to define a melt zone, and wherein at least a portion thereof of the thermoplastic has been, or is, reacted with a coupling agent selected from
a) a grafting compatibiliser, or
b) a reactive hydrogen provider,
c) or both (a) and (b),
provided that
   where the method comprises a single extruder process, all of the processed thermoplastic is reacted with a coupling agent, or
   where the method comprises one or more extruders used simultaneously or sequentially, to define a functionalising extruder process comprising a coupling agent and a non-functionalising extruder process excluding a coupling agent, at least 10% by weight of the thermoplastic is processed through the functionalising extruder process,
to define a functionalised molten thermoplastic,
emulsifying the functionalised molten thermoplastic by mixing the functionalised molten thermoplastic with a first water amount and, a surfactant and with shear force and with a second water amount downstream of the first water amount, sufficient to form functionalised thermoplastic having an average particle size of less than 0.5 mm to define an emulsification zone, to produce a functionalised thermoplastic dispersion having the water as the continuous phase, and
adding a cross-linker in liquid form, and optionally further water, to the functionalised thermoplastic dispersion at a temperature, within the one or more extruders, insufficient to chemically activate the cross-linker, and
extruding the dispersion via the outlet end of one of the one or more extruders, the dispersion comprising functionalised plastic particles with an average particle size of less than 0.5 mm.

In a further aspect there is described a method of producing a lignocellulose-thermoplastic composite product comprising
providing one or more extruders comprising
a housing having an inlet end and outlet end,
introducing thermoplastic into an inlet end of the one or more extruders,
within the one or more twin-screw extruders substantially melting the thermoplastic to define a melt zone, and wherein at least a portion thereof of the thermoplastic has been, or is, reacted with a coupling agent selected from
a) a grafting compatibiliser, or
b) a reactive hydrogen provider,
c) or both (a) and (b),
provided that
   where the method comprises a single twin-screw extruder process, all of the processed thermoplastic is reacted with a coupling agent, or
   where the method comprises one or more twin-screw extruders used simultaneously or sequentially, to define a functionalising extruder process comprising a coupling agent and a non-functionalising extruder process excluding a coupling agent, at least 10% by weight of the thermoplastic is processed through the functionalising extruder process,
to define a functionalised molten thermoplastic,
emulsifying the functionalised molten thermoplastic by mixing the functionalised molten thermoplastic with a first water amount and, a surfactant and with shear force and with a second water amount downstream of the first water amount, sufficient to form functionalised thermoplastic having an average particle size of less than 0.5 mm to define an emulsification zone, to produce a functionalised thermoplastic dispersion having the water as the continuous phase, and
adding a cross-linker in liquid form, and optionally further water, to the functionalised thermoplastic dispersion at a temperature, within the one or more extruders, insufficient to chemically activate the cross-linker,
extruding the dispersion via the outlet end of one of the one or more twin-screw extruders, the dispersion comprising functionalised plastic particles with an average particle size of less than 0.5 mm,
optionally drying the dispersion to less than 3% by weight water content to form a binder, and
mixing the binder with lignocellulosic material/fibre to form a composite mixture and applying heat and pressure to the composite mixture in a press to form a lignocellulose-thermoplastic composite.

In a further aspect there is described a method of producing a lignocellulose-thermoplastic composite product comprising
providing one or more extruders comprising
a housing having an inlet end and outlet end,
introducing thermoplastic into an inlet end of the one or more extruders,
within the one or more extruders substantially melting the thermoplastic to define a melt zone,
emulsifying the functionalised molten thermoplastic by exposing the functionalised molten thermoplastic to water, a surfactant and shear force sufficient to form functionalised thermoplastic having an average particle size of less than 0.5 mm, to define an emulsification zone, to produce a functionalised thermoplastic dispersion having the water as the continuous phase,
adding an organic peroxide-based cross-linker in liquid form, and optionally water, to the functionalised thermoplastic dispersion at a temperature, within the one or more extruders, insufficient to chemically activate the cross-linker,
extruding the dispersion via the outlet end of one of the one or more extruders, the dispersion comprising functionalised plastic particles with an average particle size of less than 0.5 mm,
drying the dispersion to less than 3% by weight water content to form a binder, and
mixing the binder with cellulosic fibre to form a composite mixture and applying heat and pressure to the composite mixture in a press to form a lignocellulose-thermoplastic composite.

Any one or more of the following configurations may relate to any of the above aspects described herein or any combination thereof.

In some configurations, the method may further comprise adding a crosslinker to the functionalised thermoplastic or thermoplastic dispersion, the cross linker being added to the extruder, or to the extruded functionalised thermoplastic or thermoplastic dispersion, to produce a binder.

In some configurations, the extruder is a twin screw extruder.

In some configurations twin screw extruder comprises two rotating screws within the housing between the inlet end and the outlet end of the extruder.

In some configurations, the thermoplastic comprises waste plastic.

In some configurations, the thermoplastic may comprise a high-melt thermoplastic such as polypropylene, and a low melt thermoplastic such as polyethylene, or a combination thereof.

In some configurations, the ratio of high-melt thermoplastic to low-melt thermoplastic is from 1:4 to 4:1.

In some configurations, the thermoplastic may be subjected to a pre-processing step comprising
a) increasing the melt flow index of the thermoplastic,
b) washing the thermoplastic,
c) comminuting the thermoplastic to reduce the variance of a particle size of the thermoplastic,
d) size/density standardisation,
e) palletisation to a particle size of 2-8 mm, or
f) any combination of one or more of (a) to (e).

In some configurations, the thermoplastic is subjected to a characterising step that analyses one or more physical property of the thermoplastic.

In some configurations comprising the pre-processing step, increasing the melt flow index of the thermoplastic comprises processing the thermoplastic through an extruder.

In some configurations comprising the pre-processing step, increasing the melt flow index of the thermoplastic comprises the addition of a melt-flow increasing additive to the extruder.

In some configurations, the melt-flow increasing additive is selected from a plasticiser, an initiator, and a combination thereof.

In some configurations comprising the pre-processing step, increasing the melt flow index of the thermoplastic comprises the addition of a further thermoplastic with a higher melt-flow index.

In some configurations comprising the characterising step, the physical property of the thermoplastic comprises the melt-flow index, melting point, viscosity, glass transition temperature, density, tensile strength or crystallinity of the thermoplastic.

In some configurations, the coupling agent is selected from a grafting compatibiliser or a reactive hydrogen provider.

In some configurations, the coupling agent is selected from glycidyl methacrylate, maleic anhydride, acrylic acid, glycidyl methacrylate, N-vinylformamide, bismaleimide or a silane.

In some configurations at least a portion of the thermoplastic is reacted with an initiator in the extruder.

In some configurations, the thermoplastic is dispersed in water with the addition of a surfactant.

In some configurations, the cross linker is selected from an organic peroxide or an isocyanate.

In some configurations, an isocyanate is added at 5% to 20% by weight of the binder.

In some configurations the isocyanate is a blocked isocyanate.

In some configurations, the isocyanate is a diisocyanate.

In some configurations, the blocked isocyanate is added to the extruder which has cooled to a temperature less than the unblocking temperature of the isocyanate blocking agent.

In some configurations, the moisture content of the binder is about 25% to about 75%.

In some configurations, the emulsification zone comprises a dilution zone for the addition of further water, to obtain a ratio of thermoplastic to water of about 0.8:1 to 1.8:1.

In some configurations, the binder and the substrate fibre are mixed in a mixer to form a substantially homogeneous mixture.

In some configurations, the substrate fibre is selected from glass fibre, carbon fibre, aramid fibre and a combination thereof.

In some configurations, the substrate fibre is selected from a lignocellulosic material selected from sawdust, wood fibre, wood particles, wood chips, wood sheets, coconut husk, rice straw or husk, barley straw, bamboo and a combination thereof.

In some configurations, where the method comprises the step of forming a thermoplastic composite product, the composite mixture has a moisture content of around 5% to around 15%.

In some configurations the plastic particles in the thermoplastic dispersion or the binder have a particle size of less than 0.5 mm in length in any orientation or axis.

In some configurations, the temperature of the melt zone is between about 140° C. to about 240° C. and the temperature of subsequent zones is lower than the temperature of the melt zone.

In some configurations, the degree of functionalisation of the binder is between 0.5% and 6%.

In some configurations, the characterising step comprises
setting a pre-determined range(s) for the melt-flow index of the thermoplastic,
processing the thermoplastic through the extruder,
measuring the melt-flow index of the processed thermoplastic,
comparing the measured melt-flow index to the pre-determined range for the melt-flow index, and
adjusting one or more conditions of the extruder to obtain a melt-flow index for the processed thermoplastic within the pre-determined range;
   wherein the one or more conditions is selected from any combination or one or more of
the ratio of different types of thermoplastic,
processing of the thermoplastic through an extruder,
the proportion of PP in the thermoplastic,
the amount of plasticiser added to the thermoplastic,
the temperature in an extruder zone,
the degree of agitation in the extruder, or
the residence time of the thermoplastic in the extruder.

In some configurations, the method may be used in the manufacture of a lignocellulosic thermoplastic composite board having
a) a modulus of elasticity of between about 1,000 to about 4,000 MPa
b) a modulus of rupture of about 10 to about 25 MPa
c) a screw holding of about 200 to about 500 N
d) a density of about 550 to about 1,100 kg/m3, or
e) any combination of one or more of (a) to (d).

In some configurations, the composite board comprises at least one of the following:
MoR greater than 1000 MPa,
MoE greater than 8 MPa,
IB greater than 0.2,
moisture content of greater than about 5%, or
moisture content of less than about 15%.

In some configurations, the thermoplastic dispersion further comprises at least one surfactant.

In some configurations, the thermoplastic is functionalised with a coupling agent to produce a thermoplastic dispersion.

In some configurations about 55% by weight to 90% by weight of the waste plastic is polyethylene.

In some configurations, the thermoplastic is, or comprises, plastic film.

In some configurations, the cellulosic content in the waste thermoplastic is less than 5, 6, 7, 8, 9, or 10% by weight, and suitable ranges may be selected from between any of these values.

In some configurations, the twin screw extruder comprises two co-rotating screws.

In some configurations, the thermoplastic for addition into the inlet end of the twin screw extruder is size sufficiently reduced to feed into the inlet end.

In some configurations, the twin screw extruder includes external heat input into the melt zone.

In some configurations, the melt zone generates heat from a combination of external heat input and frictional heat.

In some configurations, the melt zone generates heat from frictional heat.

In some configurations the twin-screw extruder comprises cooling passages.

In some configurations, the cooling passages are present in the emulsion zone, and further comprise one or more water injection ports

In some configurations, the coupling agent is in the form of a powder and is combined with the thermoplastic into the inlet end of the twin-screw extruder.

In some configurations, the coupling agent is added to the melt zone via an injector port at the melt zone.

In some configurations, the reactive hydrogen provider functionalises the thermoplastic polymer with one or more hydrogen groups.

In some configurations, the reactive hydrogen provider is selected from short to medium chain compounds containing an alkene and at least one of an alcohol, carboxylic acid or amine functionality.

In some configurations, the reactive hydrogen provider is provided for by one or more compounds comprising a carboxylic acid functionality.

In some configurations, the compound with a carboxylic acid functionality is selected from acrylic acid, itaconic acid or a monoester thereof, itaconic anhydride, methacrylic acid, acrylic acid, maleic acid or a monoester thereof, ethacrylic acid, fumaric acid or a monoester thereof, crotonic acid, vinyl sulfonic acid, 2-methacryloyloxy-ethanesulfonate, styrenesulfonic acid, 2-acrylamido-2-methylpropane sulfonic acid (AMPS), vinylphosphonic acid, 2-(methacryloyloxy)ethylphosphate, mesaconic acid, citraconic acid or a monoester thereof, glutaconic acid or a monoester thereof, methylmaleic acid or a monoester thereof, methylmaleic anhydride, citraconic anhydride, glutaconic anhydride, endobicyclo-[2,2,1]-5-heptene-2,3-dicarboxylic acid or a monoester thereof (such as monomethyl ester of heptene-2,3-dicarboxylic acid), and endobicyclo-[2,2, 1]-5-heptene-2,3-dicarboxylic acid anhydride or a combination thereof.

In some configurations, the reactive hydrogen provider is selected from N-methylethanolamine, N-methyl iso-propylamine, 4-aminocyclo-hexanol, 1,2-diaminotheane, 1,3-diaminopropane, diethylenetriamine, toluene-2,4-diamine, and toluene-1,6-diamine. Aliphatic compounds containing from 2 to 8 carbon atoms are preferred. ethylenediamine, monomethanolamine, and propylenediamine or a combination thereof.

In some configurations, the reactive hydrogen provider is provided for by an alcohol functional group.

In some configurations, the alcohol functional group is selected from PVOH.

In some configurations, the alcohol functional group may be selected from alpha, beta-olefinic unsaturated monocarboxylic acids with primary or secondary hydroxyl groups, such as hydroxyalkyl esters.

In some configurations, the hydroxyalkyl esters of alpha, beta-olefinic unsaturated monocarboxylic acids may be derived from acrylic acid, methacrylic acid, crotonic acid and/or isocrotonic acid, preferably hydroxyalkyl esters derived from (meth)acrylic acid, the hydroxyalkyl groups can contain, for example, 1 to 10 C atoms, preferably 2 to 6 C atoms.

In some configurations, the hydroxyalkyl esters of alpha, beta-olefinic unsaturated monocarboxylic acids with primary hydroxyl groups may be hydroxyethyl (meth)acrylate, hydroxypropyl (meth)acrylate, hydroxybutyl (meth)acrylate, hydroxyamyl (meth)acrylate, hydroxyhexyl (meth)acrylate.

In some configurations, the alcohol functional group may be selected from monoesterified products of (meth)acrylic acid with a dihydric alcohol having 2 to 8 carbon atoms, such as 2-hydroxyethyl (meth)acrylate, 2-hydroxypropyl (meth)acrylate, 3-hydroxypropyl (meth)acrylate, and 4-hydroxybutyl (meth)acrylate; &-caprolactone-modified products of the monoesterified products of (meth)acrylic acid with a dihydric alcohol having 2 to 8 carbon atoms; allyl alcohol; and the like.

In some configurations, the grafting compatibiliser is a reactive monomer.

In some configurations, the reactive monomer is selected from maleic anhydride, glycidyl methacrylate, acrylic acid, bismaleimide, a silane, N-vinylformamide or Titanate coupling agents.

In some configurations, the silane coupling agent is selected from vinyltriethoxysilane or r-aminopropyl triethoxy silane addition of which may increases flexural strength and modulus even in the absence of other additives.

In some configurations the initiator comprises a free-radical generating initiator. The initiator may be selected from organic peroxides, such as benzoyl peroxide, octanoyl peroxide, lauroyl peroxide, stearoyl peroxide, cumene hydroperoxide, tert-butyl peroxide, Cert-butylperoxy laurate, tert-butylperoxy isopropyl carbonate, tert-butylperoxy acetate, and diisopropylbenzene hydroperoxide. The initiator may comprise irradiation of the thermoplastic with UV or electron beam.

In some configurations the initiator is dicumyl peroxide.

In some configurations, the method comprises a single twin screw extruder, wherein the twin screw extruder is run in a continuous process such that the extruded thermoplastic is reacted with a coupling agent.

In some configurations, the single twin screw extruder is modular, a first module comprising the melt zone, and a second module comprising the emulsification zone, wherein thermoplastic is first processed through the first module, the thermoplastic selected from thermoplastic reacted with a coupling agent to define a functionalised molten thermoplastic and thermoplastic not reacted with a coupling agent to define a molten thermoplastic, and
wherein a mixture of functionalised molten thermoplastic and molten thermoplastic is processed through the second module.

In some configurations, the mixture comprises about 10, 20, 30, 40, 50, 60, 70, 80 or 90% by weight of thermoplastic of functionalised molten thermoplastic, and suitable ranges may be selected from between any of these values.

In some configurations, the method comprises two or more twin screw extruders.

In some configurations, a first twin screw extruder comprises at least the melt zone to produce a molten thermoplastic, and a second twin screw extruder comprises at least the melt zone to produce a molten thermoplastic, wherein at least one of the thermoplastics is a functionalised molten thermoplastic, and
wherein the functionalised molten thermoplastic and the molten thermoplastic are combined to produce the emulsion.

In some configurations, the emulsion comprises about 10, 20, 30, 40, 50, 60, 70, 80 or 90% by weight of thermoplastic of functionalised molten thermoplastic, and suitable ranges may be selected from between any of these values.

In some configurations, the emulsification zone comprises a mixing zone and a shear zone.

In some configurations, the water and surfactant are added into the mixing zone via an injection port to produce a first emulsified thermoplastic.

In some configurations, the first emulsified thermoplastic is subjected to shear in the shear zone to produce a functionalised thermoplastic emulsion.

In some configurations, the shear force is provided to micronise the thermoplastic within the reactive emulsion.

In some configurations, the addition of water and surfactant in the emulsification zone results in a phase change.

In some configurations, water is added with the cross linker.

In some configurations, the cross-linker is selected from a participant cross-linker or a non-participant cross-linker.

In some configurations, the participant cross-linker is selected from an isocyanate.

In some configurations, the non-participant cross-linker is selected from an organic peroxide.

In some configurations, the participant cross-linker is only added when the thermoplastic has been reacted with a hydrogen donating agent.

If adding a non-participant cross linker such as an organic peroxide, this is added at about 0.1, 0.5, 1, 2, 3, 4, or 5% by weight of the emulsion, and suitable ranges may be selected from between any of these values.

If adding a participant cross-linker such as an isocyanate, this is added at about 0.1, 0.5, 1, 2, 3, 4, 5, 6, 7, 8, 9, 10, 11, 12, 13, 14 or 15% by weight of the emulsion, and suitable ranges may be selected from between any of these values.

t.

In some configurations, the cross-linker is combined with the emulsion immediately prior to the manufacture of a fibre board.

In some configurations, the binder mixture is combined with wood chip prior to particle board manufacture.

In some configurations, the composite mixture is subject to pressure sufficient to decrease the thickness of the composite mixture and heating the composite mixture to about 140° C. to about 220° C. to form the composite panel.

In some configurations, the source thermoplastic material comprises less than 10, 9, 8, 7, 6, 5, 4, 3, 2, or 1% cellulosic material by weight of the source thermoplastic material.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

In this specification, where reference has been made to external sources of information, including patent specifications and other documents, this is generally for the purpose of providing a context for discussing the features of the present invention.

Unless stated otherwise, reference to such sources of information is not to be construed, in any jurisdiction, as an admission that such sources of information are prior art or form part of the common general knowledge in the art.

### BRIEF DESCRIPTION OF THE DRAWINGS

The invention will now be described by way of example only and with reference to the drawings in which:

FIG. 1 shows a flow diagram of the process as described to form a plastic emulsion.

FIG. 2 shows a flow diagram of the process as described to form a composite product from the plastic emulsion of FIG. 1.

FIG. 3 shows a diagram showing an expected reaction between the various components.

FIG. 4 shows a diagram showing an expected reaction between the various components.

FIGS. 5A to 5D show stylised representations of TSE as described.

FIGS. 6A to 6C show flow charts of some of the described methods.

FIGS. 7a to 7e show stylised representations of alternate representations of the TSE as described.

FIG. 8a shows DSC analysis of sample 1a-post-industrial pelletised LDPE.

FIG. 8b shows melt-flow index at different temperatures.

FIG. 8c shows DSC analysis of sample 1b.

FIG. 8d shows DSC analysis of sample 1c.

FIG. 8e shows DSC analysis of sample 1d.

FIGS. 9a to 9e show graphs comparing the melt flow index of differing % of recycled PP at different temperatures.

FIGS. 10a to 10c show graphs comparing the MOE, MOR and IB of eMDI and pMDI boards.

FIG. 11 shows the effect of functionalised PE on wood fibre board strength.

FIG. 12a shows FTIR spectra of rPP.

FIG. 12b shows FTIR spectra of rPP-g-St-GMA.

FIGS. 12c and 12d show microscope images of rPP and rPP-St-GMA respectively

FIGS. 13a to 13c show graphs illustrating the MOE of different wt % MAPE and Luperox 231.

FIGS. 14a to 14d show graphs illustrating the MOE, MOR and IB of mixed polymer-fibre boards, as well as the Melt-flow index of differing PP: LDPE blends.

FIG. 15A shows variation of modulus of elasticity (MoE) across different board treatments.

FIG. 15b shows variation in modulus of rupture (MoR) across different board treatments.

FIG. 15c shows internal bonding strength (IB) across different board treatments.

FIG. 15d shows swelling rate (SB) in 24 hrs across different board treatments.

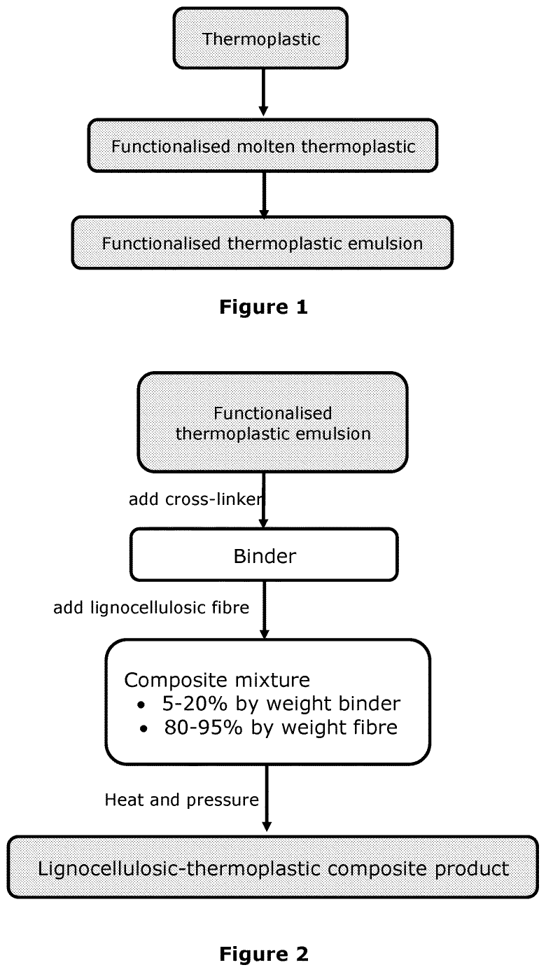

### DETAILED DESCRIPTION OF THE INVENTION

As used herein the term “cellulose”, “cellulosic” or its grammatical equivalents refers to processed plant material such as paper or cardboard, and excludes lignocellulosic material.

As used herein the term “lignocellulose”, “lignocellulosic” or its grammatical equivalents refers to plant material in which the wood fibres are still substantially intact, such as wood chips, sawdust, wood particles, wood sheets, coconut husk, rice straw or husk, barley straw, bamboo, wood fibres and the like, and excludes cellulose as defined. As referred to herein, lignocellulosic material, lignocellulosic-based material, lignocellulosic substrate and lignocellulosic fibre are to be read interchangeably.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

As referred to herein, “waste plastic” means plastic that has been used in a product or process previously for a single or multiple uses following the initial synthesis of that plastic polymer. Waste plastic has different properties compared to virgin plastic due to the wear and tear from previous use and the recycling processes undergone a single or multiple uses following the initial synthesis of that plastic polymer. Waste plastic may have been pre-processed, for example through manual, automated or mechanized sorting, washing, or comminuting. Waste plastic may originate from household or industrial waste collection services, municipal recycling facilities or other reclaimers. In certain embodiments, the waste plastic may comprise at least one of post-industrial (or pre-consumer) plastic and/or post-consumer plastic and may include recycled plastic.

As referred to herein, “virgin plastic” means plastic that has plastic resin that has not been used in a product or process before. It is newly manufactured plastic material produced directly from the petrochemical feedstock, such as natural gas or crude oil, without any recycled plastic content. Virgin plastic provides consistent quality and properties since it hasn't been subjected to prior use and processing. As a result, it is often chosen for applications where specific structural, aesthetic, or hygienic properties are critical, such as in medical devices, high-quality consumer products, or food packaging.

As referred to herein, a “dispersion” means a system in which particles of one substance (the dispersed phase) are dispersed, or distributed throughout another substance (the dispersion medium). The particles can range in size. Dispersions may comprise solid particles dispersed in a liquid, liquids of one density dispersed in another, immiscible liquid, or particles of one solid dispersed in the particles of another solid.

As referred to herein, “emulsion” means a material comprising a combination of at least two immiscible fractions which are or have been mixed in a liquid or semi-liquid state. Emulsions according to the present disclosure are examples of dispersions and may not necessarily comprise two liquids and will typically comprise a polymer in water where the polymer may be a size-reduced solidified polymer that has undergone heating and mixing to form the emulsion.

As referred to herein, an “extruder” means a machine used to mix and push or draw out a material while heating the material. The extruder may be a single or twin-screw extruder, an intermeshing co-rotating twin-screw extruder, a co-kneader, a Banbury mixer, a high-pressure homogenizer or any other machine comprising an internal screw or rotors to knead or mix material while applying high pressure and temperature. Extruders typically consist of a heated barrel equipped with a rotating screw or kneading elements. The raw material, often in the form of pellets or granules, is fed into the barrel, where it gets melted and mixed due to the combined action of the screw's mechanical work and the heat from the barrel. The molten plastic is then forced through a die at the end of the barrel, giving it a desired shape.

As referred to herein, “particularise” means the processing of a material to reduce the size of its particles. Particularisation may be achieved using various methods including extrusion for example in a single or twin-screw extruder, shredding, mechanical milling, crushing, grinding, ultrasonic disintegration, micronization, cryogenic grinding, shearing, high-pressure homogenization, microfluidisation and pulverisation.

Described is a method for forming a thermoplastic composite product. The method introduces a source of thermoplastic into an inlet end of one or more extruders. Within the one or more extruders, a substantial portion, if not all of, the thermoplastic is melted to define a melt zone in the extruder. The thermoplastic is further processed such that
a) At least a portion of the thermoplastic is reacted with a coupling agent to produce a functionalised thermoplastic,
b) the thermoplastic is dispersed in water under agitation to produce a thermoplastic dispersion, or
c) The thermoplastic is processed by (a) and subsequently (b) to produce a functionalised thermoplastic dispersion.

A cross-linker may subsequently be added to the functionalised thermoplastic or thermoplastic dispersion to produce the binder. The cross-linker may be added to the extruder, or to the extruded functionalised thermoplastic or thermoplastic dispersion.

When used, the binder is mixed with a substrate (in the form of a fibre) to form a composite mixture. The composite mixture is introduced into a press or mould and subjected to heat and pressure to form a thermoplastic composite product.

The thermoplastic (or thermosoft plastic) is a plastic polymer. Most thermoplastics have a high molecular weight. The polymer chains of the thermoplastic associate by intermolecular forces, which weaken with increased temperature, yielding a viscous liquid. In this state, thermoplastics may be reshaped.

The thermoplastic may comprise virgin or waste plastic or a mixture of virgin plastic and waste plastic.

The system, method and apparatus may be used for the processing of a variety of input plastics. In some embodiments the majority of the input thermoplastic is selected from polypropylene or polyethylene, or a combination thereof. The input thermoplastic may comprise at least 60, 65, 70, 75, 80, 85, 90 of a polypropylene or polyethylene, or a combination thereof, and suitable ranges may be selected from between any of these values, (for example, about 60 to about 90, about 60 to about 85, about 60 to about 80, about 65 to about 90, about 65 to about 80 or about 70 to about 90% by weight of the plastic). Polyethylene may comprise 55, 60, 65, 70, 75, 80, 85 or 90% by weight of the thermoplastic, and suitable ranges may be selected from between any of these values, (for example, about 55 to about 90, about 55 to about 80, about 55 to about 70, about 60 to about 90, about 60 to about 85, about 60 to about 80, about 65 to about 90, about 65 to about 80 or about 70 to about 90% by weight of the plastic).

Waste plastic provides a useful source of plastic for this process. In many countries waste plastic creates an environmental problem as society struggles to recycle or dispose of such plastic economically and safely. The sourced waste plastics may be for example the type of plastics derived from the waste recycling process. However, it will be appreciated various types of input plastic may be used depending on the desired output slurry.

A problem in processing waste plastic is the variability in polymer type and size, and the presence of additives or contaminants. For example, post-consumer waste comprises a variety of different polymers, and may include organic and inorganic contaminants such as food waste, glass and foil. A step in being able to effectively process waste plastics is the characterization of that waste quickly and efficiently. Processing of waste plastics often requires that the physical and chemical properties of the waste plastic are known so that the processing parameters can be optimally applied and correct stoichiometric ratios can be derived.

Accordingly, the methods provided herein may comprise a waste characterisation step comprising analysis of one or more physical properties. The one or more physical properties may comprise melt-flow index, melting point, viscosity, glass transition temperature, density, tensile strength, crystallinity or any combination thereof.

Similarly, the methods provided herein may comprise a waste characterisation step comprising analysis of one or more chemical properties. The one or more chemical properties may comprise chemical formula, molecular weight, monomer content, degree of branching, crosslink density, oxidative stability, or any combination thereof.

The waste plastic may include any one of, or combination of, polyethylene terephthalate (PETE or PET), high-density polyethylene (HDPE), polyvinyl chloride (PVC), low-density polyethylene (LDPE), Linear low-density polyethylene (LLDPE), polypropylene (PP), polystyrene or styrofoam (PS), polycarbonate, polylactide, acrylic, acrylonitrile butadiene, styrene, fiberglass, rubber, paper and nylon. This waste plastic mixture may for example originate from a co-mingled plastic waste stream.

Given the wide use of plastic in society, the waste plastic may be sourced from every-day waste products such as plastic bottles (e.g. milk, carbonated drinks, water bottles, cleaning products), plastic containers (e.g. for industrial products such as oil, food items), and packaging (whether rigid or soft), although it will be appreciated that the product list of waste products is immensely broad.

Waste plastic processed according to the present invention may have undergone one or more pre-processing steps. These pre-processing steps may be carried out in a pre-processing facility that includes all equipment, lines, and controls necessary to carry out the pre-processing of waste plastic. Alternatively, the waste plastic does not undergo pre-processing and the waste plastic stream is not subjected to any pre-processing before any of the downstream steps described herein.

The pre-processing facility of the waste plastic source may include at least one separation step or zone. The separation step or zone may be configured to separate the waste plastic stream into two or more streams enriched in certain types of plastics. Such separation may be advantageous when waste plastic undergoes a chemical recycling step such as functionalisation.

Some thermoplastics are difficult to recycle or reuse, such as plastic film. Plastic film can be used in the present method, which is important given the lack of other options for recycling plastic film. The ability of the present method to reuse plastic film arises from the ability of screw extruders to melt, compress and mix efficiently. Further advantages may include the ability to inject additives or reactive components into the molten plastic and have them combine in the final product. The present method uses extrusion technology to produce a binder that can then be used to manufacture new composite products.

One source of plastic may be shredded plastic. That is, it is shredded so that it can fit within the inlet of the twin screw extruder. Various methods are known to shred plastic products. For example, the use of cutting and/or extruders, shredders, granulators or grinders. Cutting and extruding machines (e.g. see U.S. Pat. No. 9,744,689) can include one or more knives that rotate in a housing such that any plastic introduced into the housing is cut by the knives into smaller particles. In some machines the plastic may start to melt, or melt, due to the action of the knives (i.e. by the heat produced by friction) and such melted or partially melted plastic may enter an extruder in which the screws carry the plastic away from the cutting blades. The plastic may then be extruded and cut into small pellets at the outlet of the extruder.

Shredders (e.g. see U.S. Pat. No. 6,241,170), granulators (e.g. see U.S. Pat. No. 6,749,138) and grinders (e.g. see U.S. Pat. No. 5,547,136 or German patent DE 19614030 A1) may include a single or plurality of cutting wheels or rollers that again rotate in a housing and reduce the size of the plastic through the action of the cutting wheel or rollers against the plastic as the plastic passes between the cutting wheels or roller and the internal surface of the housing. Alternately, the plastic may pass between two or more banks of knives or rollers, that in some cases overlap, such that the plastic is cut or ground due to this passage.

Such processes typically use rotary knives or bed knives whose rotation cuts the plastic into smaller particles or pieces.

It will be appreciated that the plastic waste may include some contamination. In some embodiments the waste thermoplastic may include some cellulosic material such as paper and labels. Preferably the thermoplastic comprises less than about 1, 2, 3, 4, 5, 6, 7, 8, 9 or 10% cellulosic material by weight of the thermoplastic, and suitable ranges may be selected from between any of these values.

The processes of functionalisation and/or emulsification described herein may require the use of a pre-processed waste thermoplastic. The processes of functionalisation and/or emulsification may be required before waste plastics such as plastic film, or thin “shards” of thermoplastic such as common types of plastic bottle, can be used in the described method. Pelletising of the waste plastic prior to processing may ensure uniformity of plastic particle size and density which may allow for better control over the flow and melting of the material. The smaller and more homogenous size of the pellets may allow for more efficient melting and mixing during the extrusion process. As used herein, the palletisation pre-processing step may comprise preparation of pellets with a size of about 2, 3, 4, 5, 6, 7, or 8 mm, and suitable ranges may be selected from between any of these values (for example, about 2 to about 8. 2 to about 6, about 2 to about 5, about 3 to about 8, about 3 to about 7, about 3 to about 6, about 4 to about 8 or about 4 to about 6 mm). This may lead to a more homogeneous functionalisation and emulsification when these steps are employed. Further, the pellets may be able to be effectively fed with a pre-determined rate which ensures stoichiometric ratios during functionalisation and emulsification are maintained.

The melt-flow index (MFI) of processed thermoplastic may be increased following passage through an extruder. The higher melt flow thermoplastics may provide processing benefits during board formation as they melt and spread more effectively, enhancing mechanical locking between the thermoplastic and lignocellulosic material.

The present method may provide pre-processing of a thermoplastic that comprises a step of increasing the melt-flow index (MFI) of the thermoplastic. The pre-processing step may be carried out:
a) prior to functionalisation,
b) after functionalisation and prior to emulsification, or
c) prior to emulsification in the absence of functionalisation.

The functionalisation may comprise both:
functionalising the thermoplastic; and
increasing the melt flow index.

Step (a) above may increase the thermoplastic reactivity when it is combined with a cross-linker. Step (b) above may result in improved processing through an extruder, enhanced emulsification and results in a smaller particle size. The step of increasing the melt-flow index (MFI) of the thermoplastic may be carried out by any one or more of the following.
The addition of a melt-flow index-increasing additive to an extruder. The additive may be at least one of a plasticiser and an initiator. The initiator may be an initiator described herein such as DCP. The plasticiser may be tall oil or a polyolefin-specific plasticiser.
Processing the thermoplastic through an extruder to reduce molecular weight of the thermoplastic molecules. Where the thermoplastic includes the presence of polypropylene, the polypropylene may be more amenable to processing in this way due to the branched nature of the molecules and processing reduces chain length of the polymer.
Combining the thermoplastic, such as the waste thermoplastic, with a second thermoplastic.

Step (c) may comprise combining the thermoplastic with a second thermoplastic that has a higher melt-flow index. That is, the first thermoplastic may comprise a low melt thermoplastic and the second thermoplastic may comprise a high-melt thermoplastic. The second thermoplastic may comprise polypropylene. The second thermoplastic (comprising a high-melt thermoplastic) may form 10, 20, 30, 40 or 50% of the total weight of thermoplastic, and suitable ranges may be selected from between any of these values (for example, about 10 to about 50, about 10 to about 40, about 10 to about 30, about 20 to about 50, about 20 to about 49 or about 30 to about 50% of the total weight of thermoplastic). Example 4 illustrates the effect on melt-flow index of addition of varying quantities of recycled polypropylene. This shows that the addition of recycled polypropylene provides a method of increasing the melt-flow index of a mixed waste thermoplastic composition.

As referred to herein, a high low-melt thermoplastic comprises a melting point greater than 130° C., and low-melt thermoplastic comprises a melting point of 130° C. or less.

The melt-flow index may be increased by processing the thermoplastic through an extruder with the addition of an initiator. This may be particularly effective in processing polypropylene because the initiator abstracts a hydrogen from the polymer backbone causing a reduction in molecular weight through chain scission. Accordingly, in one embodiment, the thermoplastic may be processed to increase the melt-flow index by the use of an extruder to process thermoplastic comprising polypropylene. The initiator in this example may be added to the extruder, or to the fed material prior to entry into the extruder.

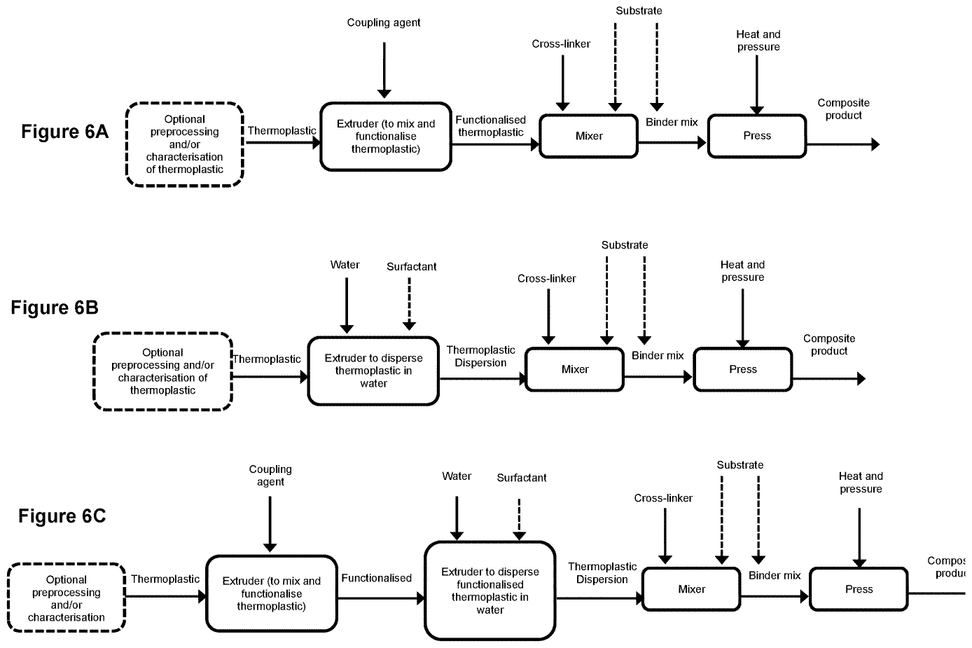

FIG. 6A shows an example of the method as described herein in which:
a thermoplastic is functionalised in an extruder to form a functionalised thermoplastic,
the functionalised thermoplastic is combined with a cross-linker and a substrate in a mixer to form a binder mix,
the binder mix is formulated into a mat for pressing in a press, and
heat and pressure are applied to the mat to produce a composite product.

The composite product may undergo post-processing such as cutting or laminating to form a useful product. The thermoplastic may have undergone at least one of pre-processing (e.g. washing or sorting) and/or characterisation step. Example 10 illustrates the preparation of a wood-fibre board with functionalised PE and combination with an organic peroxide cross-linker.

As shown in FIG. 6B, the thermoplastic may not undergo functionalisation in an extruder. The thermoplastic may already have been functionalised, or may not require functionalisation to provide a useful composite product. FIG. 6B shows an example of the method as described herein in which:
at least a portion of the thermoplastic is substantially melted and combined with water in an extruder to form a thermoplastic dispersion,
the dispersion is mixed in a mixer with a cross-linker and a substrate to form a binder mix,
the binder mix is formulated into a mat for pressing in a press, and
heat and pressure are applied to the mat to produce a composite product.

The composite product may undergo post-processing such as cutting or laminating to form a useful product. The thermoplastic may have undergone at least one of pre-processing (e.g. washing or sorting) and/or characterisation step.

Examples 2, 3, 5, and 6 show various examples of thermoplastic dispersions being produced for composite board preparation.

As shown in FIG. 6C, the thermoplastic may undergo both functionalisation (to form a functionalised thermoplastic), and dispersion (to form a thermoplastic dispersion). FIG. 6C shows an example of the method as described herein in which:
a thermoplastic is functionalised in an extruder to form a functionalised thermoplastic,
at least a portion of the functionalised thermoplastic is substantially melted and combined with water in an extruder to form a thermoplastic dispersion,
the thermoplastic dispersion is combined with a cross-linker and a substrate in a mixer to form a binder mix,
the binder mix is formulated into a mat for pressing in a press, and
heat and pressure are applied to the mat to produce a composite product.

The composite product may undergo post-processing such as cutting or laminating to form a useful product. The thermoplastic may have undergone at least one of pre-processing (e.g. washing or sorting) and/or a characterisation step.

Examples, 6, 7, 8 and 10 demonstrate the effective production of binders and use of those binders in the preparation of composite boards.

It will be appreciated that the binder mix referred to herein may be used in the preparation of a range of composite materials or adhesives such as those described below. In one embodiment, the substrate comprises a lignocellulosic material/substrate.

### Functionalisation

The method as described herein may include functionalising a thermoplastic to improve its reactivity with cross-linkers when preparing a binder. The binder may find use in various applications, such as being combined with a lignocellulosic material/substrate to form a plastic composite product.

The method as described herein may produce a composite material comprising:
introducing thermoplastic into an extruder;
reacting the thermoplastic with a coupling agent to form a functionalised thermoplastic;
formulating the functionalised thermoplastic with a cross-linker to form a binder; and
mixing the binder with a cellulosic substrate to form a composite mixture.

The process may further comprise heating and pressing the binder mix to produce a composite product.

Most plastic waste, in particular PP and PE, is hydrophobic. Lignocellulosic material fibres are hydrophilic. Therefore it can be difficult to combine the two. Coupling agents, for example grafting compatibilisers, can be used that have both hydrophobic and hydrophilic functional groups and therefore enable the binding of cross-linkers to thermoplastics.

The thermoplastic introduced to the extruder may substantially melt in a melt zone of the extruder. The coupling agent may be added to the melted thermoplastic in the melt zone. The functionalisation of thermoplastic waste with a coupling agent can occur at the same time in an extruder or sequentially in multiple extruders or modular extruders.

Without wishing to be restricted by theory, there are differences between the chemical structure and/or polarity of thermoplastic polymers and lignocellulosic material fibres. Those differences may result in weak interfacial adhesion. For example, polyolefins are hydrophobic and lignocellulosic material fibres are hydrophilic, meaning that they repel each other. Weak interfacial adhesion can lead to low tensile strength and a weaker thermoplastic composite product, which results in a weaker final product such as a plastic-lignocellulosic material composite board. Coupling agents can add functional groups which provide available hydrogen, or be grafted onto the polymer to change its polarity and create favourable interactions with the lignocellulosic material. These favourable interactions with the lignocellulosic material can result in stronger interfacial adhesion. Where cross linkers are used, the coupling agent can form bonds with the cross linker.

At least one coupling agent may be added to the extruder with the thermoplastic. The one or more coupling agent may be added prior to heating and operation of the extruder. One or more coupling agents may be added after initial heating and operation of the extruder.

The amount of each coupling agent added may be about 1, 2, 3, 4 or 5% by weight of the thermoplastic, and suitable ranges may be selected from between any of these values (for example, about 1 to about 5, about 1 to about 4, about 1 to about 3, about 2 to about 5, about 2 to about 4, about 3 to about 5 or about 3 to about 4% by weight of the thermoplastic).

Where different types of coupling agents are added, the total amount of coupling agent added may be 2, 3, 4, 5, 6, 7, 8, 9 or 10% by weight of the thermoplastic, and suitable ranges may be selected from between any of these values (for example, about 2 to about 10, about 2 to about 8, about 2 to about 7, about 3 to about 10, about 3 to about 9, about 3 to about 7, about 3 to about 6, about 4 to about 10, about 4 to about 9, about 4 to about 8, about 5 to about 10, about 5 to about 9, about 5 to about 8, about 6 to about 10, about 6 to about 8, about 7 to about 10 or about 7 to about 9% by weight of the thermoplastic).

The degree of functionalisation of a polymer backbone refers to the extent to which functional groups are attached to the polymer's main chain. In polymer chemistry, a functional group is a specific group of atoms within a molecule that is responsible for the characteristic chemical reactions of that molecule. The “degree of functionalization” quantifies how many of these groups are attached to the polymer. For instance, in a functionalised polymer, not every repeat unit might have a functional group attached. The degree of functionalisation as referred to herein expresses a percentage of the polymer's repeat units that have been modified with a functional group. The degree of functionalisation is controlled during the reactive extrusion process.

Described is a method of preparing functionalised thermoplastic, or using functionalised thermoplastic according to the methods described herein with a degree of functionalisation in the range from 0.5, 1, 2, 3, 4, 5 or 6%, and suitable ranges may be selected from between any of these values (for example, about 0.5 to about 6, about 0.5 to about 5, about 0.5 to about 4, about 0.5 to about 2, about 1 to about 6, about 1 to about 5, about 1 to about 4, about 2 to about 6, about 2 to about 5, about 3 to about 6%, or about 3 to about 4%). The functionalised thermoplastic may comprises PE or PP or a mixture of PE and PP. Methods to measure the degree of functionalisation will be known to those of skill in the art. For example, the method may comprises the use of FTIR and/or acid-base titration

In one example, the coupling agent comprises the monomer GMA. The GMA may be added to an extruder via a feed concurrently or consecutively with a thermoplastic. In one example the GMA is added to a melt zone of an extruder via an injector. The amount added depends on the desired degree of functionalisation. The GMA may be added in a range of 2, 3, 4, 5, 6, 7, 8, 9, or 10% by weight of the thermoplastic, and suitable ranges may be selected from between any of these values (for example, about 2 to about 10, about 2 to about 8, about 2 to about 7, about 3 to about 10, about 3 to about 9, about 3 to about 7, about 4 to about 10, about 4 to about 9, about 4 to about 8, about 5 to about 10, about 5 to about 8 or about 6 to about 10% by weight of the thermoplastic). Adding a higher proportion of coupling agent can result in undesirable phase separation where contrasting hydrophilic and hydrophobic reactants prevent effective mixing. In this instance, undesirable homopolymerisation can occur which causes the monomer to self-react or the polymer degrades and monomer mixing/miscibility is compromised.

Example 8 describes the functionalisation of recycled polypropylene using GMA. Analysis indicated that the particle size of processed GMA-functionalised polypropylene is smaller than non-functionalised material. When the material is processed through an extruder to achieve emulsification and production of a thermoplastic dispersion, it is expected that the smaller particle size would lead to decreased particle size in the resultant thermoplastic dispersion and subsequently improved strength in wood-fibre board comprising the dispersion with a cross-linker such as isocyanate.

The coupling agent may be added to the extruder as a powder or other form of solid. The coupling agent may be selected from a grafting compatibiliser, a reactive hydrogen provider, or a combination thereof.

A grafting co-monomer may be used to increase affinity of a coupling agent with a thermoplastic. Styrene may be used to bridge the monomer and polymer as it has affinity for both and acts as a co-solvent.

A grafting compatibiliser facilitates the adhesion between immiscible or incompatible components of a blend or composite. Absence of compatibilisation may result in inferior mechanical properties in the final product. For example, a grafting compatibiliser may improve the cohesion between inherently hydrophilic wood chips and inherently hydrophobic PP/PE. A grafting compatibiliser works by grafting of chemical groups onto a polymer backbone, the impact of which is to alter the polymer chain's fundamental character thereby rendering it “compatible” with composite components. Grafting compatibilisers have functional groups that are compatible with each of the components in the composite. As such, they can “anchor” themselves between the two incompatible components and reduce interfacial tension, promoting finer dispersion and better adhesion between the components.

The coupling agent or grafting compatibiliser may be selected from maleic anhydride, acrylic acid, glycidyl methacrylate, N-vinylformamide, bismaleimide or silanes. The use of N-vinylformamide may increase flexural strength and modulus. Silane grafting compatabilsers may be selected from vinyltriethoxysilane or r-aminopropyl triethoxy silane. The grafting compatibiliser may be selected from titanate coupling agents.

Maleic anhydride (MA) may be used as the grafting compatibiliser or coupling agent to form maleated polyethylene or maleated polypropylene. Maleated polyethylene is formed by reacting polyethylene with maleic anhydride. Maleated polypropylene is formed by reacting polypropylene with maleic anhydride. The anhydride functionalities of the MA can interact with the surface hydroxyls of the wood or lignocellulose polymers during the manufacture of a composite board. Also during the manufacture of the composite board, the carbon chain of the maleate copolymer can then cross-link with the non-functionalised polymer matrix because of their similar polarities. Sufficient maleic anhydride may be added to form a maleated thermoplastic. Without wishing to be restricted by theory, the maleic anhydride can form bonds with the hydroxy groups on lignocellulose fibre during the manufacture of a composite board. The hydroxy group may react with one of the carbonyls on the maleic anhydride forming a covalent bond between the lignocellulose oxygen and one of the carbonyl carbons on the maleic anhydride. This may lead to ring opening and formation of a carboxylic acid moiety at the other carbonyl. The resulting carboxylic acid may then form additional bonds with another lignocellulosic material hydroxy or with a cross linker, such as diisocyanate. The polymer chain attached to the maleic acid may then form favourable interactions with the non-malleated plastic matrix, through chain entanglement, resulting in stronger interfacial adhesion. Hydrogen bonding between the lignocellulose hydroxyls and the carboxylic acid hydroxy may also contribute to favourable interactions.

Example 6 outlines an experiment in which, composite wood fibre boards were created using maleic anhydride functionalized polyethylene (MAPE) along with Luperox 231 as a cross-linker. The binder was prepared by blending and emulsifying LDPE to prepare a thermoplastic dispersion. Results showed that boards with MAPE exhibited significantly higher strength (MoE) compared to those without it. The example demonstrates that MAPE improved the adhesion of LDPE to wood fibre in the preparation of composite boards.

The amount of grafting compatibiliser added may be about 1, 2, 3, 4 or 5% by weight of the thermoplastic, and suitable ranges may be selected from between any of these values (for example, about 1 to about 5, about 1 to about 4, about 1 to about 3, about 2 to about 5, about 2 to about 4, about 3 to about 5 or about 3 to about 4% by weight of the thermoplastic).

In one embodiment, glycidyl methacrylate is used as the grafting compatibiliser or coupling agent to form a functionalised thermoplastic.

An initiator may be added with the grafting compatibiliser or the functionalisation agent. The initiator is added to facilitate thermo-dissociation and generate free radicals to promote grafting. In one example the initiator comprises a free-radical generating initiator.

The use of initiators has been explored combined with functionalisation of the thermoplastic. The thermoplastic may be functionalised using Glycidyl Methacrylate (GMA) wherein the thermoplastic may be a high-melt thermoplastic such as poly-propylene, and a low melt thermoplastic such as polyethylene, or a combination thereof. As described in example 8 it was found that the processing of high-melt thermoplastics such as PP in the presence of an initiator resulted in an increase in melt flow. This provided enhanced size reduction of the waste plastic and better emulsification.

A method as described herein may provide a thermoplastic dispersion comprising an initial step of processing a high-melt thermoplastic such as PP in the presence of an initiator, then combining the high-melt thermoplastic such as PP with a low melt thermoplastic such as PE prior to emulsification in an extruder to prepare a thermoplastic dispersion as described herein. The high-melt thermoplastic such as poly-propylene, or low melt thermoplastic such as polyethylene, or both may optionally be functionalised. The ratio of high-melt thermoplastic (such as poly-propylene) to low melt thermoplastic (such as polyethylene) may be from 1:4 to 4:1, and suitable ranges may be selected from between any of these values (for example, about 4:1, about 3:1, about 2:1, about 1:1, about 1:2, about 1:3, or about 1:4).

In the context of emulsion-based processes, it has been found that it is preferable to minimise viscosity differences between phases, such as polymer and water because this leads to smaller particle sizes in emulsions. Addition of a high-melt thermoplastic such as polypropylene to form a thermoplastic composition is an example of this as exemplified in examples 3 and 4. Higher melt flow thermoplastics also offer benefits during board formation as they melt and spread more effectively, enhancing mechanical locking between the plastic and lignocellulosic materials. Additionally, the hydrophilic nature of GMA fosters better adhesion to lignocellulosic materials, promoting intimate mixing.

The advantages of GMA grafting extend beyond emulsion processes. GMA's hydrophilic properties aid in reducing surface tension between immiscible phases, leading to smaller droplets and finer dispersions. Additionally, GMA and Maleic Anhydride (MAH) serve as potential compatibilizers, potentially improving the homogeneity of blended plastics, which could positively influence melt flow and other aspects.

The initiator may be selected from organic peroxides, such as benzoyl peroxide, dicumyl peroxide, octanoyl peroxide, lauroyl peroxide, stearoyl peroxide, cumene hydroperoxide, tert-butyl peroxide, Cert-butylperoxy laurate, tert-butylperoxy isopropyl carbonate, tert-butylperoxy acetate, and diisopropylbenzene hydroperoxide. The initiator may comprise irradiation of the thermoplastic with UV or electron beam.

The initiator may be selected from dicumyl peroxide.

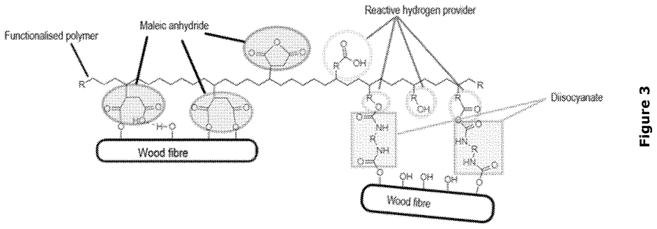

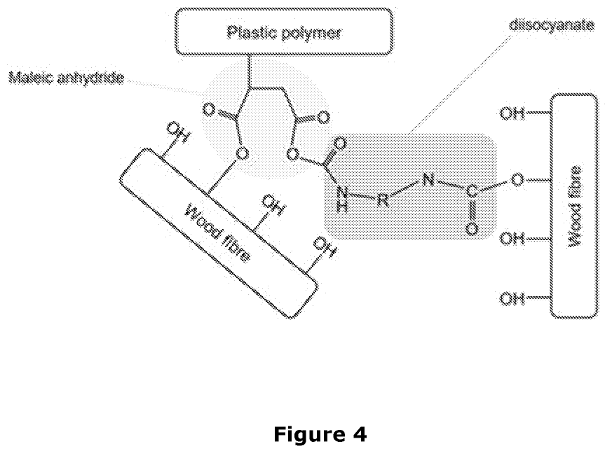

Additionally, functionalisation can be achieved using groups which provide “available hydrogen”. The reactive hydrogen provider is a coupling agent and can be selected from acids such as acrylic acid and itaconic acid or alcohols such as polyvinyl alcohol. The reactive hydrogen provider can be grafted on to the backbone of the polymer to form bonds with the lignocellulosic material fibre or covalent bonds with cross linkers if included as shown in FIGS. 3 and 4.

The amount of reactive hydrogen provider or coupling agent added may be about 1, 2, 3, 4 or 5% by weight of the thermoplastic, and suitable ranges may be selected from between any of these values (for example, about 1 to about 5, about 1 to about 4, about 1 to about 3, about 2 to about 5, about 2 to about 4, about 3 to about 5 or about 3 to about 4% by weight of the thermoplastic).

Suitable reactive hydrogen providers may be selected from compounds containing at least one reactive functional group for isocyanate, and a functional group suitable for grafting onto a polyolefin backbone. A reactive functional group for isocyanate is one containing a reactive, active or Zerewitinoff-reactive hydrogen.

Where compounds with an isocyanate-reactive functional group are not suitable for grafting onto a polyolefin, it will be understood by persons skilled in the art to modify the compound to be suitable for grafting, such as by inclusion of an alkene functionality or short chain alkene side-chain. Examples of coupling agent compounds containing isocyanate-reactive hydrogen atoms include alcohols, glycols, mercaptans, carboxylic acids such as polybasic acids, amines, ureas, silanes and amides.

The reactive hydrogen providers may be selected from compounds that provide an acidic functional group, or an alcohol functional group, or an amine functional group. Without wishing to be restricted by theory, the groups with available hydrogen may hydrogen bond with the hydroxyls on the wood fibres which also creates favourable, albeit weaker, interactions. The groups with available hydrogen also provide the necessary hydrogen and subsequent interactions to form urethane bonds with the diisocyanate.

Preferred reactive hydrogen providers or coupling agents are selected from short to medium chain compounds containing an alkene and at least one of an alcohol, carboxylic acid or amine functionality. This may include vinyl alcohol, acrylic acid or itaconic acid.

Examples of suitable reactive hydrogen providers or coupling agents suitable for grafting which contain a carboxylic acid functionality include methacrylic acid, acrylic acid, maleic acid or a monoester thereof (such as monomethyl maleate), maleic anhydride, ethacrylic acid, fumaric acid or a monoester thereof (such as monomethyl fumarate), crotonic acid, itaconic acid or a monoester thereof (such as monomethyl itaconate), itaconic anhydride, vinyl sulfonic acid, 2-methacryloyloxy-ethanesulfonate, styrenesulfonic acid, 2-acrylamido-2-methylpropane sulfonic acid (AMPS), vinylphosphonic acid, 2-(methacryloyloxy)ethylphosphate, mesaconic acid, citraconic acid or a monoester thereof (such as monomethyl citraconic acid), glutaconic acid or a monoester thereof (such as monomethyl glutaconate), methylmaleic acid or a monoester thereof (such as monomethyl methylmaleate), methylmaleic anhydride, citraconic anhydride, glutaconic anhydride, endobicyclo-[2,2,1]-5-heptene-2,3-dicarboxylic acid or a monoester thereof (such as monomethyl ester of heptene-2,3-dicarboxylic acid), and endobicyclo-[2,2, 1]-5-heptene-2,3-dicarboxylic acid anhydride.

Reactive hydrogen providers that may be suitable for grafting may include alkene derivatives of glycols such as ethylene glycol, diethylene glycol, propylene glycol, dipropylene glycol, 1,3-propanediol, 1,3-butanediol, 1,4-butanediol, 1,5-pentanediol and other pentane diols, 2-ethyl-1,3-hexanediol, 2-ethyl-1,6-hexanediol, other 2-ethyl-hexanediols, 1,6-hexanediol and other hexanediols, 2,2,4-trimethylpentane-1,3-diol, decanediols, dodecanediols, bisphenol A, hydrogenated bisphenol A, 1,4-cyclohexanediol, 1,4-bis(2-hydroxyethoxy)-cyclohexane, 1,3-cyclohexanedimethanol, 1,4-cyclohexanediol, 1,4-bis(2-hydroxyethoxy)benzene, Esterdiol 204 (propanoic acid, 3-hydroxy-2,2-dimethyl-, 3-hydroxy-2,2-dimethylpropyl ester available from TCI America).

Amines which may be suitable for grafting include alkene derivatives of: N-methylethanolamine, N-methyl iso-propylamine, 4-aminocyclo-hexanol, 1,2-diaminotheane, 1,3-diaminopropane, diethylenetriamine, toluene-2,4-diamine, and toluene-1,6-diamine. Aliphatic compounds containing from 2 to 8 carbon atoms are preferred. ethylenediamine, monomethanolamine, and propylenediamine.

Other acids that may be suitable for grafting include alkene derivatives of bis(hydroxymethyl) propionic acid, diaminobenzoic acid, bis(hydroxymethyl) acetic acid, 2,2,2-tri (hydroxymethyl) acetic acid, 2,2-bis(hydroxymethyl) propionic acid, 2,2-bis(hydroxymethyl) butyric acid, 2,2-bis(hydroxymethyl) pentanoic acid, 2,5-dihydroxy-3-methylpentanoic acid, 3,5-dihydroxy-3-methylpentanoic acid, 4,5-dihydroxy-3-methylpentanoic acid, 3,4-dihydroxy-3-methylpentanoic acid, 2,3-dihydroxy-3-methylpentanoic acid, 2,4-dihydroxy-3-methylpentanoic acid, 2,3-dihydroxybenzoic acid, 2,4-dihydroxybenzoic acid, 2,5-dihydroxybenzoic acid, 2,6-dihydroxybenzoic acid, 3,4-dihydroxybenzoic acid, 3,5-dihydroxybenzoic acid, 2,3-dihydroxysuccinic acid, 2,5-diaminopentanoic acid, 3,5-diaminopentanoic acid, 4,5-diaminopentanoic acid, 2,3-dihydroxybenzenesulfonic acid, 3,4-dihydroxybenzenesulfonic acid, 2,4-dihydroxybenzenelsulfonic acid, 2,5-dihydroxybenzene sulfonic acid, 3,5-dihydroxybenzenesulfonic acid, 2,3-diaminobenzenesulfonic acid, 3,4-diaminobenzenesulfonic acid, 2,4-diaminobenzenesulfonic acid, 2,5-diaminobenzenesulfonic acid, 3,5-diaminobenzenesulfonic acid, 3,4-dihydroxy-2-toluenesulfonic acid, 3,4-xiamino-2-toluenesulfonic acid, 4,5-dihydroxy-2-toluenesulfonic acid, 4,5-diamino-2-toluenesulfonic acid, 5,6-dihydroxy-2-toluenesulfonic acid, 5,6-diamino-2-toluenesulfonic acid, 3,5-dihydroxy-2-toluenesulfonic acid, 3,5-diamino-2-toluenesulfonic acid, 3,6-dihydroxy-2-toluenesulfonic acid, 3,6-diamino-2-toluenesulfonic acid, 4,6-dihydroxy-2-Ttoluenesulfonic acid, 4,6-diamino-2-toluenesulfonic acid, 2,4-dihydroxy-3-toluenesulfonic acid, 2,4-diamino-3-toluenesulfonic acid, 2,5-dihydroxy-3-toluenesulfonic acid, 2,5-diamino-3-toluenesulfonic acid, 2,6-dihydroxy-3-toluenesulfonic acid, 2,6-diamino-3-toluenesulfonic acid, 4,5-dihydroxy-3-toluenesulfonic acid, 4,5-diamino-3-toluenesulfonic acid, 4,6-dihydroxy-3-toluenesulfonic acid, 4,6-dDiamino-3-toluenesulfonic acid, 5,6-dihydroxy-3-toluenesulfonic acid, 5,6-diamino-3-toluenesulfonic acid, 2,3-dihydroxy-4-toluenesulfonic acid, 2,3-diamino-4-toluenesulfonic acid, 2,5-dihydroxy-4-toluenesulfonic acid, 2,5-diamino-4-toluenesulfonic acid, 2,6-dihydroxy-4-toluenesulfonic acid, 2,6-diamino-4-Ttoluenesulfonic acid, 3,5-dihydroxy-4-toluenesulfonic acid, 3,5-diamino-4-toluenesulfonic acid, 3,6-dihydroxy-4-toluenesulfonic acid, 3,6-diamino-4-toluenesulfonic acid, 5,6-dihydroxy-4-toluenesulfonic acid, 5,6-diamino-4-toluenesulfonic acid.

An initiator may be added with the reactive hydrogen provider. The initiator is added and undergoes thermal dissociation to generate free radicals to facilitate and promote grafting. In one configuration the initiator is selected from organic peroxides, such as benzoyl peroxide, dicumyl peroxide, octanoyl peroxide, lauroyl peroxide, stearoyl peroxide, cumene hydroperoxide, tert-butyl peroxide, Cert-butylperoxy laurate, tert-butylperoxy isopropyl carbonate, tert-butylperoxy acetate, and diisopropylbenzene hydroperoxide.

The initiator may be selected from dicumyl peroxide. The initiator may be combined with materials prior to input into the extruder. Alternatively or additionally, the initiator may be injected into the extruder in, or after the melt zone. The initiator is preferably injected following effective mixing of the polymer and coupling agent to ensure homogenous dispersion and efficient radical generation. The initiator may be dissolved in the coupling agent (for example GMA), or an appropriate organic solvent (as in the case of maleic anhydride, as it is a solid at room temperature.

The methods described herein result in the production of a thermoplastic dispersion or emulsion. The emulsion may be prepared from different portions of thermoplastic, where one portion of thermoplastic has undergone functionalisation with a coupling/functionalisation agent to form a functionalised thermoplastic portion, and another portion may be non-functionalised thermoplastic that has not undergone a process to functionalise it. The resultant thermoplastic dispersion or emulsion may comprise particularised thermoplastic, in which about 10, 20, 30, 40, 50, 60, 70, 80, 90 or 100% by weight of the particularised thermoplastic in the emulsion is functionalised thermoplastic, and the remainder of the thermoplastic, if any, is non-functionalised. Accordingly only a portion of the waste used for downstream binder production purposes may be functionalised and this has been found to have beneficial effects in terms of processing speed and efficiency, as well as the cost of functionalisation agents.

The functionalised thermoplastic, for processing by the extruder or TSE in an emulsification zone, may be prepared by the first module of the extruder or TSE that provides melting and functionalisation of the thermoplastic.

Some or all of the functionalised thermoplastic may be obtained from commercially available compatibilised thermoplastic, such as compatibilised PE that is functionalised by, for example, maleic anhydride. Examples 6 and 10 demonstrate the production of composite boards comprising functionalised thermoplastic.

Commercially available compatibilised thermoplastic may be mixed with non-functionalised thermoplastic that has been processed by a first module (melt zone), functionalised thermoplastic that has been processed by the first module (melt zone with one or more coupling agents) or a combination thereof; for subsequent emulsification.

A dispersant may be added to promote the formation of a stable dispersion or emulsion. In selected embodiments, the dispersant may be a surfactant, a polymer or mixtures thereof. In certain embodiments, the polymer may be a polar polymer, having a polar group as either a co-monomer or grafted monomer. In preferred embodiments, the dispersant may comprise a stabilising agent comprising one or more polar polyolefins, having a polar group as either a co-monomer or grafted monomer.

The dispersant may comprise at least one carboxylic acid, a salt of at least one carboxylic acid, or carboxylic acid ester or salt of the carboxylic acid ester. The carboxylic acid, the salt of the carboxylic acid, or the carboxylic acid portion of the carboxylic acid ester or the salt of such ester can have up to 60, or up to 50, or up to 40, or up to 30, or up to 25 carbon atoms. The carboxylic acid, the salt of the carboxylic acid, or the carboxylic acid portion of the carboxylic acid ester or the salt of such ester can have at least 12, at least or at least 15, or at least 20, or at least 25 carbon atoms. If in salt form, the dispersant comprise a cation selected from the group consisting of an alkali metal cation, alkaline earth metal cation, or ammonium or alkyl ammonium cation. The dispersant may be an olefin (e.g. ethylene) carboxylic acid polymer, or its salt, such as ethylene acrylic acid copolymers or ethylene methacrylic acid copolymers.

For example, the dispersant may include an ethylene/alpha-beta unsaturated carboxylic acid copolymer. In some embodiments, the ethylene/alpha-beta unsaturated carboxylic acid copolymer may include an ethylene-acid copolymer, such as an ethylene-acrylic acid copolymer or an ethylene methacrylic acid copolymer. Typical copolymers include ethylene-acrylic acid (EAA) and ethylene-methacrylic acid copolymers, such as those available under the trademarks PRIMACOR™ (trademark of The Dow Chemical Company), NUCREL™ (trademark of E.I. DuPont de Nemours), and ESCOR™ (trademark of ExxonMobil). Other copolymers include ethylene ethyl acrylate (EEA) copolymer, ethylene methyl methacrylate (EMMA), and ethylene butyl acrylate (EBA). Other ethylene-carboxylic acid copolymer may also be used.

Alternatively, the dispersant can be selected from alkyl ether carboxylates, petroleum sulfonates, sulfonated polyoxyethylenated alcohol, sulfated or phosphated polyoxyethylenated alcohols, polymeric ethylene oxide/propylene oxide dispersing agents, primary and secondary alcohol ethoxylates, alkyl glycosides and alkyl glycerides.

Combinations of the above dispersants can be used.

With certain dispersants or compatibilisers it can be desirable to include a neutralizer to improve the effectiveness of the dispersant. For example, if the polar group of the thermoplastic polymer is acidic or basic in nature, the dispersant may be partially or fully neutralized with a neutralizing agent to form the corresponding salt. In certain embodiments, neutralization of the dispersant, such as a long chain fatty acid or EAA, may be from 25% to 200% on a molar basis; from 50% to 110% on a molar basis in other embodiments. For example, for EAA, the neutralizing agent is a base, such as ammonium hydroxide or potassium hydroxide, for example. Other neutralizing agents may include lithium hydroxide or sodium hydroxide, for example. Those having ordinary skill in the art will appreciate that the selection of an appropriate neutralizing agent depends on the specific composition formulated, and that such a choice is within the knowledge of those of ordinary skill in the art.

Described herein is a method of forming a plastic-containing polymer-water dispersion, optionally an emulsion. The dispersion may be formed in one or more extruders, for example single or twin-screw extruders (TSE). The single or twin screw extruders comprise a housing having an inlet end and outlet end and one or two rotating screws within the housing between the inlet end and the outlet end. The thermoplastic is introduced into an inlet end of the one or more single or twin-screw extruders. The one or more single or twin-screw extruders substantially melts the thermoplastic to define a melt zone. In one example, at least a portion thereof of the thermoplastic is reacted with a coupling agent selected from at least one of a grafting compatibiliser, a reactive hydrogen provider and a functionalising agent to define a functionalised thermoplastic.

Particle size reduction in an extruder is via capillary break-up. In the melt zone there is molten polymer. The melt zone may be followed by a molten polymer seal. Past the seal, there is water and optionally surfactant which undergoes high shear mixing to achieve striata-small fibres-that are meta-stable particles. The energy required to obtain particle size reduction using these methods is much lower than standard size reduction techniques.

In some embodiments at least 10% by weight of the thermoplastic may be functionalised. A further portion of thermoplastic comprising 90% or less by weight of the thermoplastic may be non-functionalised. Other proportions of functionalised and non-functionalised material may be used. The degree of functionalised of the functionalised thermoplastic portion may vary according to reaction conditions and reactant availability. In some embodiments the degree of functionalisation of the thermoplastic polymer in a portion of functionalised thermoplastic may be between 0.5% and 6% as discussed earlier.

Twin-screw extruders (TSE) consist of two screws mounted in a barrel having a “Figure-eight” cross section. The “Figure-eight” cross section comes from the machining of two cylindrical bores whose centres are less than two radii apart. Twin screw extruders typically use segmented screws that are assembled on high-torque splined shafts or with solid screws machined from round bar stock. The barrels of the TSEs may be modular. The TSE may also use liquid cooling. The motor of the TSE inputs energy into the process via rotating screws. Feeders meter materials into the TSE. The screws' rpm may be independent of other processing conditions and thus can be set to optimise processing efficiencies. Segmented screws and barrels, in combination with the controlled pumping and wiping characteristics of co-rotating screws, may allow screw/barrel geometries to be matched to the process tasks.

The TSE or other extruder may be modular, with a first module comprising at least the melt zone of the TSE or other extruder and a second module comprising at least the emulsification zone of the TSE or other extruder.

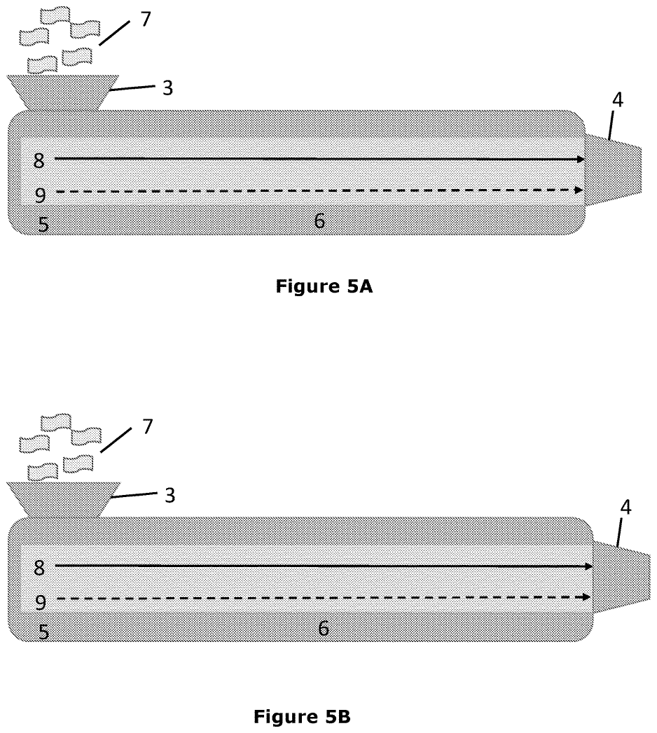

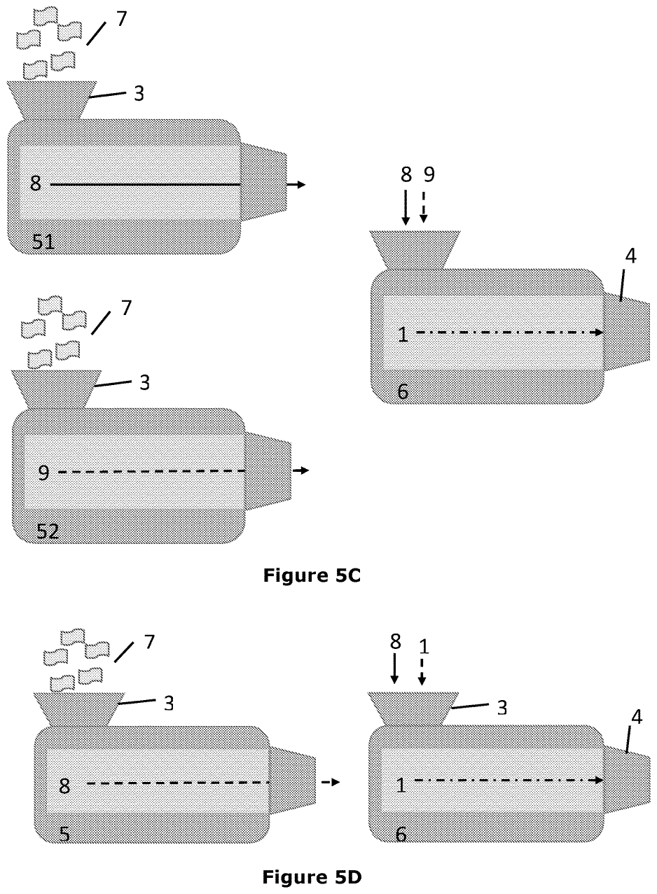

In the case of a single non-modular twin-screw extruder, as shown in FIG. 5A, the thermoplastic 7 will progress directly from the inlet 3 to the outlet 4 passing through each of the various zones of the TSE, such as the melt zone 5 and the emulsification zone 6. Similar zones and modes of operation are found in other extruders which may be substituted for references to twin-screw extruders herein. In one example, all of the thermoplastic being extruded is subjected to the functionalisation reaction(s) to compatibilise the thermoplastic. It will be understood by those of skill in the art that this does not mean that all the thermoplastic polymer groups are actually functionalised. Often only a small proportion of groups will be functionalised, for example, between 0.5% to 6%. There are various reasons for the lack of functionalisation of all polymer functional groups including-blocking of functional groups by other chemical moieties, incomplete melting, mixing or particularisation of the thermoplastic.

In some instances it may be desirable to provide an emulsion that comprises a mixture of particularised functionalised thermoplastic and particularised non-functionalised thermoplastic. In some instances, the particularisation may be achieved within the extruder and does not need to be carried out as a pre-processing step beforehand. A method to achieve this may be to process thermoplastic through a single modular or non-modular extruder in batches with one batch 8 including the addition of one or more coupling agents and/or cross-linker(s), and with a second batch 9 not including the addition of coupling agents nor cross-linker(s). The two resultant thermoplastic dispersions or emulsions could then be subsequently mixed to form a combined thermoplastic dispersion or emulsion having a desired mix of functionalised and non-functionalised particularised thermoplastic. Alternately, as shown in FIG. 5B the functionalised thermoplastic 8 and unfunctionalised thermoplastic 9 may be separately batch processed through a single melt zone 5 and then run through an extruder/TSE emulsification zone 6 to produce an emulsion 17.

Alternately, a combination of extruder/TSE modules, or extruders or TSEs, may be used. For example, as shown in FIG. 5C the method may comprise a plurality of first modules (51 and 52) comprising the melt zone. Thermoplastic in one melt zone module 51 may be reacted with one or more coupling agents, whereas thermoplastic in a second melt zone module 52 may not be reacted with a coupling agent. The resultant melted thermoplastic from both modules may be fed into a second module 6 (i.e. the emulsification module) to provide a resultant thermoplastic dispersion or emulsion 17 having a mixture of functionalised and non-functionalised thermoplastic.

Alternately, as shown in FIG. 5D, thermoplastic 7 may be fed into an extruder/TSE module having a melt zone 5 and reacted with one or more coupling agents to produce melted functionalised thermoplastic 8. The melted functionalised thermoplastic 8 may then be fed into a second module comprising the emulsification zone 6 along with non-melted non-functionalised thermoplastic 1.

The functionalised molten thermoplastic may be emulsified in an emulsification zone of the twin screw extruder by exposing the functionalised molten thermoplastic to water, a surfactant and shear force sufficient to form functionalised thermoplastic having an average particle size (Dv50) of less than 0.5 mm, to produce a functionalised thermoplastic dispersion or emulsion having the water as the continuous phase. The functionalised thermoplastic dispersion or emulsion is then extruded via the outlet end of one of the one or more twin-screw extruders, the emulsion comprising functionalised plastic particles with an average particle size (Dv50) of less than 0.5 mm.

Example 11 provides examples relating to the preparation of wood fibre boards from a variety of recycled thermoplastic feedstocks.

The method may further include the addition of a cross-linker in liquid form, and optionally further water, to the functionalised thermoplastic emulsion at a temperature, within the one or more extruders or twin-screw extruders, insufficient to chemically activate the cross-linker.

The thermoplastic dispersion/emulsion derived from the emulsification/TSE process may be used as a binder. The binder may then be mixed with lignocellulosic material fibre to form a composite mixture and added to a press that applies heat and pressure to the composite mixture to form a lignocellulose-thermoplastic composite.

The extruder or twin-screw extruder may be modular. That is, a first module may comprise the melting zone of the twin-screw extruder, which includes the addition of coupling agents, and a second module may comprise the emulsification zone of the extruder or twin-screw extruder, which includes at least the addition of water and surfactant.

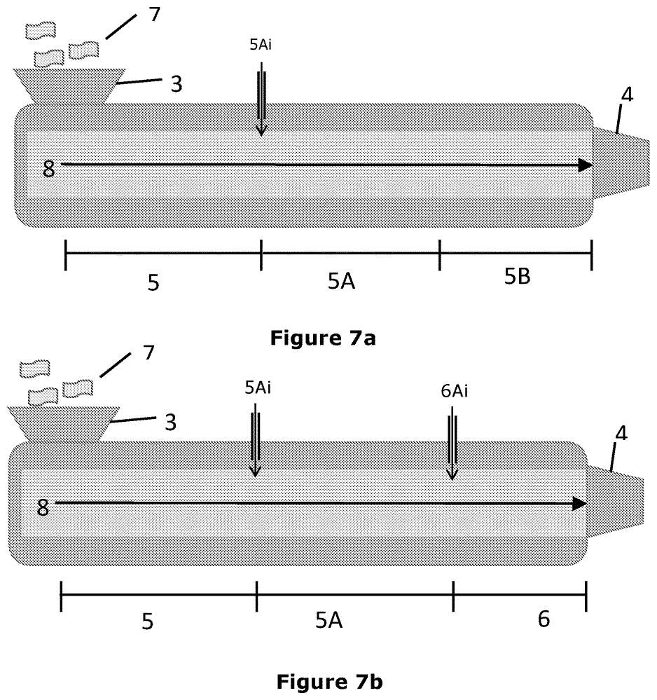

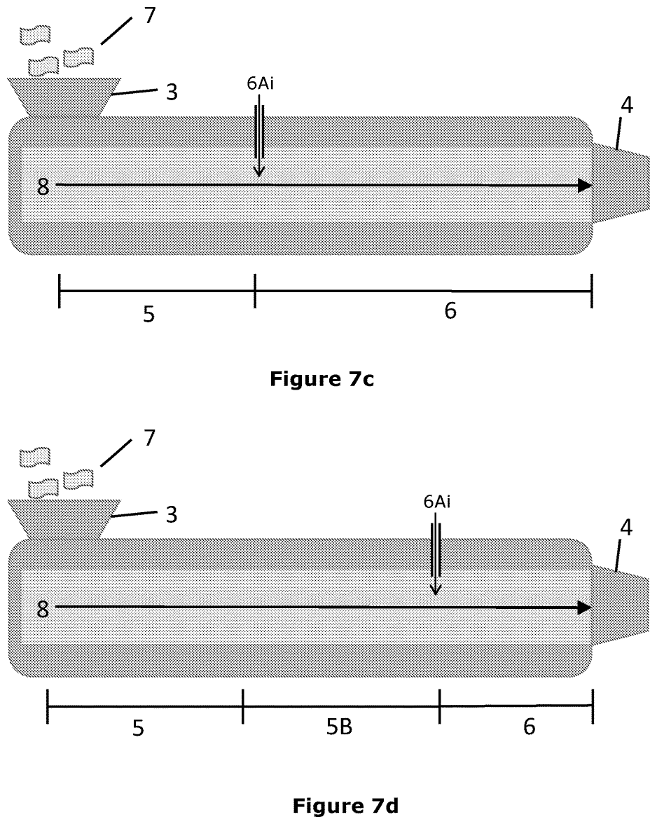

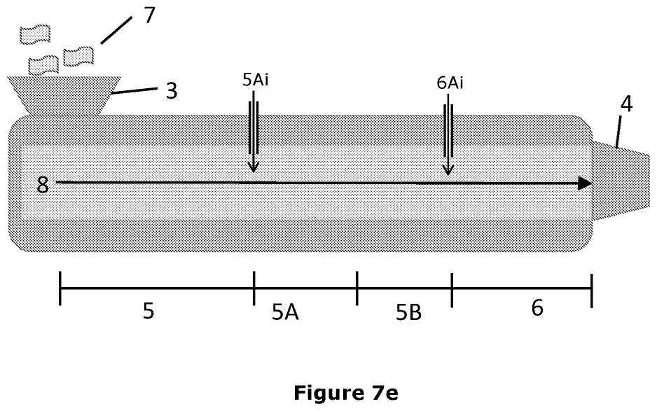

In one example shown in FIG. 7a-e, the extruder comprises zones adapted for specific processing steps.

### TSE Zones

The extruder or TSE is conFigured with different zones which treat the thermoplastic. In one example, thermoplastic conveying and melting occurs in the first portion of the extruder or TSE, termed the “melt zone”. The melt zone may also include a zone for functionalisation of the thermoplastic, which is located downstream of where the thermoplastic melts. The zone for functionalisation includes at least the addition of one or more coupling agents to functionalise the thermoplastic, such that the coupling agents functionalise the thermoplastic after the thermoplastic has melted. The coupling agents may be combined with the thermoplastic prior to feeding into the extruder or TSE, or the coupling agents may be added into the extruder or TSE via an injection port at or after the melting of the thermoplastic in the melt zone.

FIG. 7a-7e show examples in which thermoplastic 7 is processed in an extruder. In FIG. 7a, thermoplastic 7 is fed via a feeder 3 into to an extruder and progresses 8 through a melt zone 5 to provide a melted thermoplastic. The melted thermoplastic progresses to a functionalisation zone 5A where it is mixed with a coupling agent that may be injected at injection port 5Ai, or added concurrently or sequentially with the thermoplastic 7 through the feeder 3. In one example, the functionalisation zone 5A is controlled to provide optimal temperature for functionalisation of the thermoplastic. The functionalised thermoplastic subsequently enters a mixing zone 5B where it is mixed prior to extrusion through outlet 4 to provide a functionalised thermoplastic. The functionalised thermoplastic may be passed through a further extruder to achieve emulsification to provide a thermoplastic dispersion.

In a further example shown in FIG. 7b, the mixing zone of 7a may be replaced or combined with an emulsification zone 6. In this example, water and optionally surfactant is injected at injection port 6Ai and mixed throughout the emulsification zone to provide a functionalised thermoplastic dispersion that is extruded through an outlet 4.

In a further example shown in FIG. 7c, thermoplastic proceeds through a melt zone 5 to an emulsification zone 6. In this example, water and optionally surfactant is injected at injection port 6Ai and mixed throughout the emulsification zone to provide a thermoplastic dispersion that is extruded through an outlet 4.

In a further example shown in FIG. 7d, thermoplastic proceeds through a melt zone 5 to a mixing zone 5B where it is mixed. In this example, water and optionally surfactant is injected at injection port 6Ai and mixed throughout the emulsification zone 6 to provide a thermoplastic dispersion that is extruded through an outlet 4.

In one example, the extrusion process described in 7d occurs after the process described in FIG. 7a.

The extruder may comprise multiple mixing and injection zones.

In a further example shown in FIG. 7e, thermoplastic 7 is fed via a feeder 3 into to an extruder and progresses 8 through a melt zone 5 to provide a melted thermoplastic. The melted thermoplastic progresses to a functionalisation zone 5A where it is mixed with a coupling agent that may be injected at injection port 5Ai, or added concurrently or sequentially with the thermoplastic 7 through the feeder 3. In one example, the functionalisation zone 5A is controlled to provide optimal temperature for functionalisation of the thermoplastic. The functionalised thermoplastic subsequently enters a mixing zone 5B where it is mixed prior to passing to an emulsification zone 6. Water and optionally surfactant is injected at injection port 6Ai and mixed throughout the emulsification zone to provide a functionalised thermoplastic dispersion. The dispersion may be subjected to a further mixing zone (not shown) or a conveying zone (not shown) prior to being extruded through an outlet 4.

The sequential combination of a melt zone, mixing zone then emulsification zone provides particularly effective size-reduction and dispersion preparation. This is believed to be due to the injector port 6Ai being positioned after the mixing zone. The effect of the injector port 6Ai is to reduce the temperature due to the addition of liquid (i.e. water and surfactant) at a significantly lower temperature than the melted material. Without the effective melting and mixing prior to the injector port 6Ai, the material may not be sufficiently size reduced or mixed.

The temperature configuration of the extruder may depend on the reaction requirements. A melt zone is defined as requiring a temperature set point greater than the melting temperature of the thermoplastic being processed. That temperature may be above 130° C. for LDPE, and 160-220° C. for PP. The mixing zone comprises a temperature of approximately the same melt temperature to maintain the molten state of the thermoplastic. An optional venting zone is defined after the mixing zone to enable unreacted monomers to evaporate and purify the thermoplastic output. The temperature in the venting zone is set to enable volatilisation of the coupling agent and may be up to 20° C. hotter than the melting zone, for example greater than 200° C. Prior to exiting the extruder, the temperature may be reduced to reduce viscosity of the extruded material.

The definition of the zones described above will be clear to those of skill in the art. However, by way of example, a melt zone comprises a zone of the extruder with a temperature set point which achieves substantially complete melting of the polymer feedstock. The melt zone may be defined by an aggressive melting-zone design. For example, through the use of neutral/wide kneading-block elements. The melt zone may also use a reverse element. The reverse element may achieve full melting of the thermoplastic polymer. Alternately, the melt zone may be defined by an extended screw design that uses narrow disk kneading-block elements. The narrow disk kneading-block elements may result in less intensive shear-stress input into the thermoplastic polymer, which results in more gradual melting of the polymer.

The extruder screw elements are chosen to perform different unit operations as the ingredients pass down the length of the screw. In one example, there is first a melting then mixing and conveying zone, next an emulsification zone, and finally a dilution and cooling zone. Steam pressure at the feed end is contained by placing kneading blocks and blister elements between the melt mixing zone and is contained and controlled by using a Back-Pressure Regulator. The polyolefin, dispersing agent, compatibilizer and water are melt kneaded in the extruder.

The melt zone may be heated to about 140° C. to about 240° C., or as required to melt the thermoplastic in the melt zone. For some low-melt-point thermoplastics, the melt zone may be set to 95° C. to 140° C. During start-up, the extruder temperature is raised to a higher set-point compared to the operating temperature. In one example the start-up temperature is raised to at least about 150° C. In another example, in which the melting temperature of the thermoplastic is higher, the temperature is raised to about 180° C.

The melt zone may use external heating elements to heat the melt zone. It will be appreciated that when the extruder or TSE initiates, the extruder or TSE will include heat input (such as a heating element or heating jacket). However, once the extruder or TSE has been running for a sufficient period the extruder or TSE will generate heat via frictional heating. As the frictional heat increases, the external heat input may be decreased (potentially removed) so as to prevent over-heating. Overheating can lead to degradation of the thermoplastic indicated by smoke and discoloration. The extruder or TSE may include cooling elements in the melt zone to prevent over-heating. The cooling elements may be in the form of cooling passages. A cooling liquid, such as water, may be run through the cooling passages to cool the extruder or TSE.

During operation, the extruder or twin-screw extruder is maintained at set-point temperatures for the zones along the barrel. In one example, the barrel comprises one or more water cooled zones.

The temperature set-point of the barrel may be automatically adjusted to be maintained at or about a barrel zone temperature set-point. This automated feedback mechanism is achieved using a temperature regulating apparatus. In this apparatus, temperature is sensed using a temperature sensor positioned in or near the barrel then data is fed to a temperature controller. Based on the barrel zone temperature set-point, the controller regulates the temperature using part of the temperature regulating apparatus. The temperature may be regulated by a water-cooling apparatus adapted to cool the barrel. The temperature may be regulated by heating elements adapted to heat the barrel.

There may be multiple extruder zones each comprising a temperature regulating apparatus. Example 2.1 discusses initial experiments using waste polymers. This experiment indicated that to achieve effective emulsification of waste polymers, the temperature set-point of the extruder is preferably set above the melting temperature of the polymers being processed. For example 20% above.

The melt zone may comprise no, or substantially no, water. The presence of water may interfere with the activity of coupling agents that may be present. The melt zone may comprise less than 5, 4, 3, 2, or 1% water by weight of the thermoplastic and suitable ranges may be selected from between any of these values.

Once processed through the melt zone the thermoplastic is processed by a different section of the extruder or TSE. In one example, the next zone comprises a mixing zone. A mixing zone may comprise kneading and mixing elements.

Examples provided herein also comprise an emulsification zone, which includes the addition of water and optionally a surfactant.

Once in the emulsification zone of the extruder or TSE, water and optionally surfactant is added to the thermoplastic that may also be functionalised. As the water and surfactant is added, the thermoplastic may form a bi-continuous phase in the first section of the emulsification zone. A bi-continuous phase is an intermediate phase of water-in-oil and oil-in-water mixture. The bi-continuous phase may be an intermediate phase of water-in-polymer and polymer-in-water mixture. As additional water is added into the emulsification zone the emulsion forms an emulsion with the water as the continuous phase.

The emulsion is formed while being subjected to shear force in the emulsification zone of the extruder or TSE. The shear force is provided for by the design of the extruder, for example the screw or screws in the emulsification zone of the extruder or TSE that impart shear force (or shear stress).

The emulsification zone may comprise a water mixing zone where the water and surfactant is initially mixed, with a shear zone downstream of the water mixing zone to impart shear force. In one example, the water (and optionally surfactant) mixing zone and shear zone are combined to define a dispersion zone. The dispersion zone comes before the dilution zone.

The emulsification zone may include a dilution zone which comprises ports for the addition of further water. That is, an initial amount of water is added prior to the mixing zone optionally along with surfactant. As the material moves downstream of the water mixing zone additional water is injected at the dilution zone. The additional water may be where the bi-continuous phase changes to an oil in water or polymer-in-water phase (having water as the continuous phase).

A surfactant may be blended with the feed mixture prior to entry into the extruder, this is especially effective where solid surfactants such as PVOH are used. Alternately, the surfactant may be injected into the extruder at a position downstream of the feed, and preferably downstream of the melt zone.

The water may be injected via water injection ports, for example 6Ai and optionally further injection ports. That is, the water injection line that terminates in the injection port may include a flow meter and valve to control the amount of water that is added to the extruder or TSE.

The water flow rate may be to achieve a set moisture content of the thermoplastic dispersion being produced. Given that amount is scale dependent, it is typically described in terms of the resin: water ratio w/v. In the method described herein, the resin comprises thermoplastic. In some embodiments, the resin: water ratio is in the range of from 1:1 to 5:1. The resin: water ratio post-mixing zone may be at a ratio of 2:1 to 5:1. This provides water but still maintains a high resin load during the particle breakdown stage. The water input to the dilution zone may be adjusted to achieve a resin: water ratio in the dilution zone of between about 0.8:1 to 1.8:1. The increased amount of water added to the dilution zone, optionally in combination with a surfactant, causes dispersion of the particles to form the thermoplastic dispersion.

The resin: water ratio may be adjusted to achieve a target moisture content of the thermoplastic dispersion. Moisture content is a critical parameter in the production of composite boards such as lignocellulosic material composite boards because too much moisture results in a weak board. Similarly, too little moisture can compromise the ability of certain cross-linkers to effectively bind to the lignocellulosic material.

The thermoplastic dispersion may comprise a moisture content of between 25-75%. The moisture content may be adapted to ensure that the moisture content of a board prepared using the thermoplastic dispersion is in a preferred range. Accordingly, the moisture content of the thermoplastic dispersion is preferably in a range of from 35% to 55%. The moisture content of the dispersion may be adjusted by dilution, for example within the dilution zone of the extruder. Alternatively, it may further be adjusted by drying following extrusion. Achieving a specific preferred moisture content reduces the requirement for drying of the dispersion which has commensurate benefits in reduced energy usage and time for preparation. In this example, the moisture content of the thermoplastic dispersion is between about 40-50%.

The water injection system may be a high pressure low volume system. For example, the system may include an injector, that may be based on a spring loaded ball that mounts in an inlet chamber of the extruder, a manifold and pump. The manifold may include a gate valve, needle valve for adjustment and flow meter.

The inventors have found that the properties of the thermoplastic dispersion obtained following emulsification can affect the properties of materials made with a binder containing the thermoplastic dispersion. In particular, the properties effected a change including particle size, particle size distribution and melt-flow index.

In addition, the properties of the thermoplastic introduced to the extruder also affect the properties of the thermoplastic dispersions produced following emulsification. The inventors have found that using thermoplastic with a higher melt-flow index provides a thermoplastic dispersion with a lower particle size. Smaller particle sizes are more easily mixed with lignocellulosic materials to form a composite panel. Further, smaller particle sizes provide enhanced integration of the binder with the lignocellulosic material

Described is a method of processing a thermoplastic to increase the melt-flow index, then carrying out steps to prepare a thermoplastic dispersion and optionally producing a board. The preparation of the dispersion and board are carried out according to the methods described herein. Thermoplastic dispersions with a higher melt-flow index may be correlated to reduced particle size and reduced particle size distribution.

Cross linkers are added prior to the manufacture of a composite board. The cross-linker may be added in the extruder/TSE or to the extruded thermoplastic dispersion/emulsion or to both the extruder/TSE and the extruded emulsion.

The cross linker may be selected from a participant cross-linker or non-participant cross-linker. A participant cross-linker is one that directly participates in the bonding between the two compounds which are being linked. That is, one end of the participant cross-linker forms a bond with one of the compounds and another end of the participant cross-linker forms a bond with the other compound.

A non-participant cross-linker is one that does not directly participate in the bonding between the two compounds. That is, it does not form bonds with the two compounds being linked. Instead the non-participant cross-linker interacts with one or more of the compounds to provide an active site on at least one of the compounds. This active site then provides a site for bonding between the two compounds.

The temperature of the extruder or TSE may be modified prior to, or during, the addition of the participant cross-linker. The temperature of the extruder/TSE may be reduced by a water based cooling system such as a high pressure water cooling system, barrel cooling or water jacket. The temperature of the extruder/TSE may be reduced by the addition of water. The temperature of the extruder/TSE may be reduced by a combination of both water additional and an active cooling system.

The participant cross-linker may be an isocyanate. Without wishing to be restricted by theory, the addition of isocyanates may also have the effect of reducing the hydrophilicity of the lignocellulosic fibre/material.

The temperature of the extruder/TSE may be modified prior to, or during, the addition of the non-participant cross-linker. The temperature of the extruder/TSE may be reduced by a water based cooling system such as a high pressure water cooling system, barrel cooling or water jacket. The temperature of the extruder/TSE may be reduced by the addition of water. The temperature of the extruder/TSE may be reduced by a combination of both water additional and an active cooling system.

The non-participant cross-linker may be an organic peroxide.

If adding a non-participant cross-linker such as organic peroxide, this may be added at about 0.1, 0.5, 1, 2, 3, 4, or 5% by weight of the thermoplastic dispersion/emulsion, and suitable ranges may be selected from between any of these values. A non-participant cross-linker such as organic peroxide may be added when a grafting compatibilizer or reactive hydrogen provider has been added.

Example 6 show the preparation of wood-fibre composite boards using an organic peroxide cross-linker. Specifically, 1,1-di-(tert-butylperoxy)-3,3,5-trimethylcyclohexane enhanced strength of wood-fibre composite boards prepared with a thermoplastic dispersion of LDPE in water. The organic peroxide cross-linker may be added to a thermoplastic dispersion to form a binder comprising between 1-10% organic peroxide to provide enhanced strength. In some embodiments, where lower strength may be acceptable, the organic peroxide cross-linker is added at between 2 and 8%.

As described, binders may comprise the following:
organic peroxide (e.g. luprox) 3-5%
MAPE 10-20%.
Thermoplastic dispersion 75-87%

As described, a composite board of the invention may comprises the following composition (w/w):
95% Lignocellulosic material (e.g. wood fibre);
4% thermoplastic dispersion
0.75% MAPE
0.25% organic peroxide (e.g. luprox)
   The organic peroxide may be provided in powder or liquid form. Experiments carried out by the inventors indicated that powder form enabled easier mixing. The powdered organic peroxide may comprise 40% benzoyl peroxide.

If adding a participant cross-linker such as an isocyanate, this may be added at about 0.1, 0.5, 1, 2, 3, 4, 5, 6, 7, 8, 9, 10, 11, 12, 13, 14 or 15% by weight of the thermoplastic dispersion/emulsion, and suitable ranges may be selected from between any of these values (for example, about 0.1 to about 15, about 0.1 to about 13, about 0.1 to about 10, about 0.1 to about 8, about 0.1 to about 5, about 0.5 to about 20, about 0.5 to about 19, about 0.5 to about 17, about 0.5 to about 12, about 0.5 to about 9, about 0.5 to about 5, about 1 to about 20, about 1 to about 18, about 1 to about 16, about 1 to about 14, about 1 to about 10, about 2 to about 20, about 2 to about 18, about 2 to about 16, about 2 to about 14, about 2 to about 10, about 3 to about 20, about 3 to about 17, about 3 to about 15, about 3 to about 11, about 3 to about 9, about 4 to about 20, about 4 to about 18, about 4 to about 16, about 4 to about 10, about 5 to about 20, about 5 to about 18, about 5 to about 17, about 5 to about 11, about 6 to about 20, about 6 to about 18, about 6 to about 16, about 6 to about 12, about 6 to about 10, about 7 to about 20, about 7 to about 18, about 7 to about 15, about 7 to about 12, about 7 to about 10, about 8 to about 20, about 8 to about 17, about 8 to about 15, about 8 to about 13, about 8 to about 10, about 9 to about 20, about 9 to about 16, about 9 to about 13, about 10 to about 20, about 10 to about 16, about 11 to about 20, about 11 to about 17, about 12 to about 20, about 12 to about 17, about 13 to about 20, about 13 to about 18, about 14 to about 20, about 14 to about 18 or about 15 to about 20% by weight of the thermoplastic dispersion/emulsion). The participant cross-linker such as isocyanate may be added when a reactive hydrogen provider has been added as a coupling agent.

The inventors have derived preferred stoichiometric ratios of isocyanate to thermoplastic dispersion which achieve effective reaction kinetics and composite board strength. Accordingly, the binder may comprise between 5-20% isocyanate. In other words, the isocyanate is added at 5% to 20% by weight of the binder. In one particular example, a composite board may comprise the following composition (w/w):
90% Lignocellulosic material (e.g. wood fibre);
9% thermoplastic dispersion;
1% eMDI;

An alternative composite board composition may comprise:
90% Lignocellulosic material;
8% thermoplastic dispersion;
2% eMDI.

An alternative composite board composition may comprise:
90% Lignocellulosic material;
9.5% thermoplastic dispersion;
0.5% eMDI.

Example 12 provides various further examples of composite board compositions as described.

Without wishing to be restricted by theory, it is believed that isocyanate reacts with the natural fibres modifying their polarity. Urethane links are formed between the isocyanate functionality and the hydroxyl group of the natural fibres, which may block the hydrophilic hydroxyl sites, which results in the wood fibre being less hydrophilic and thus more compatible with the hydrophobic thermoplastic. As described the use of diisocyanates may form bonds with the reactive moieties of the functionalised polymer. One isocyanate group of the diisocyanate may react with the hydroxyls on the wood fibre and the other isocyanate group react with the reactive moieties on the functionalised polymer. This may form a covalent bonds between the reactive moieties on the functionalised polymer and the diisocyanate.

The isocyanate may also react with other hydroxyls on the lignocellulosic fibre such as wood fibre, which may mask its hydrophobicity. In this manner, the diisocyanate can be used to block polar hydrophobic hydroxyls on the fibre or be used to form covalent bonds with the reactive moieties on the functionalised polymer which can increase the compatibility of the plastic polymer and the wood fibres.

Emulsified isocyanate compounds such as emulsified methylene diphenyl diisocyanate (eMDI) may be used as a cross-linker in conjunction with thermoplastic dispersions to make composite boards. Example 5 demonstrates that when combining an isocyanate with a thermoplastic dispersion (for example one prepared according to the methods described herein), eMDI achieves better mixing properties and enhanced strength compared to pMDI.

### Binder Formulation

Thermoplastic dispersions may be formulated into a binder by combining the dispersion with one or more cross-linking agents as described in detail above. To form a composite board, the binder is then combined with a lignocellulosic material. The binder may comprise between 1% and 50% of a composite mixture. However, providing more than 20% of binder within a board may compromise the properties of the board due to the decreased fibre content which provides a physical matrix to provide enhanced strength.

Accordingly, the binder formulation may comprise 1, 2, 3, 4, 5, 6, 7, 8, 9, 10, 11, 12, 13, 14, 15, 16, 17, 18, 19 or 20% by weight of the composite board, and suitable ranges may be selected from between any of these values (for example, about 1 to about 20, about 1 to about 18, about 1 to about 16, about 1 to about 14, about 1 to about 10, about 2 to about 20, about 2 to about 18, about 2 to about 16, about 2 to about 14, about 2 to about 10, about 3 to about 20, about 3 to about 17, about 3 to about 15, about 3 to about 11, about 3 to about 9, about 4 to about 20, about 4 to about 18, about 4 to about 16, about 4 to about 10, about 5 to about 20, about 5 to about 18, about 5 to about 17, about 5 to about 11, about 6 to about 20, about 6 to about 18, about 6 to about 16, about 6 to about 12, about 6 to about 10, about 7 to about 20, about 7 to about 18, about 7 to about 15, about 7 to about 12, about 7 to about 10, about 8 to about 20, about 8 to about 17, about 8 to about 15, about 8 to about 13, about 8 to about 10, about 9 to about 20, about 9 to about 16, about 9 to about 13, about 10 to about 20, about 10 to about 16, about 11 to about 20, about 11 to about 17, about 12 to about 20, about 12 to about 17, about 13 to about 20, about 13 to about 18, about 14 to about 20, about 14 to about 18 or about 15 to about 20% by weight of the composite board). If too little binder is included in a formulation, the lignocellulosic particles are insufficiently coated to create effective bonds between the particles. This provides a board that breaks apart under load. Accordingly, the lignocellulosic material: binder ratio may be in a range of from approximately 80% lignocellulosic material: 20% binder to 95% lignocellulosic material to 5% binder. In other examples, the lignocellulosic material: binder ratio may be in a range of from approximately 85% lignocellulosic material: 15% binder to 92% lignocellulosic material to 8% binder.

Example 12 shows that composite boards with lower lignocellulosic material experience less swelling and are therefore more suitable for outdoor or humid environments. Accordingly, for boards that exhibit less than 20% swelling over 24 hours the lignocellulosic material: binder ratio comprises a range of approximately 90:10 to 85:15.

Composite boards may be designed to achieve certain minimum strength standards.

Example 12 provides exemplary binder compositions comprising varying levels of cross-linker, thermoplastic dispersion and lignocellulosic material. The modulus of elasticity of a composite board prepared using a thermoplastic dispersion prepared according to the methods described herein is at least 1000 MPa when measured according to ASTM D1037 or EN310. This provides boards suitable for lightweight usage. In alternative examples where stronger boards are required, a composite board may have an MoE of greater than 1200, 1400 or 1600 depending on the end use requirements. Examples 15 and 16 provide examples of composite boards meeting these strength requirements with varying levels of cross-linker. In examples, the binder comprises thermoplastic dispersion at between 85-94%, and cross-linker at between 6 and 15%. Where composite boards are prepared according to the methods described herein, the binder may comprise between about 5 to 20% of a composite mixture used to prepare a composite board, the remainder being comprised of lignocellulosic material. In alternative examples, the binder comprises between about 8 and 15% of a composite mixture, the remainder comprising lignocellulosic material such as wood chip.

Combining the binder with a suitable lignocellulosic material may be achieved in a number of ways including mixing with a paddle mixer, mixing by tumbling, and/or spraying of the binder while mixing. The preparation of a thermoplastic dispersion as described herein provides enhanced mixing and resultant board properties compared to simply mixing size-reduced thermoplastic with a cross-linker and lignocellulosic substrate.

Isocyanates are highly reactive compounds. Blocking agents can be used to control reactivity by blocking the isocyanate functionality, forming blocked isocyanates. However, if the isocyanate is added to the emulsion immediately prior to mixing with the lignocellulosic material for forming into a thermo-plastic composite product, then blocking may not be required.

When the blocked isocyanate is heated to a certain temperature, the blocking agents separates from the isocyanate, thus restoring the isocyanate functionality. Blocking agents enable the mixing of components without the isocyanate reacting. When it is desirable for the isocyanate functionality to be restored, the components can be heated and the isocyanate can react. The isocyanate functionality may be blocked until such a time that the waste plastic has sufficiently wet the wood chips. This prevents the isocyanate reacting with water before the plastic has melted. Use of blocking agents produces a compound that is seemingly inert at room temperature yet yields the reactive isocyanate functionality at elevated temperatures.

Examples of blocking agents include phenol, cardanol, cresol, xylenol, nitrophenol, ethylphenol, hydroxydiphenyl, butylphenol, isopropylphenol, nonylphenol, octylphenol, methyl hydroxybenzoate, and like phenol compounds; s-caprolactam, o-valerolactam, y-butyrolactam, β-propiolactam, and like lactam compounds; methanol, ethanol, propyl alcohol, butyl alcohol, amyl alcohol, lauryl alcohol, and like aliphatic alcohol compounds; ethylene glycol monomethyl ether, ethylene glycol monoethyl ether, ethylene glycol monobutyl ether, diethylene glycol monomethyl ether, diethylene glycol monoethyl ether, propylene glycol monomethyl ether, methoxymethanol, and like ether compounds; benzyl alcohol; glycolic acid; methyl glycolate, ethyl glycolate, butyl glycolate, and like glycolates; lactic acid, methyl lactate, ethyl lactate, butyl lactate, and like lactates; methylol urea, methylol melamine, diacetone alcohol, 2-hydroxyethyl acrylate, 2-hydroxyethyl methacrylate, and like alcohol compounds; formamide oxime, acetamide oxime, acetoxime, methyl ethyl ketoxime, diacetyl monoxime, benzophenone oxime, cyclohexane oxime, and like oxime compounds; dimethyl malonate, diethyl malonate, ethyl acetoacetate, methyl acetoacetate, acetylacetone, and like active methylene compounds; butyl mercaptan, t-butyl mercaptan, hexyl mercaptan, t-dodecyl mercaptan, 2-mercaptobenzothiazole, thiophenol, methylthiophenol, ethylthiophenol, and like mercaptan compounds; acetanilide, acetanisidide, acetotoluide, acrylamide, methacrylamide, acetic acid amide, stearic acid amide, benzamide and like acid amide compounds; succinimide, phthalimide, maleimide, and like imide compounds; diphenylamine, phenylnaphthylamine, xylidine, N-phenylxylidine, carbazole, aniline, naphthylamine, butylamine, dibutylamine, butylphenylamine, and like amines; imidazole, 2-ethylimidazole, and like imidazole compounds; 3,5-dimethylpyrazole and like pyrazole compounds; urea, thiourea, ethylene urea, ethylenethiourea, diphenylurea, and like urea compounds; phenyl N-phenylcarbamate and like carbamate compounds; ethyleneimine, propyleneimine, and like imine compounds; and sodium bisulfite, potassium bisulfite, and like sulfite compounds. In some embodiments the cross-linker, such as an isocyanate or organic peroxide, may be added to the functionalised plastic emulsion immediately prior to the addition of a lignocellulosic substrate/material.

The temperature of the extruder or TSE upon addition of the blocked isocyanate must be reduced to below the unblocking temperature of the isocyanate, for example, through the addition of water and/or use of cooling passages in the extruder/TSE. Shown below in a table showing the unblocking temperature of various isocyanate blocking agents.

| Isocyanate | Unblocking temperature |
|---|---|
| blocking agent | (° C.) |
| Sodium bisulfite | 85 |
| Diethyl malonate | 110 |
| 3,5-Dimethylpyrazole | 115 |
| Methylethyl ketoxime | 135 |
| Phenol (e.g. Cardanol) | 150 |
| Caprolactam | 170 |

The cross-linker may be added in the form of a powder or another form of solid. The cross-linker is typically added in a small amount to the extruder/TSE and so is added to the TSE in liquid form, that is, solubilised in water.

Following the addition of the cross-linker, additional water may be added to the TSE.

Where the cross-linker is a non-participant cross-linker such as an organic peroxide, the emulsion may be dried to a water content of less than about 3% by weight.

Where the cross-linker is a participant cross-linker such as an isocyanate, then drying may not be required. That is isocyanates are more aqueous tolerant compared to organic peroxide cross-linkers. The presence of increased water may provide a benefit of heat transfer in the board making process. The isocyanate containing emulsion may have a solids content of about 30, 40, 50, 60 or 70% by weight, and suitable ranges may be selected from between any of these values. In some preferred embodiments the isocyanate containing emulsion may have a solids content of about 50, 55, 60, 65, or 70% by weight, and suitable ranges may be selected from between any of these values. In some embodiments additional water may be used. For example, additional water may be added to dilute the emulsion immediately prior to board making. The addition of water may allow the viscosity to be controlled.

The binder mix comprises at least a thermoplastic dispersion and a cross-linker and may be used in the manufacture of a plastic composite, such as a panel or board. Where the plastic composite is mixed with a lignocellulosic substrate/material, the board may be selected from fibreboard, oriented strand board, wafer board, particle board, softboard, MDF and/or hardboard

In alternative examples the binder material is used in the preparation of a composite material selected from the group consisting of fibre-reinforced polymers (FRPs), glass fibre-reinforced polymer (GFRP or fibreglass), carbon fiber-reinforced polymer (CFRP), aramid fibre-reinforced polymer (AFRP e.g. Kevlar), particle-reinforced composites, polymer cement and concrete, metal matrix composites (MMCs), laminated composites, plywood, laminated safety glass, adhesive-based composites joints or laminates. In an alternative embodiment, the binder may be used as an adhesive with or without combining it with a substrate.

The composite boards as described may meet an industry need to make use of recycled and waste plastic feedstocks. Further, they composite boards also provide greater durability and water resistance. In particular, using isocyanate cross-linkers integrated into a thermoplastic polymer matrix form bonds through a reaction that is essentially non-reversible. This results in a more durable and moisture-resistant bond, which is particularly advantageous in applications where exposure to wet or humid conditions is expected. Isocyanate-theroplastic binders provide enhanced resistance to water and humidity, ensuring the longevity and integrity of the bond in challenging environments.

The cross-linker may be added in the form of a powder or another form of solid. When added directly to an extruder/TSE, the cross-linker is typically added in a small amount in liquid form, that is, solubilised in water. Following the addition of the cross-linker, additional water may be added to the extruder/TSE.

Where the cross-linker is a non-participant cross-linker such as an organic peroxide, the emulsion may be dried to a water content of less than about 3% by weight.

Where the cross-linker is a participant cross-linker such as an isocyanate, then drying may not be required. That is isocyanates are more aqueous tolerant compared to organic peroxide cross-linkers. The presence of increased water may provide a benefit of heat transfer in the board making process. The isocyanate containing emulsion may have a solids content of about 30, 40, 50, 60 or 70% by weight, and suitable ranges may be selected from between any of these values. In some preferred embodiments the isocyanate containing emulsion may have a solids content of about 50, 55, 60, 65, or 70% by weight, and suitable ranges may be selected from between any of these values. In some embodiments additional water may be used. For example, additional water may be added to dilute the emulsion immediately prior to board making. The addition of water may allow the viscosity to be controlled.

Achieving a target moisture content in binders and composite boards prepared according to the methods described herein may be important in determining binding and strength. Cross-linkers such as isocyanates and organic peroxides are highly reactive chemicals and can react with, or be inhibited by hydroxyl groups present in lignocellulosic fibres. For example isocyanate (—NCO) groups reacting with the hydroxyl group (—OH) to create urethane bonds (—NHCOO—). The moisture content in wood fibres affects the availability of these OH groups. If the wood fibrs are too dry, there may not be enough moisture to facilitate the reaction with isocyanates, leading to poor bonding and reduced board quality. Therefore it is particularly important to match the moisture content of the board to the type of cross-linker being used.

The moisture content of the pre-press composite mixture containing isocyanate may be greater than about 5%. This helps ensure that the isocyanate has sufficient binding capacity.

Example 11 describes the preparation of composite mixtures comprising between about 8% and 14% moisture content.

Further, following experimental verification, it has been found that boards comprising a composite mixture produced in a press should have a total pre-press moisture content of less than about 15%. This minimizes the risk of issues like excessive board expansion or warping during pressing and curing. Excessive steam produced in the board leads to bubbles and which can lead to failure. Accordingly, the total pre-press moisture content of a composite mixture may comprise between about 5% to about 15%.

Described is a composite mixture comprising isocyanate cross-linker, lignocellulosic substrate and a thermoplastic dispersion described herein, where the moisture content of the board is between 5 and 15%

Unconditioned lignocellulosic materials such as wood chip often has a moisture content of from 8-12%. Taking this into account, a binder comprising cross-linker plus thermoplastic dispersion preferably comprises less than 45% moisture content.

As shown in examples 6 and 10 using organic peroxides, the inventors have found that higher moisture contents can compromise binding. Accordingly, when the cross-linker comprises an organic peroxide, the total board moisture content may comprise less than 10%. When using binder at 10% of the composite mixture, and organic peroxide at 5% of binder formulation, the moisture content of the thermoplastic dispersion is preferably reduced to below 1% to achieve effective binding.

The method for making a thermoplastic composite board broadly includes the steps of introducing a composite mixture into a press or mould that contains the binder and fibrous or particulate lignocellulosic material. The composite mixture may comprise about 4% to about 30% by weight of the binder, the remainder being provided by the lignocellulosic material-being a fibrous or particulate substrate. Examples 6 and 11 provide several examples of different binder and composite mixture ratios.

It will be appreciated by the person skilled in the art that a press or mould may include any apparatus which applies heat and/or pressure to produce a flat or shaped solid product. Non-limiting examples of a press or mould may include a 3-D mould capable of producing complex 3-dimensional product, an injection mould, compression mould, transfer mould or rotational mould.

In another example, the thermoplastic dispersion or binder described herein may be used as a resin in other applications such as 3D printing.

The lignocellulosic material or fibrous or particulate substrate may comprise wood (such as sawdust, wood fibre, wood particles, wood chips or wood sheets), coconut husk, rice straw or husk, barley straw, or bamboo. The selection of the lignocellulosic material or fibrous or particulate substrate will define the nature and use of the composite material product.

Examples provided herein describe several instances of the preparation of composite board using wood fibre. In addition, Example 7 describes the preparation of composite boards using a variety of other lignocellulosic materials.

For plywood and glulam style wood products, the wood may be in the form of sheets, that are glued to one another through the use of the binder. In this case the sheets of wood may have at least one dimension that is greater than about 1 m in length.

For other products, such as oriented strand board, wafer board, particle board, softboard, MDF or hardboard, the lignocellulosic-based material/substrates may have at least one dimension (such as the major dimension) less than 500 mm in length. For example an oriented strand board may comprise a lignocellulosic-based material/substrate in which the major dimension is between about 50 mm to about 500 mm. A wafer board may comprise a lignocellulosic-based material/substrate in which the major dimension is between about 10 mm to about 50 mm. A particle board may comprise a lignocellulosic-based material/substrate in which the major dimension is between about 1 mm to about 15 mm. Softboard, MDF and hardboard may comprise a lignocellulosic-based material/substrate in which the major dimension is between about 1 mm and 5 mm.

In relation to lignocellulosic-based material/substrates, the substrate may be sourced from a range of different lignocellulosic-based material products. For example, a fine grade of lignocellulosic-based material/substrate may have an average particle size of about 0.5, 1, 1.5, or 2 mm, and suitable ranges may be selected from between any of these values (for example, about 0.5 to about 2, about 0.5 to about 1.5, about 0.5 to about 1, about 1 to about 2, about 1 to about 1.5 or about 1.5 to about 2 mm). For example, the fine grade of lignocellulosic-based material/substrate may be sourced from sawdust, or wood flour. It will be appreciated that any source that results in a lignocellulosic-based material/substrate having an average particle size as defined above may be appropriate for use. For example, the use of grinding such as the use of a hammer mill. A grinder system may control the size of the particles produced through the use of grinder screens, which are screens having a mesh with set perforation sizes.

The lignocellulosic-based material/substrate may be a coarser grade of substrate having an average particle size of about 1, 2, 3, 4, 5, 6, 7, 8, 9, 10, 11, 12, 13, 14 or 15 mm, and suitable ranges may be selected from between any of these values (for example, about 1 to about 15, about 1 to about 13, about 1 to about 10, about 1 to about 8, about 1 to about 5, about 2 to about 15, about 2 to about 14, about 2 to about 10, about 2 to about 6, about 3 to about 15, about 3 to about 12, about 3 to about 9, about 4 to about 15, about 4 to about 11, about 4 to about 8, about 5 to about 15, about 5 to about 13, about 5 to about 10, about 6 to about 15, about 6 to about 12, about 6 to about 10, about 6 to about 8, about 7 to about 15, about 7 to about 11, about 8 to about 15, about 8 to about 13, about 9 to about 15, about 9 to about 12 or about 10 to about 15 mm). For example, the coarser grade of wood-based substrate may be sourced from wood chips and wood pellets.

When defining the size of the lignocellulosic material particles as the “average particle size” it will be appreciated that lignocellulosic material particles are not uniform in size. Given lignocellulosic material particles are often irregular in shape the average particle size refers to the length of the longest axis.

A conventional method to obtain the particle size distribution is mechanical sieving. American Society of Agricultural and Biological Engineers (ASABE Standard S424.1, 2007) developed the mechanical sieving method as a standard particle size analysis for biomass particles. Mechanical sieving determines the mass percent of particles retaining on each sieve. However, since particles pass through the sieves based on their width the length of the particles is ignored in a sieving process. Given the particles may be mostly irregular and heterogeneous in size and shape two particles that pass through the same sieve may have different shapes.

Rather than the conventional mechanical sieving approach, advanced techniques such as machine vision are able to analyse particle size and shape using image analysis techniques. Image analysis is a practical method to determine the actual dimensions and shape of single particles. Image analysis is not subjective and is repeatable over the same picture.

Another method to characterise the size of lignocellulosic material particles may be to look at the bulk density of a product. Smaller particles will rearrange themselves to a more efficient packing condition thus having a higher bulk density. For example, the bulk density of wood sawdust is about 370 kg/m3 to about 415 kg/m3.

If a lignocellulosic material-composite product is desired then the substrate may include both a fine and coarse wood substrate as mentioned above. The board is formed by first preparing a fine mixture and a course mixture. The fine mixture is prepared by mixing the fine wood fibre with the binder that comprises functionalised thermoplastic and cross linker. The coarse mixture is prepared by mixing the coarse lignocellulosic material fibre with the binder, that comprises functionalised thermoplastic and the cross linker.

When forming a board the board may be formed by first layering the fine composite mixture in the base of the mould, then the coarse composite mixture and then the fine composite mixture on top to sandwich the coarse mixture. The prepared composite material is then pressed under pressure and temperature. In some embodiments the ratio of fine composite mixture to coarse composite mixture is about 20:80 to 80:20. It will be appreciated that when the fine composite mixture is prepared that it can be divided into use as the top and bottom layer. Typically the ratio of division is from 40:60:60:40, and about 50:50 is preferred.

The ratio of coarse composite mixture to the fine composite mixture may be between 20:80 to 80:20 as mentioned above, and a ratio of 40:60 to 60:40 are also contemplated.

In one preferred embodiment the board is formed from 20% by weight fine composite mixture, 60% by weight of the coarse composite mixture and then 20% by weight of the fine composite mixture.

In relation to a plywood style composite product, the binder is placed between the sheets, for example by spraying or spreading of the binder.

The composite material is formed as a mat in a press. The mat may be subjected to pre-compression in a continuous press or a separate stage in a non-continuous press to make the mat more compact prior to placement in a hot press. The thickness of the composite material decreases under pressure such that the cured final product may be about 10, 15, 20, 25, 30 or 35% of the thickness of the original composite material mixture prior to pressure and heat.

The pressure applied to the composite mixture may be about 3, 4, 5, 6, 7, 8, 9 or 10 MPa, and suitable ranges may be selected from between any of these values (for example, about 3 to about 10, about 3 to about 9, about 3 to about 7, about 3 to about 6, about 3 to about 5, about 4 to about 10, about 4 to about 8, about 4 to about 6, about 5 to about 10, about 5 to about 8, about 5 to about 7, about 6 to about 10, about 6 to about 9 or about 7 to about 10 MPa).

The temperature of the press or mould is such that the composite material is heated to about 100 to about 220° C. This is a temperature sufficient to melt the binder allowing it to coat and bind the substrate and form the product. In some embodiments some thermoplastic within the binder may not melt, which may be the case where the binder comprises thermoplastic contaminants. That is, while enough thermoplastic within the binder may be melted to form a continuous phase that coats the substrate, some thermoplastic in the binder may remain unmelted and remain as a particulate in the composite material.

Several factors can influence the hot-pressing process, including press temperature, moisture content (MC) of the mat, press closing speed, characteristics of the resin, and the type of wood chip particles. The rate at which the press temperature increases notably impacts the adhesive curing rate. This not only affects the total press time but also plays a crucial role in creating a vertical density gradient within the material. Among these factors, mat moisture content significantly affects heat transfer within the mat. The speed at which heat penetrates the mat determines the required press time. Higher MC in mats necessitates more energy for water vaporization.

It will be appreciated that the top and bottom fine mixture layers may be exposed to greater heating compared to the inner coarse mixture layer. Given this, the functionalised thermoplastic used in the binder of the fine mixture may comprise functionalised thermoplastics having a higher melting point compared to the plastic used in the binder for the coarse mixture (used in the middle layer of the board).

Each fine layer may comprise 5, 10 or 15% of the total thickness of the mat, and suitable ranges may be selected from between any of these values.

The functionalised thermoplastic may be a mixture of low-density or high density PE and PP. The functionalised thermoplastic may comprise a small percentage of contaminant thermoplastic, The composite mixture is subjected to pressure sufficient to decrease the thickness of the composite mixture, and subsequently heating the composite mixture to about 100, 110, 120, 130, 140, 150, 160, 170, 180, 190, 200, 210 or 220° C. to form the wood composite panel, and suitable ranges may be selected from between any of these values.

A releasing agent may be applied to the surface of the press to prevent sticking of the composite to the press platens. In some embodiment the external layers of the composite may include urea formaldehyde to inhibit sticking of the composite to the press, for example the UF fine composite mixture layer referred to above.

The particle size of the functionalised thermoplastic may be smaller for the fine fibre compared to the coarse fibre. That is, to achieve effective coating of the fine fibre this may be best achieved by utilising thermoplastic particles with a finer average particle size to ensure good coating of the fine lignocellulosic material fibres.

The cross linker used between the fine mixture and the coarse mixture may be different. For example, the cross linker used in the fine mixture may be selected based on performance at higher temperatures, whereas the cross linker used in the coarse layer may be selected based on its performance at a lower temperature.

The moisture content of the fine layer may be increased relative to the coarse layer.

The composite mixture may also comprise an additive. The additive may be present in the binder. The additive may be selected from any one or more of
a) an accelerator,
b) a modifier,
c) an activator, and/or
d) a catalyst.

In relation to the accelerator, the accelerator may be an amine based accelerator. More particularly the accelerator may be a toluidine based accelerator. Specifically, the accelerator may be selected from N-(2-Hydroxylethyl)-N-Methyl-para-Toluidine, ethoxylated para-Toluidine, N,N-Dimethyl-p-Toluidine, N, N-Dihydroxyethyl-p-Toluidine, Diisopropoxy-p-Toluidine or a combination thereof.

The binder may comprise 0.5, 1.0, 1.5, 2.0, 2.5, or 3.0 by weight of the binder of accelerator, and suitable ranges may be selected from between any of these values.

Without wishing to be bound by theory the accelerator increases the amount of free radicals by the cross linking agent, which increases the rate of polymerisation of the functionalised thermoplastic material to theromoset material.

The boards produced may have a modulus of elasticity (MoE) of about 1,000, 1500, 2000, 2500, 3000, 3500 or 4000 MPa, and suitable ranges may be selected from between any of these values. Static bending is often used for machine stress rating (MSR) of timber-based products. MSR is currently the most common dynamic, mechanical load procedure. Boards are fed through a machine flat wise, longitudinally and bent by rollers upwards and downwards in two sections. The span between the rollers is typically around 1.2 m. Depending on the design, the machine bends the boards to a constant deflection and measures the required force or the machine bends the boards with a constant force and measures the deflection. Using the load deflection relationship, the local MOE can be determined directly by using equations sourced from fundamental mechanics of material on every point of the board except for approximately the first and last 500 mm. This test method allows the stiffness profile of a board to be determined.

The composite boards produced have a Modulus of Rupture (MOR) of about 5, 10, 15, 20 or 25 Mpa, and suitable ranges may be selected from between any of these values. The MOR (sometimes referred to as bending strength), is a measure of a specimen's strength before rupture. It can be used to determine a wood-based products overall strength; unlike the modulus of elasticity, which measures the wood's deflection, but not its ultimate strength. The MOR “sigma” can be calculated using the equation σr=3Fx/yz2 for the load force F and size dimensions in three directions, x, y and z, of the material. In this case, the load is the external force put on the material of interest. The load force is applied to the centre of the composite product of the material elevated slightly above ground.

In some embodiments the composite product as a surface screw holding of about 200, 250, 300, 350, 400, 450 or 500 N, and suitable ranges may be selected from between any of these values (for example, about 200 to about 500, about 200 to about 400, about 200 to about 300, about 250 to about 500, about 250 to about 450, about 250 to about 350, about 300 to about 500, about 300 to about 450, about 350 to about 500, about 350 to about 450 N).

The density of the composite board can be controlled by the degree of compression applied in the press or mould. For example, a lower pressure can be used to provide a low density composite board having a density of about 550, 560, 570, 580, 590, 600, 610, 620, 630, 640 or 650 kgm³, and suitable ranges may be selected from between any of these values.

A greater pressure can be used to provide a mid density composite board having a density of about 650, 700, 750 or 800 kgm³, and suitable ranges may be selected from between any of these values.

A greater pressure can be used to provide a high density composite board having a density of about 800, 850, 900, 950, 1000, 1050 or 1100 kgm³, and suitable ranges may be selected from between any of these values.

### EXAMPLES

### Standard Methodology

Unless stated otherwise, the following testing methods and board properties were used in the examples provided below:

TABLE 1
Standard methodologies used in the present invention

| Property | Test Based on |
|---|---|
| Density | ASTM D1505 |
| Melt flow index | ASTM1238 |
| (190° C./2.16 kg) | |
| Melting temperature (° C.) | ISO11357 |
| Composition of polymer | ISO11357 |
| Degree of cross-linking (wt %) | ASTM D2765 |
| Modulus of elasticity (MOE) | EN310 |
| Modulus of rupture (MOR) | EN310 |
| Internal bond strength | EN319 |
| Soak/swelling in thickness | EN317 |
| Board Size | 450 × 450 mm |
| Board Thickness | 15 mm |
| Target Board Density | 620 kg/m3 |
| Target Moisture Content in | 10-12% |
| composite mixture | |

### Example 1—Thermoplastic Polymer Characterisation

### Aim

Analysis of various plastics was carried out to understand their composition and identity. This characterisation is an important first step when using unknown waste/recycled plastics, especially where downstream processes (for example functionalisation and emulsification) are sensitive to the feedstock identity and composition.

### Methodology

### FTIR Analysis

Post-industrial recycled LDPE (Astron) was analysed to assess the amount of LDPE and other polymers. Four different blends were prepared as calibration standards and made from Recycled PP Pellets and Post-industrial recycled LDPE pellets. The pellets were homogenously mixed and fed into a twin-screw extruder using a gravimetric feeder. Once the extrudate output stabilized it was pelletized and collected. The pellets were dried in an oven overnight at 40° C. to remove any moisture present. Measurements were performed using the PerkinElmer Spectrum Two FT-IR fitted with a diamond ATR accessory according to manufacturer's instructions. 4 scans were averaged at 400-4000 wavenumbers (cm⁻¹) with a resolution of 4 cm⁻¹. For each blend, 6 pellets were randomly selected and measured. Data was processed using PerkinElmer Spectrum IR software and the peak areas of the 1377 cm⁻¹ and 1462 cm⁻¹ peak were analysed. The quantitative method uses the ratio between the CH₃ umbrella in-phase bending mode (mainly in PP) and the CH₂ and CH₃ bending mode which is present in both PE and PP.

### Differential Scanning Calorimetry

Differential scanning calorimetry (DSC) analysis was carried out according to manufacturers instructions.

### Samples Analysed

The following samples were analysed:

TABLE 2
Plastic Samples analysed

| Sample | | |
|---|---|---|
| no. | Material | Form |
| 1a | Post-industrial | Pelletised |
| | LDPE (Astron) | |
| 1b | Post-agricultural | Film |
| | LDPE film (Bale | |
| | wrap (green)) | |
| 1c | Post-construction | Shredded and pelletised |
| | film (building wrap) | by twin-screw extruder |
| 1d | Virgin LDPE A (LD | Pellet |
| | 104BR from ExxonMobil) | |
| 1e | Virgin LDPE B (Alkathene | Pellet - contains process |
| | LDH210 from Qenos) | stabilisation additive |

### Results

Results and conclusions relating to each plastic are provided below:

1a—Results-Post-Industrial LDPE

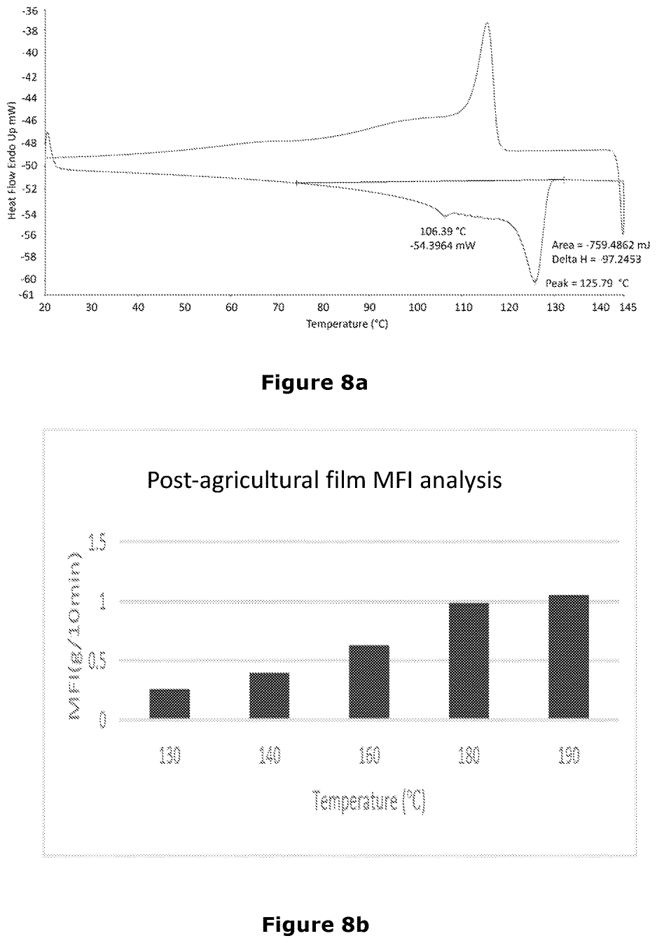

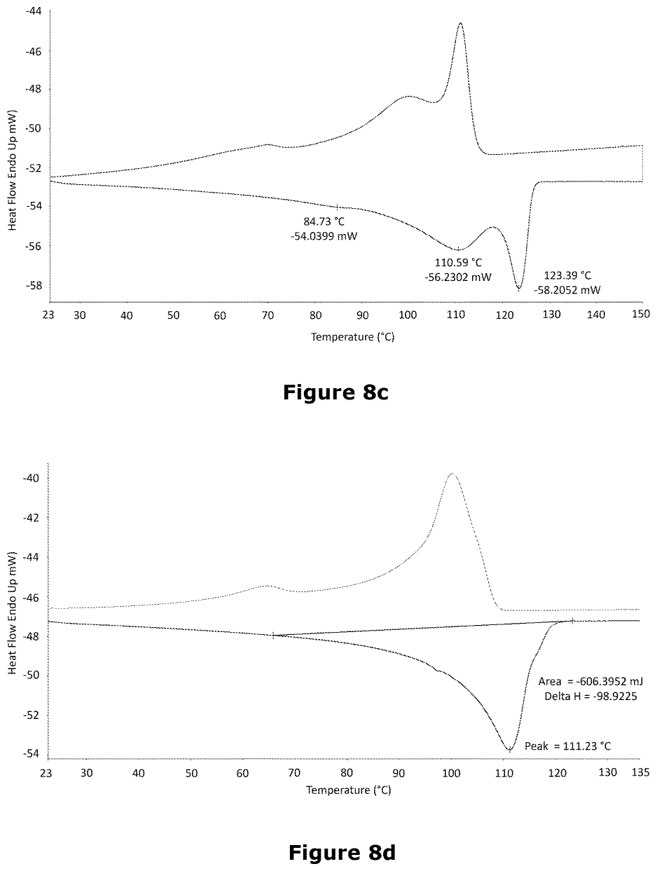

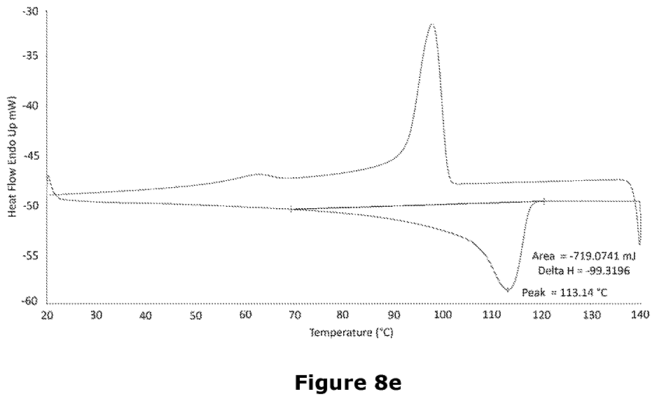

FIG. 8A shows DSC analysis of sample 1a-post-industrial pelletised LDPE.

TABLE 3
Properties of sample 1a post-industrial pelletised LDPE

| Property | Value |
|---|---|
| Melt-flow index | 0.522 |
| (190° C./2.16 kg) | |
| Melting temperature (° C.) | 106 and 125 |
| Composition of polymer | LDPE and MDPE |
| Degree of cross-linked (wt %) | 0.62 |
| Degree of MA grafted (wt %) | 0.05 |

1a—Conclusions

The first melting peak in the DSC curve at 106° C. is indicative of LDPE. The peak is broad indicating non-uniform chain length. The second melting peak at 125° C. is sharp and indicative of medium density PE with uniform chain length. No HDPE or PP contamination visible.

1b—Results—Post Agricultural Film Analysis

TABLE 4
Properties of sample 1b post-agricultural film

| Property | Value |
|---|---|
| Melt-flow index | 1.2 |
| (190° C./2.16 kg) | |
| Melting temperature (° C.) | 111 and 123 |
| Composition of polymer | LDPE & MDPE, |
| Degree of cross-linking (wt %) | 0.49 |
| Degree of MA grafting (wt %) | 1.3 |

TABLE 5
Melt-flow analysis at different temperatures

| Temperature (° C.) | MFI (g/10 min) |
|---|---|
| 120 | 0 |
| 130 | 0.26 |
| 140 | 0.4 |
| 160 | 0.63 |
| 180 | 0.983 |
| 190 | 1.05 |

FIG. 8b shows melt-flow index at different temperatures. FIG. 8c shows DSC analysis of sample 1b showing distinct peaks corresponding to different compounds.

1b—Conclusions

The first melting peak in the DSC curve is at 111° C. and is of broad nature. This peak is indicative of LDPE with non-uniform chain length. The second melting peak at 123° C. is sharp and indicative of medium density PE with uniform chain length. No HDPE or PP contamination visible.

1c—Results—Post Industrial Film Analysis

TABLE 6
Properties of sample 1c post-industrial film

| Property | Value |
|---|---|
| Melt-flow index | 0.335 |
| (190° C./2.16 kg) | |
| Melting temperature (° C.) | 111.23 |
| Composition of polymer | LDPE |
| Degree of cross-linking (wt %) | 4.48 |
| Degree of MA grafting (wt %) | 0.064 |

FIG. 8d shows DSC analysis of sample 1c.

1c—Conclusions

Broad, singular melting peak in the DSC curve at 111.23° C. is indicative of LDPE with a non-uniform chain length. No MDPE, HDPE or PP contamination visible.

1d—Results—Virgin LDPE A analysis

| Property | Value |
|---|---|
| Density | 0.925 |
| Melt-flow index | 1.83 |
| (190° C./2.16 kg) | |
| Melting temperature (° C.) | 113.14 |
| Composition of polymer | LDPE |
| Degree of cross-linking (wt %) | 0 |
| Degree of MA grafting (wt %) | 0 |

FIG. 8e shows DSC analysis of sample 1d showing a distinct peak corresponding to LDPE.

1d—Conclusions

The DSC curve for sample 1d shows a sharp singular peak at 113.14° C., indicative of high-quality LDPE.

1e—Results—Virgin LDPE B Analysis

| Property | Value |
|---|---|
| Density | 0.922 |
| Melt-flow index | 21.4 |
| (190° C./2.16 kg) | |
| Melting temperature (° C.) | 100-130 |
| Composition of polymer | LDPE |

1e—Conclusions

Analysis indicates a relatively high melt-flow index.

### Example 2—Binder Production

This example demonstrates preparation of wood fibre board from thermoplastic dispersions using various LDPE feedstocks and processing conditions.

### Methodology

TABLE 7
Twin screw extruder temperature configuration
with different polymer samples

| Polymer | | PVOH | Polymer |
|---|---|---|---|
| description | Temperature profile | Content | description |
| Post-industrial | 120\|95\|95\|95\|95\|95\|96 | 5 | Post-industrial |
| LDPE | | | LDPE |
| Virgin LDPE B | 100\|100\|140\|140\|140\|95\|95\|95 | 5 | Virgin LDPE B |
| Virgin LDPE B | 100\|100\|140\|140\|140\|95\|95\|95 | 10 | Virgin LDPE B |
| Virgin LDPE A | 99\|97\|95\|95\|96\|94\|94 | 10 | Virgin LDPE A |

Three LDPE samples were processed through a twin-screw extruder at the temperature settings shown above.

The polymer samples were pre-mixed with polyvinyl alcohol pellets (5% w/w and 10% w/w) and fed into the extruder feed to enhance processing efficiency. The PVOH increased the flow of the sample through the twin screw extruder and no high pressure/torque failures were observed. Water was added to achieve a final moisture content in the thermoplastic dispersion of between 50-70%

Thermoplastic dispersions were collected from the twin-screw extruder and mixed with eMDI and wood fibre using a paddle mixer. Composite mixtures and boards were produced according to the protocol described in example 3.

### Results

TABLE 8
Wood fibre board press parameters

| Press | | Binder content | eMDI content |
|---|---|---|---|
| factor | Density | (wt % of | in binder |
| (s/mm) | (g/cm³) | composite mixture) | (wt %) |
| 12 | 620 | 10 | 10 |

Physical test results of different binder sources of wood fibre boards

TABLE 9
test results of wood fibre boards

| | PVOH | MoE | MoR | |
|---|---|---|---|---|
| Binder base material | (wt %) | (MPa) | (MPa) | IB(MPa) |
| Post-industrial LDPE | 5 | 1990 | 13.7 | 0.45 |
| Post-industrial LDPE | 5 | 1675 | 11.6 | 0.46 |
| VIRGIN LDPE B | 5 | 2527 | 14.0 | 0.81 |
| VIRGIN LDPE B | 5 | 2390 | 12.8 | 0.65 |
| VIRGIN LDPE B | 10 | 2111 | 12.5 | 0.71 |
| VIRGIN LDPE B | 10 | 2074 | 12.3 | 0.77 |
| VIRGIN LDPE A | 10 | 1970 | 13.3 | Not tested |
| VIRGIN LDPE A | 10 | 2076 | 13.8 | Not tested |

TABLE 10
Average MoE, MoR and IB

| | PVOH | Average. | Average. MoR | Average. |
|---|---|---|---|---|
| Binder base material | (wt %) | MoE (MPa) | (MPa) | IB(MPa) |
| Post-industrial LDPE | 5 | 1832.4 | 12.6 | 0.5 |
| VIRGIN LDPE B | 5 | 2458.5 | 13.4 | 0.7 |
| VIRGIN LDPE B | 10 | 2092.5 | 12.39 | 0.74 |
| VIRGIN LDPE A | 10 | 2023.2 | 13.53 | None |

TABLE 11
Wood fibre board testing with difference in
level of PVOH using virgin LDPE B

| Binder base | Surfactant used | Average, | Average |
|---|---|---|---|
| material | (wt %) | MoE (MPa) | MoR (MPa) |
| VIRGIN LDPE B | 5 | 2458.5 | 13.4 |
| VIRGIN LDPE B | 10 | 2092.5 | 12.39 |

### Conclusions

Virgin LDPE B has a MFI of 21.4 whereas Virgin LDPE A MFI is 2 g/10 mins.

Both LDPE A and LDPE B provided thermoplastic dispersions which were used to prepare wood fibre boards with excellent board properties.

The level of PVOH within the binder affected the mechanical strength of boards produced using the binder. In particular, 5% PVOH provided a stronger board compared to 10% PVOH. In addition, adding 5% PVOH enhanced the melt flow of the thermoplastic through the extruder. The addition of PVOH is believed to provide additional hydroxyl groups which bind with the isocyanate functional group. Oversaturating with 10% PVOH produces adverse effects on the strength of the wood fibre board.

### Example 3—Mixed Waste Polymer Binder Production

This example demonstrates production of binder with recycled polypropylene and recycled polyethylene feedstocks. These represent a high melt-point thermoplastic (PP melt-point approx. 171° C.) and a low melt-point thermoplastic (LDPE melt point approx. 106° C.). Three thermoplastic material treatments were tested:
a. Recycled PP (Yuplene): recycled post-industrial LDPE (Astron) 1:1
b. Recycled PP (Yuplene): recycled post-industrial LDPE (Astron) 1:4
c. Recycled Post-industrial LDPE (Astron) 100%

A twin-screw extruder was used to process the three feedstock materials and prepare thermoplastic dispersions. Wood fibre boards were produced using the binder and tested for strength characteristics.

Three mechanical tests were performed to understand the effect of varying the ratios of thermoplastic-modulus of elasticity (MOE), modulus of rupture (MOR), and internal bonding strength (IB). This example provides insights into the potential for using a high melt-point recycled thermoplastic such as PP and a low melt-point recycled thermoplastic such as LDPE as sustainable alternatives for enhancing processing and/or tailoring the mechanical performance of wood fibre composite boards.

### Methodology

### Binder Preparation

The raw materials were passed through a twin-screw extruder to homogenise the materials and mix the different plastic sources to produce a thermoplastic pellet. The thermoplastic pellets were passed through a twin-screw extruder with water added to induce emulsification and particle size reduction and produce a thermoplastic dispersion.

Three replicate boards were produced using binder prepared from the three thermoplastic dispersions. Identical twin-screw extruder emulsification conditions were used.

TABLE 12
Temperature profile for twin screw extruded binder
Set temperature profile

| Z1 | Z2 | Z3 | Z4 | Z5 | Z6 | Z7 | Z8 | Die |
|---|---|---|---|---|---|---|---|---|
| 120 | 95 | 95 | 95 | 95 | 95 | 95 | 95 | 25 |

The twin-screw extruder temperature profile shown in the table above incorporates a higher initial temperature to melt the thermoplastic prior to mixing.

The extruder comprised two water injection points. Two surfactants were used at the respective first and second injection points—an anionic surfactant—Dowfax 2A-1 and Teric 463—a non-ionic surfactant. Surfactant input was adjusted to achieve 4% surfactant w/w to resin. Water was injected at injection point 1 (post-melting zone) and injection point 2—dilution zone. Water flow was adjusted to achieve a resin: water ratio post injection point 1 of 3.5 and a resin: water ratio post-injection point 2 of 1.3.

During processing, the torque (current in amps) reading on the twin-screw extruder was assessed and graded in a range from 1—least processable/highest current to 5—most processable/lowest current. This indicates the processability of the recycled material and is linked to energy consumption. Initial tests using recycled post-industrial LDPE failed due to high torque/current readings causing shut-down of the extruder.

Following processing in the extruder, the dispersion moisture content was adjusted by drying for 24 hours to achieve a composite mixture moisture content of 8-12%. Thermoplastic dispersion was mixed with emulsified methylene diphenyl diisocyanate (eMDI) for 10 minutes. 1% of composite mixture by weight was eMDI. 500 g of coarse woodchips was added in two batches and mixed for 10 minutes each to prepare the composite mixture.

### Board Preparation

The mixed formulation was distributed in a mold on a platen and flattened to prepare a mat with a consistent height and uniform distribution of the materials. The mat was pre-compressed with a 5-tonne force then subjected to hot pressing with a press factor of 12 and target density of 620 to produce a compressed wood fibre board.

### Board Testing

MOE, MOR and IB testing was carried out on four strips from three replicate boards per treatment to investigate how different combinations of recycled PP and PE affect mechanical strength.

During processing, torque readings were assessed for each sample to provide a processability metric.

### Results

TABLE 13
MOE, MOR and IB for thermoplastic polymer blends

| Treatment | MOE | MOR | IB | Processability |
|---|---|---|---|---|
| 50LDPE/50PP (RECYCLED) | 1774 | 11.8 | 0.50 | 5/5 |
| 80LDPE/20PP (RECYCLED) | 1780 | 12.8 | 0.48 | 1.5/5 |
| 100% LDPE RECYCLED | 1811 | 13.1 | 0.43 | 1/5 |

MOE—The table above shows mean modulus of elasticity across the three treatment groups. The 50% recycled PP has the lowest average MOE which is 1774 MPa whereas the MOE with only LDPE was 1811 MPa. There is a non-significant trend (P>0.1) in MOE with higher LDPE indicating higher MOE.

MOR—The table above shows mean MOR across the three treatment groups. The average modulus of rupture of the three treatment groups were 11.817 MPa (50/50=recycled PP/recycled LDPE), 12.82Mpa (20/80=recycled PP/recycled LDPE) and 13.140 MPa (100% recycled LDPE). There is a non-significant (p>0.05) trend towards higher LDPE content providing higher MOR.

IB—The table above shows the mean IB across three treatment groups. The average internal bonding strength for the three different board compositions showed a negative correlation to the proportion of recycled LDPE. However, the means did not differ significantly across treatment groups (p>0.05).

Processability—The processability of samples with increasing PP content was increased—i.e. lower energy consumption required for processing and less chance of clogging.

Melt-flow index—the table below shows a clear increase in melt-flow index (measured at 1900C) when proportion of LDPE in a blend is increased.

TABLE 14
Melt-flow index for PP:LDPR blends

| Treatment | MFI |
|---|---|
| PP:LDPE = 10:90 | 0.643 |
| PP:LDPE = 20:80 | 0.683 |
| PP:LDPE = 50:50 | 1.416 |
| PP = 100 | 4.583 |

### Conclusions

The results indicate that a recycled high-melt thermoplastic and a recycled low-melt thermoplastic comprising a mixture of PP and LDPE can be used to make wood fibre boards with no detrimental effects on MOE or MOR. The processability of the blend increased with higher PP content. This trial indicates that the described methods enable processing of material with high melt temperatures to make binder and wood fibre boards with improved processability, decreased energy consumption and consistently high strength.

Recycled PP has a higher melting temperature of approx. 171° C. Recycled LDPE has a lower melt temperature of approx. 106° C. Increased PP proportion in blends resulted in increased melt-flow index. This in turn provided advantageous reduction in torque and improved processability through the twin-screw extruder. This example shows that blends of recycled PP and LDPE can provide viable wood fibre boards following processing through an extruder. It also shows that melt-flow index can be increased by adding recycled PP to a blend, for example at least 50% recycled PP in a blend of LDPE and PP provides enhanced processability and mixing.

### Example 4—Characterisation of Recycled Thermoplastic Material for Enhanced Processing

This example illustrates a pre-processing characterisation step used in some embodiments to customise the extrusion parameters in methods and apparatus described herein. Specifically, this example provides a numerical model for characterisation of a waste thermoplastic polymer to determine the PP: LDPE ratio and adjustment of processing parameters. This enables enhanced processing and energy efficiency of extrusion processes by determining the properties of an unknown thermoplastic, then adjusting the extrusion and optionally functionalisation parameters of the process to prepare an enhanced thermoplastic dispersion for board making. Waste polypropylene (PP) was combined with waste Low-Density Polyethylene (LDPE), and the melt flow index was measured at temperatures from 190° C. to 230° C. in accordance with ASTM D1238 standard.

### Results

| Set temperature | % of | Average | Nat. log |
|---|---|---|---|
| (C) | PP | MFI | MFI |
| 190 | 0 | 0.522 | −0.65009 |
| | 10 | 0.643 | −0.44161 |
| | 20 | 0.683 | −0.38126 |
| | 50 | 1.416 | 0.347836 |
| | 100 | 4.583 | 1.522354 |
| 200 | 10 | 0.816 | −0.20334 |
| | 20 | 0.833 | −0.18272 |
| | 50 | 1.9 | 0.641854 |
| | 100 | 5.33 | 1.673351 |
| 210 | 10 | 1.016 | 0.015873 |
| | 20 | 1.016 | 0.015873 |
| | 50 | 2.23 | 0.802002 |
| | 100 | 7.066 | 1.955295 |
| 220 | 10 | 1.283 | 0.249201 |
| | 20 | 1.253 | 0.225541 |
| | 50 | 2.783 | 1.023529 |
| | 100 | 10.833 | 2.382597 |
| 230 | 10 | 1.45 | 0.371564 |
| | 20 | 1.49 | 0.398776 |
| | 50 | 3.143 | 1.145178 |
| | 100 | 14.516 | 2.675251 |

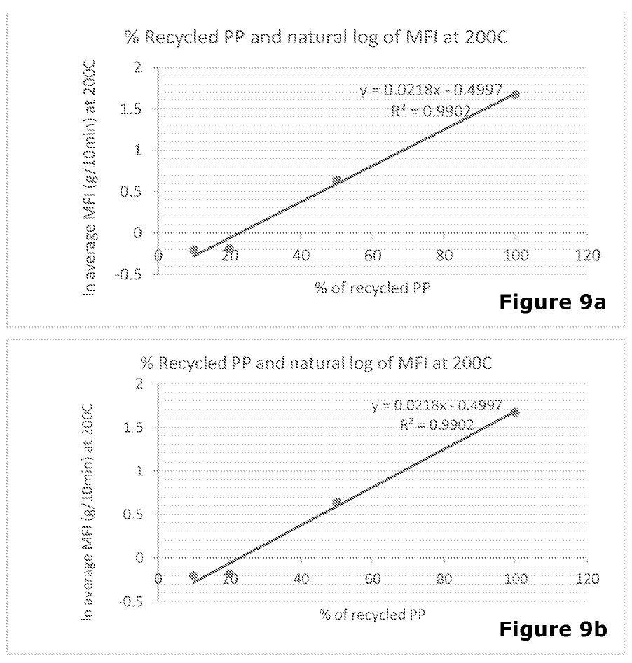

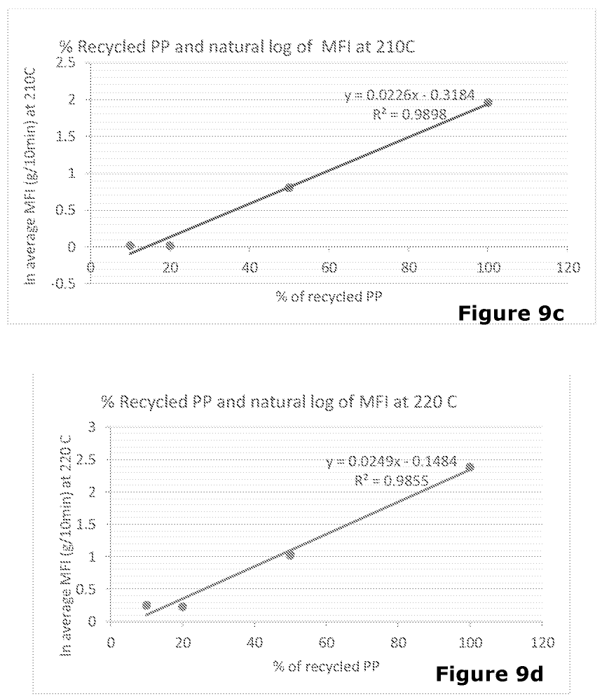

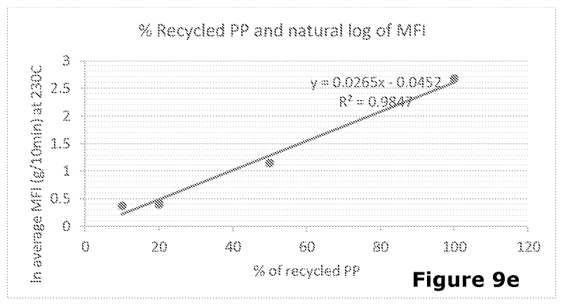

FIGS. 9a-9e show calibration graphs showing experimental results of varying recycled PP: LDPE compositions with natural log of average MFI at different set-point temperatures from 190° C. to 230° C.

TABLE 15
Linear modelling of the different composition of
waste PP and waste LDPE at different temperatures.

| Set temperature (°C) | Linear model |
|---|---|
| 190 | y = 0.022x-0.7117 |
| 200 | y = 0.0218x-0.499 |
| 210 | y = 0.0226x-0.3184 |
| 220 | y = 0.0249x-0.1484 |
| 230 | y = 0.0265x-0.0452 |

### Discussion

Different set temperatures for the melt flow index testing provided a linear regression between the percentage of Polypropylene (PP) and the melt flow index at various temperatures (190, 200, 210, 220, and 230° C.). This linear relationship provides a method for determining the level of PP in mixed waste thermoplastic polymer. The determination of PP and LDPE composition enables the modification of extrusive emulsification to enhance thermoplastic dispersion preparation and wood fibre board mechanical properties.

### Example 5—Composite Board Production Using Isocyanates

The experiment describes the production of composite wood-fibre boards made using thermoplastic dispersion and the isocyanate variants polymeric methylene diphenyl diisocyanate (PMDI) and emulsion of PMDI in water (EMDI).

### Methodology

Thermoplastic dispersion was prepared from Virgin LDPE A blended with 5% PVOH by twin screw extruder processing according to the methods and twin-screw configuration outlined in example 3. Wood fibre boards were prepared according to the mixing and board press procedures outlined in Example 3. Two replicates were prepared.

### Results

| | Actual | Binder | | | | | Swelling |
|---|---|---|---|---|---|---|---|
| Sample | Density | content | Resin | MoE | MoR | IB | after 24 |
| name | (kg/m3) | (wt %) | type | (MPa) | (MPa) | (MPa) | hrs (%) |
| pMDI-S1 | 642 | 10 | pMDI | 2037 | 12.6 | 0.61 | 12.77% |
| pMDI-S2 | 646 | 10 | pMDI | 2206 | 14.4 | 0.6 | 13.58% |
| pMDI-S3 | 641 | 10 | pMDI | 2132 | 13.6 | 0.8 | 13.15% |
| pMDI-S4 | 645 | 10 | pMDI | 2038 | 14.1 | 0.73 | 12.45% |
| pMDI-S5 | 640 | 10 | pMDI | 2054 | 13.6 | 0.74 | 13.04% |
| pMDI-S6 | 641 | 10 | pMDI | 2046 | 13.6 | 0.74 | 13.23% |
| pMDI-S7 | 640 | 10 | pMDI | 2037 | 13.0 | 0.71 | 13.50% |
| pMDI-S8 | 649 | 10 | pMDI | 2070 | 14.1 | 0.67 | 13.34% |
| eMDI-S1 | 657 | 10 | eMDI | 2343 | 16.4 | 0.78 | 13.40% |
| eMDI-S2 | 647 | 10 | eMDI | 2225 | 14.2 | 0.79 | 13.30% |
| eMDI-S3 | 641 | 10 | eMDI | 2108 | 13.6 | 0.83 | 13.60% |
| eMDI-S4 | 642 | 10 | eMDI | 2271 | 15.2 | 0.84 | 12.20% |
| eMDI-S5 | 639 | 10 | eMDI | 2207 | 14.9 | 0.83 | 12.50% |
| eMDI-S6 | 638 | 10 | eMDI | 2328 | 15.8 | 0.88 | 12.80% |

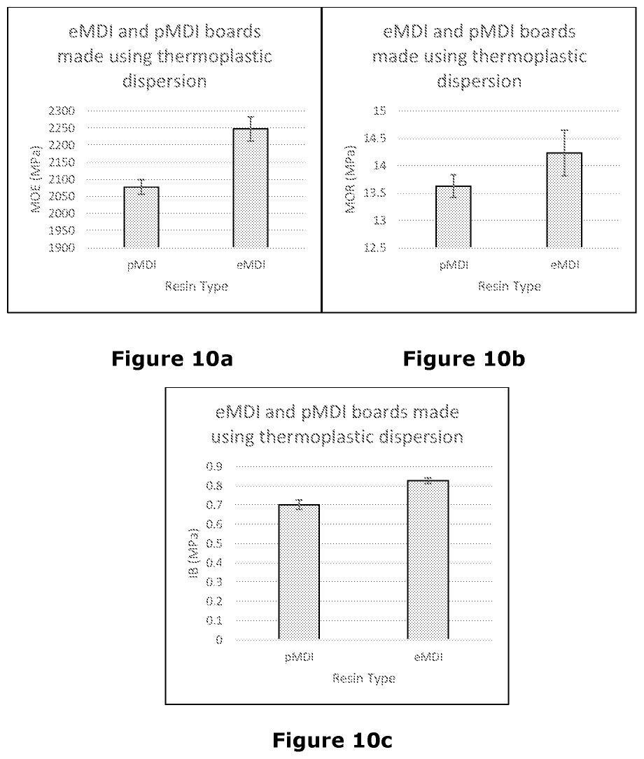

FIGS. 10a-10c show average MOE, MOR and IB for boards made using eMDI and pMDI. eMDI exhibited a higher mean MOE (2247.07 MPa), MOR (14.23 MPa), and IB (0.825 MPa) compared to pMDI MOE (2077.5 MPa), MOR (13.63 MPa) and IB (0.7 MPa).

### Conclusions

LDPE thermoplastic dispersions were used to produce high quality wood fibre boards using eMDI and pMDI. eMDI provided higher strength boards compared to pMDI.

### Example 6—Use of Maleic Anhydride Functionalised PE to Prepare Composite Wood Fibre Boards

Composite boards comprising wood fibre and maleic anhydride functionalised PE were formed using the organic peroxide cross-linker Luperox 231 (1,1-di-(tert-butylperoxy)-3,3,5-trimethylcyclohexane).

### Methodology

Binder was prepared by blending Virgin LDPE A (Exxon) with poly-vinyl alcohol through a twin-screw extruder before emulsifying it to prepare the thermoplastic dispersion. The dispersion preparation and board testing were as described in example 3 above. The thermoplastic dispersion was dried in the oven overnight to achieve a moisture content of approx. 50%.

The composite mixture comprised:
90% Coarse wood chips 8-12 wt % moisture content.
10% binder

2 replicates of each binder composition were prepared according to the binder compositions below:
Sample 1a and 1b:
   87% thermoplastic dispersion prepared using LDPE;
   10% PMDI;
   3% w/w organic peroxide cross-linker (Luperox 231).
Sample 2a and 2b:
   62% thermoplastic dispersion prepared using LDPE;
   10% PMDI;
   3% w/w organic peroxide cross-linker (Luperox 231);
   25% maleic anhydride-grafted PE (1% MA grafted).

The binder was mixed then wood chips were added with further mixing. The materials were transferred to a mould and levelled. Pre-compression was applied then the board was hot-pressed with a press factor of 12s/mm at 200° C.

### Results

TABLE 16
Addition of functionalised PE to a thermoplastic
dispersion enhances strength

| | | | Moisture | |
|---|---|---|---|---|
| | | Binder | content of | |
| Sample | Binder base material | (%) | whole board | MoE |
| 1a | PMDI + LDPE + OP | 10 | 10.86 | 1238 |
| 1b | PMDI + LDPE + OP | 10 | 10.86 | 1219 |
| 2a | PMDI + LDPE + OP + MAPE | 10 | 10.86 | 1279 |
| 2b | PMDI + LDPE + OP + MAPE | 10 | 10.86 | 1310 |

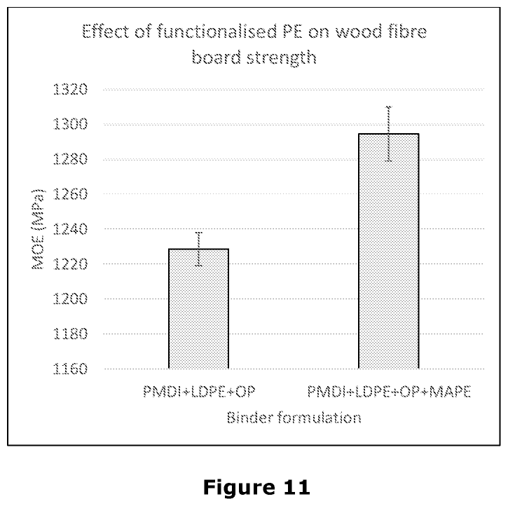

FIG. 11 shows that the mean board strength when measured by MOE is significantly higher when functionalised PE is used as a component of the wood fibre board.

### Conclusions

MAPE is believed to facilitate the bonding between LDPE and wood particles. The functionalisation of PE by MA enhances the adhesion of LDPE to the wood fibres within the particle board. The results show that maleic anhydride functionalised polyethylene provides composite boards with higher strength than not using MAPE.

### Example 7—Alternative Lignocellulosic Materials

### Aim

This example investigates several lignocellulosic substrates that may be included within composite boards comprising thermoplastic dispersions described herein.

### Methodology

Two lignocellulosic substrates were trialled in comparison to pine wood chip: pea straw and barley straw. Pea and Barley straw have a coarse and fibrous texture and are often used for water retention in gardening and agricultural applications.

Mechanical strength was tested according to the standard methodology.

pMDI was used as cross-linking agent at 10 wt % of the binder. A thermoplastic dispersion comprising LDPE (Exxon) was used. The twin-screw configuration for dispersion preparation is as described in Example 3. Melt flow index of the polymer was 2 g/10 mins at 190° C. The moisture content of the lignocellulosic substrates was standardised to 10 wt %. 10 wt % of the board composition was made up of binder. Boards of 10 mm thickness and 620 kg/m3 were prepared for testing.

### Results

Table 17 below shows mechanical strength testing results of each board:

TABLE 17
strength testing results of board prepared using alternative substrates.

| Lignocellulosic substrate | Average. MoE (MPa) | Average. MoR (MPa) |
|---|---|---|
| Pea straw | 776.2 | 5.6 |
| Barley straw | 1838.63 | 12.4 |
| Pine tree-soft wood fibre | 1190 | 8.15 |

### Discussion

The mechanical strength of boards made with barley straw exhibited the highest strength as measured by MOR and MOE. Barley straw typically has a higher lignin content compared to some other crop residues. The lignin content in barley straw is estimated to be in the range of 15%-20% and pea straw is in the range of 5-15%.

This experiment shows that a range of lignocellulosic substrates can be used to produce composite boards.

### Example 8—Effect of GMA Grafted PP on Processing and Board Performance

GMA was grafted to recycled polypropylene thermoplastic to assess the processibility during extruder processing steps the mechanical strength of prepared boards.

### Methodology

Recycled PP (rPP) was fed gravimetrically at 2 kg/h prior to the melt zone. Glycidyl methacrylate, styrene monomer and dicumyl peroxide solution (1:1:0.1) were premixed before being injected into the twin screw extruder at 6.5 ml/min. The temperature of the barrel was kept above 1800C and the screw speed at 200 rpm. The extrudate was immediately cooled and pelletized after exiting the die.

For characterisation, 1 g of the product was dissolved in xylene and precipitated in acetone, followed by drying at 60° C. for 24 h. Confirmation of grafting was performed by FTIR.

These pellets of rPP-g-St-GMA were fed into another extruder at 1.5 kg/hour. The extruder setup was identical to the configuration in example 3, except the melt zone was hotter (>160° C.) to ensure complete melting of the polypropylene. The resin/water ratio after injection 1 was 1.2 and 0.5 post injection 2. Unfunctionalized, recycled polypropylene was used as a control and size reduced in an identical way.

### Results

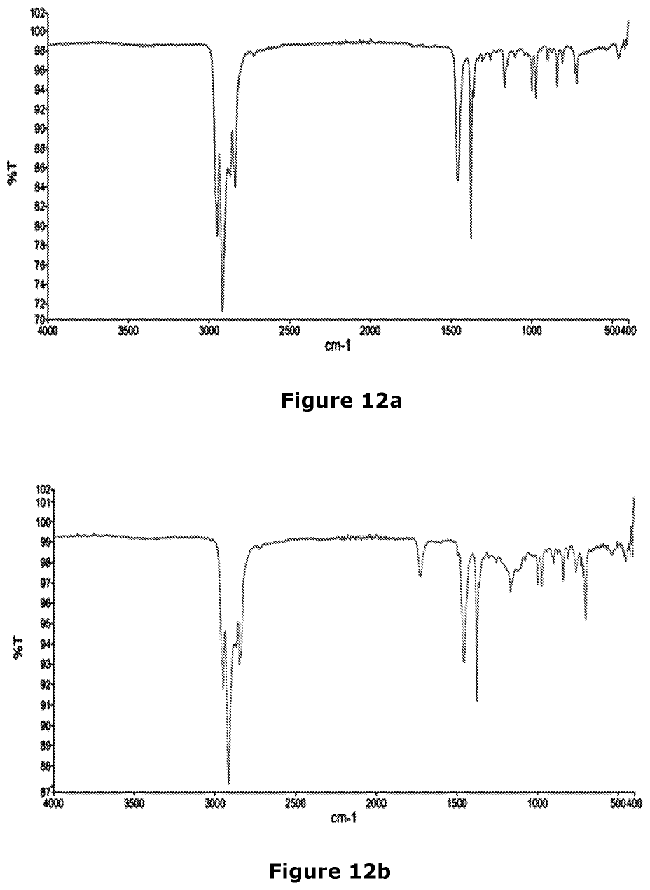

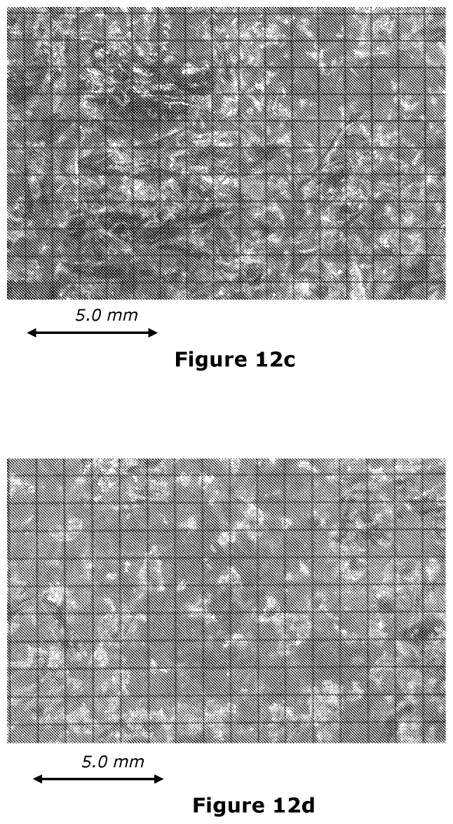

FIG. 12a shows a typical polypropylene FTIR spectra and has a clear absence of any carbonyl or epoxide peaks. FIG. 12b demonstrates the successful grafting of glycidyl methacrylate by the strong absorbance of a C═O carbonyl stretch at ~1730 cm⁻¹ and much smaller C—O—C epoxide peak located ~900 cm⁻¹.

The emulsified pellets were dried and analysed under an optical microscope using a 1.0 mm scale. FIGS. 12c and 12d show microscope images of rPP and rPP-St-GMA respectively. These results showed an average decrease in particle size when rPP-St-GMA is used as a feed in the SFEE process instead of rPP. There is a notable reduction of large, agglomerated particles once GMA is incorporated which is representative of the thermoplastic dispersion as a whole.

### Conclusion

Recycled PP was successfully functionalised with GMA using a solvent free melt grafting method in a co-rotating twin screw extruder. The presence of a peak typical for carbonyl compounds was evidence of successful GMA grafting. Introduction of the hydrophilic monomer to the hydrophobic polymer backbone reduced the surface tension between the resin-water interface, reducing the frequency of particle agglomeration, decreasing the average particle size of the dispersion.

PP is a hydrophobic polymer and insoluble in water. This reduces the intimate mixing of the two phases during emulsification. By introducing hydrophilic moieties (e.g. GMA) to the backbone, increased dispersion and stability is achieved. More hydrophilic thermoset plastics will have a reduced contact angle with the hydrophilic lignocellulosic material and the water within the composite board, thereby providing enhanced mechanical locking and thus increased MOE and MOR. The reactive epoxide of GMA provides for reactive functionalisation of thermoplastic materials to form effective binders.

### Example 9—Use of Carboxylic Acids to Functionalise Recycled PE

This example shows how to improve emulsion stability of recycled LDPE (rLDPE), and improve binding strength of thermoplastic dispersions manufactured by SFEE techniques by grafting functional groups onto the rLDPE backbone prior to the SFEE process. Evaluation of the performance of Methacrylic acid grafted rLDPE particle boards is carried out.

### Methodology

### Synthesis

Recycled LDPE, water, methacrylic acid and styrene in a ratio of 3.3:2.3:1:0.1 are added to a round bottom flask. This mixture is gently agitated and heated to 93° C. Once at reaction temperature, an initiator-dicumyl peroxide-is added at 1.5% on LDPE and the system is stirred continuously for three hours. The grafted LDPE is washed three times; firstly with 0.1 mol caustic solution, then with 0.1 mol hydrochloric acid and finally with DI water.

A dispersion is then produced from the resulting functionalised polymer. For example as per the method described in example 3 above.

### Oven Stability

The viscosity of the polymer described above is measured 72 hours after manufacture using a Brookfield RVT viscometer. It is then placed into a 200 mL screw top glass jar and artificially aged in an oven at 60° C. for two weeks. Upon completion of accelerated ageing, the sample is reviewed for grit and viscosity.

### Particleboard Adhesive Performance

A series of boards is produced and tested the EN312 standard for P3 particle boards. Half of the boards use the grafted rLDPE adhesive, whilst the other half use an un-grafted analogue

### Results

### Oven Stability

Grafting reduces both the concentration of grit and reduces the viscosity drift that occurs upon accelerated ageing.

### Crosslink Density and Performance Assessment.

An improvement in the modulus of elasticity is expected to be observed. This suggests improved compatibility of the constituents within the recycled LDPE and/or an improvement in the adhesion between the wood fibre particles and the polymer. Whilst acid functionality will provide sites for isocyanates to react with the polymer; it is anticipated that pMDI will react with any water in the system in preference to acid groups along the backbone of the polyolefin.

### Conclusion

This experiment would show that acid-grafted rLDPE dispersions have better shelf stability and deliver improved adhesive properties in particle board applications, allowing for composite boards to be produced with lower ratios of pMDI: rLDPE that meet the P3 Particleboard specification as described in EN312.

### Example 10—Preparation of Functionalised PE for Wood Fibre Board Production Using Peroxide Cross-Linkers

This example describes the use of maleic anhydride compatibilizers to increase cross-linking in the preparation of wood fibre boards from thermoplastic.

### Methodology

Two different waste LDPE sources were used-AXM1 and V plas. AXM1 and V plas were produced with different mechanical treatments. Isopropyl alcohol was used as a tackifier during binder production.

Wood fibre boards were prepared and hot pressed with a press factor of 22 seconds/mm and the mechanical properties of each formulated boards were analysed.

Wood fibre board production
Cross linker (Luperox 231)
Maleic anhydride-grafted PE (1% MA grafted)
Isopropyl alcohol (IPA).
Wood chip: Coarse wood chips and fine chips
Press factor—22 s/mm

The binder, Cross linker (Luperox 231), MAPE and IPA were mixed. 20% of the total volume of the boards comprised fine wood chips and 80% of the total volume comprised coarse chips. A three-layered wood fibre board mattress composition was formed comprising 10% volume of fine chips, 80% coarse chips on top, then the other 10% of fine chips on top. A mini press pre-compressed the material to form a mattress which was subsequently pressed by a hot-press at press factor 22 mm/seconds to produce 15 mm boards. Boards were cooled and tested.

### Results

TABLE 18
MoE and MoR vary according to MAPE content.

| | | | | Cross | | |
|---|---|---|---|---|---|---|
| | | | MAPE | linker | | |
| | | Binder | content | content | | |
| | | (AXM | (wt % of | (wt % of | Avg. | Avg. |
| Sample | Density | content | binder | binder | MoE | MoR |
| name | (kg/m3) | (wt %) | content) | content) | (MPa) | (MPa) |
| A | 680 | 20 | 0 | 5 | 1408 | 10.3 |
| B | 680 | 20 | 15 | 5 | 2120 | 13.0 |
| C | 680 | 20 | 20 | 5 | 2197 | 13.7 |
| D | 680 | 20 | 25 | 5 | 2430 | 16.0 |
| E | 680 | 20 | 30 | 5 | 2366 | 15.6 |

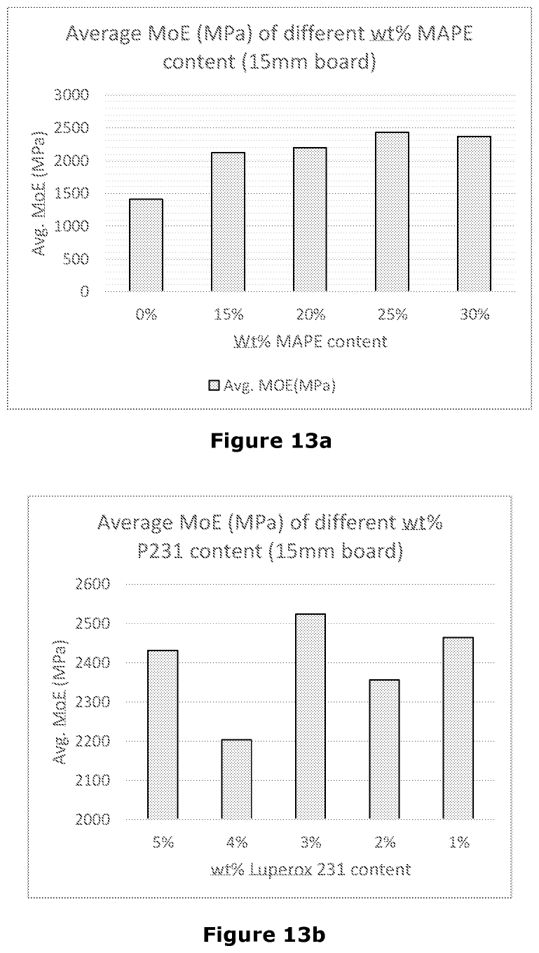

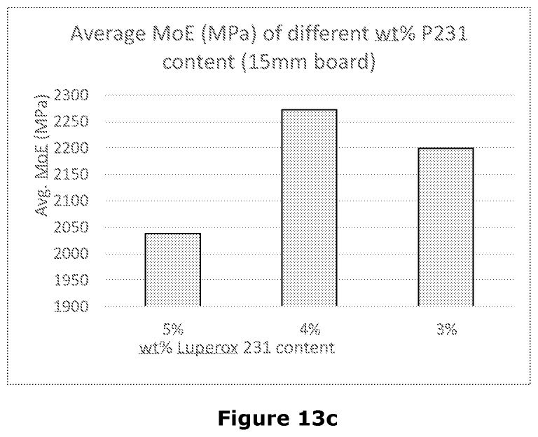

FIG. 13a shows results from 20% AXM1.5% P231, IPA, 10:80:10, F/C/F, press time 4.5+1 min 680 kg/m3, SP Temp 190° C.

TABLE 19
MoE and MoR vary according to cross-linker content

| | | | Luperox | MAPE | | |
|---|---|---|---|---|---|---|
| | | Binder | content | content | | |
| | | (AXM 1 | (wt % of | (wt % of | | |
| Sample | Density | content | binder | binder | MoE | MoR |
| name | (kg/m3) | (wt %) | content) | content) | (MPa) | (MPa) |
| A | 680 | 20 | 5 | 25 | 2430 | 15.6 |
| B | 680 | 20 | 4 | 25 | 2202 | 13.7 |
| C | 680 | 20 | 3 | 25 | 2523 | 15.2 |
| D | 680 | 20 | 2 | 25 | 2355 | 15.5 |
| E | 680 | 20 | 1 | 25 | 2463 | 14.1 |
| F | 680 | 20 | 0 | 25 | Failed | Failed |

FIG. 13b shows results from 20% AXM1, 25% MAPE, IPA, 10:80:10, F/C/F, press time 4.5+1 min 680 kg/m3, SP Temp 190° C.

TABLE 20
MoE and MoR vary according to cross-linker content

| | | | Luperox | MAPE | | |
|---|---|---|---|---|---|---|
| | | Binder | content | content | | |
| | | (V plas | (wt % of | (wt % of | | |
| Sample | Density | content | binder | binder | MoE | MoR |
| name | (kg/m3) | (wt %) | content) | content) | (MPa) | (MPa) |
| A | 660 | 20 | 5 | 25 | 2038 | 13.1 |
| B | 660 | 20 | 4 | 25 | 2272 | 14.6 |
| C | 660 | 20 | 3 | 25 | 2199 | 11.4 |

FIG. 13c shows results from 20% V Plas, 25% MAPE, IPA, 10:80:10, F/C/F, press time 4.5+1 min 660 kg/m3, SP Temp 190° C.

### Discussion

Peroxide crosslinker provided at varying concentrations provided high strength wood fibre boards. Both V plas and AXM1 processed waste LDPE binder provided similar mechanical strength results across all peroxide crosslinker concentrations.

Impact of the MAPE compatibilizer in wood fibre board-functionalised PE enhanced board strength when added at a concentration above 0% as shown in FIG. 13a. Addition of MAPE increases the MoE strength by 700-1000 MPa and the MoR strength by 3-6 MPa. MAPE acts as a bridge between the hydrophobic LDPE matrix and the hydrophilic wood fibres. It has both polar and nonpolar components in its molecular structure. This dual nature allows MAPE to improve the adhesion and bonding between LDPE and wood fibres, making the interface more compatible.

It was observed that MAPE has shortened half-life when it contacts with water therefore optimal results were obtained using dried lignocellulosic fibres wherein the composite mixture comprises a moisture content of less than 5 wt %.

### Example 11—Recycled Thermoplastic Dispersions Used to Make Wood Fibre Boards

This example describes preparation of thermoplastic dispersions from four different waste thermoplastics (Low density polyethylene and Polypropylene) and one virgin LDPE Preparation of composite boards comprising wood fibre is described.

### Methodology

Thermoplastic samples were prepared as pellets and fed into a twin screw extruder with the configuration outlined below. Water flow rate was adjusted to achieve a moisture content in the thermoplastic dispersion of 45% to 55%.

Two samples with 1:1 blended PE/PP mixture was prepared to enhance the processibility and reduce the particle size of the thermoplastic dispersion following extrusion. The first sample comprised 1:1 post-industrial LDPE (Astron) and recycled PP. The second sample comprised 1:1 post-agricultural LDPE film and recycled polypropylene. Each blend is passed through the first twin screw extruder for mixing then through a second twin-screw extruder for preparation of the thermoplastic dispersion.

TABLE 21
Twin screw extruder temperature profile
Set temperature profile

| Z1 | Z2 | Z3 | Z4 | Z5 | Z6 | Z7 | Z8 | Die |
|---|---|---|---|---|---|---|---|---|
| 180 | 180 | 95 | 95 | 95 | 95 | 95 | 95 | 25 |

The TSE temperature profile was maintained constant for all samples.

TABLE 22
Boards were formed with constant parameters across all samples

| | Board |
|---|---|
| Parameter | formulation |
| Density (kg/m³) | 650 |
| Press factor (mm/seconds) | 12 |
| Isocyanate content in binder (wt %) | 10 |
| Binder content in composite mixture (wt %) | 10 |

Two replicate boards were prepared for each treatment. Moisture content of the prepared binder was assessed.

### Results

TABLE 23
Shows processability metrics which are dependent on thermoplastic
source, and any modifications (e.g. blending with PP).

| Description | Screw rpm | Screw amps | Torque |
|---|---|---|---|
| 100% Virgin LDPE A | 150 | 6-7 | 9-10 Nm |
| 100% Post-industrial LDPE | 150 | 9-10 | 23-28 Nm |
| (Astron) | | | |
| 100% Recycled PP (re PP) | 150 | 6-7 | 9-10 Nm |
| 100% Post-agricultural LDPE | 150 | 9-10 | 20-25 Nm |
| film (Bale wrap) | | | |
| 50/50 (Astron/re PP) | 150 | 6.5-7.5 | 10-15 Nm |
| 50/50 (Bale Wrap/re PP) | 150 | 6.5-7.5 | 8-12 Nm |
| 100% Astron + 5% PVOH | 150 | 8-9 | 15-20 Nm |
| 100% Post-construction film | 150 | 7.5-8.5 | 15-20 Nm |
| (building wrap) | | | |

TABLE 24
Moisture content and composite board results (mean of 2 replicate boards)

| | | Wood | | | | | |
|---|---|---|---|---|---|---|---|
| | Binder | chip | Composite | | | | SW in |
| | MC | MC | mix MC | MoE | MoR | IB | 24 hrs |
| Description | (%) | (%) | (%) | (MPa) | (MPa) | (MPa) | (%) |
| 100% Virgin LDPE A | 51 | 6.0 | 13.86 | 2002 | 14.1 | 0.499 | 23.34% |
| 100% Post-industrial | 21 | 6.0 | 8.04 | 1693 | 11.6 | 0.205 | 49.95% |
| LDPE (Astron) | | | | | | | |
| 100% Recycled PP (re PP) | 32 | 6.6 | 9.14 | 1377 | 8.8 | 0.206 | 64.44% |
| 100% Post-agricultural | 50 | 6.6 | 10.94 | 1359 | 9.2 | 0.258 | 34.96% |
| LDPE film (Bale wrap) | | | | | | | |
| 50/50 (Astron/re PP) | 44 | 5.7 | 9.53 | 1497 | 10 | 0.283 | 40.99% |
| 50/50 (Bale Wrap/re PP) | 50 | 5.7 | 10.13 | 1455 | 9.2 | 0.298 | 34.51% |
| 100% Astron + 5% PVOH | 51 | 7.5 | 11.81 | 1615 | 10.7 | 0.253 | 36.70% |
| 100% Post-construction film | 45 | 6.6 | 13 | 1520 | 10.3 | 0.199 | 33.77% |
| (building wrap) | | | | | | | |

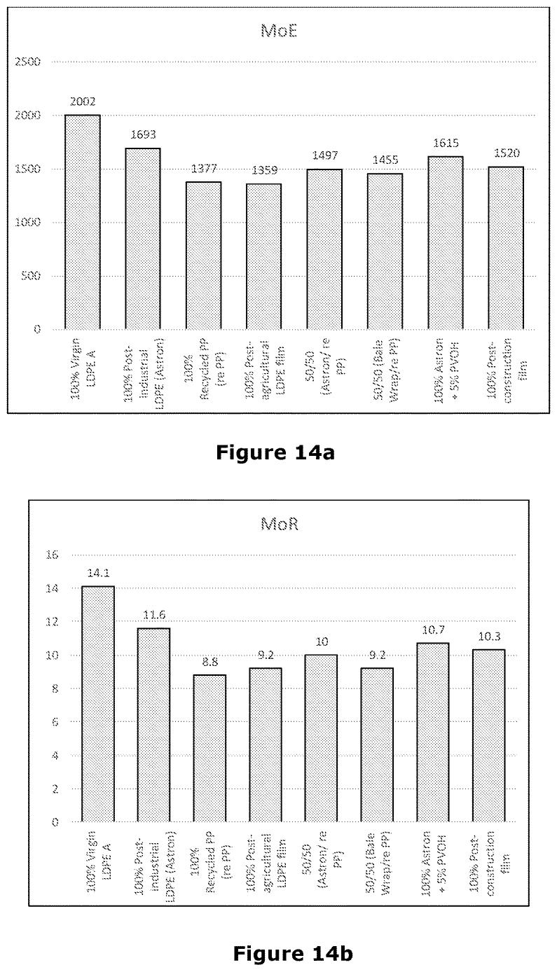

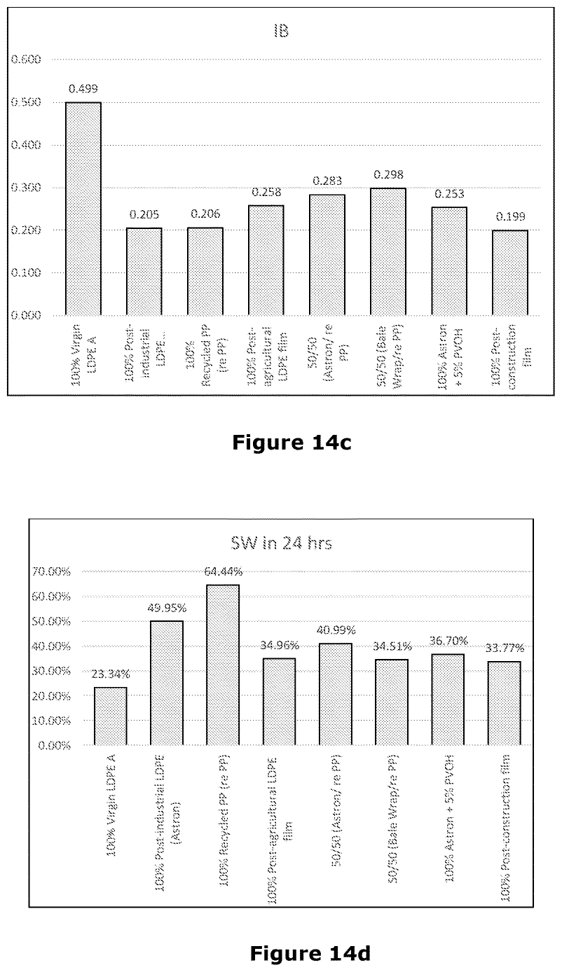

FIGS. 14a-14d show MoE, MOR, IB and 24 h swell results.

### Conclusions

The twin screw extruder torque and current data illustrate the binder processability for each treatment. The torque measured in the twin screw extruder reflects the shear force capable of inducing mixing within the TSE. Polymers with high melt flow index (MFI), like Virgin LDPE A and recycled PP, exhibit lower torque. The blending of polymers, specifically Astron/rePP and bale wrap/rePP, results in a reduction in torque when combined with the high MFI of recycled PP.

MoE and MoR indicated that all processed thermoplastic dispersions provided binder compositions with acceptable board properties. Post-industrial LDPE (Astron) exhibits good performance compared to other types of waste thermoplastic dispersions.

Virgin LDPE exhibited stronger composite boards. This is believed to be due to additives or contaminants in waste thermoplastics which interfere with binding properties of the cross-linker.

Internal bonding strength determines the binding between wood fiber and polymer binder. The four different waste polymer binders provided a similar internal bonding strength around 0.2-0.3 MPa.

Virgin LDPE A binder had 0.5 MPa in internal bonding strength which is twice greater than the waste thermoplastic polymer-based binder boards. This indicates that waste thermoplastics lose binding strength, potentially due to additives or contaminants.

The swelling rate observed over a 24-hour period in water indicates a significant propensity for water absorption in the recycled Polypropylene board. This swelling rate appears to be dependent on the moisture content of the board both before and during the preparation process. Interestingly, contrary to expectations, the board with lower initial moisture content exhibits a higher water absorption rate and swells more easily. The experimental results demonstrate that, with a moisture content of 9.14%, the recycled polypropylene board exhibited a swelling rate exceeding 60% within a 24-hour timeframe. Furthermore, both the 8% moisture content for Astron and the 9.53% moisture content for Astron/PP, which are considered low, demonstrated elevated swelling rates within a 24-hour period.

### Example 12—Optimisation of Binder Content in Wood Fibre Boards Using Recycled thermoplastic Dispersions

This example investigates various ratios of binder to cross-linker for the production of composite boards comprising wood fibre.

### Methodology

Thermoplastic dispersions were prepared in a twin screw extruder. Thermoplastic comprised Virgin LDPE B (MFI: 20 g/10 mins, 190° C.) with 5% PVOH (wt %) blended in the twin screw feed prior to emulsification to improve processability. Wood fibre board was formulated at 620 kg/m3 density.

TABLE 25
Temperature profile in Twin screw extruder
Temperature profile (°C)

| Z1 | Z2 | Z3 | Z4 | Z5 | Z6 | Z7 | Z8 |
|---|---|---|---|---|---|---|---|
| 100 | 100 | 140 | 140 | 140 | 95 | 95 | 95 |

TABLE 26
Composite board press parameters.

| Parameter | Board formulation |
|---|---|
| Density (kg/m³) | 620 |
| Press factor (mm/seconds) | 12 |
| Isocyanate content (wt %) | 20, 15, 10, 8, 6 |
| Binder content (wt %) | 15, 10, 8 |

Binder ratio and isocyanate (eMDI) content were varied to understand optimal ratios.

### Results

| | Wt % | Wt % | | Wt % | | | | |
|---|---|---|---|---|---|---|---|---|
| | Wood chip | Binder of | Wt % | eMDI of | | | Mean | Mean. |
| Sample | of composite | composite | eMDI | composite | Mean | Mean | IB | TS 24 h |
| name | mixture | mixture | of binder | mixture | MoE | MoR | (MPa) | (%) |
| 1 | 85 | 15 | 15 | 2.25 | 2120 | 13 | 0.89 | 11.10% |
| 2 | 85 | 15 | 10 | 1.5 | 2145 | 14.2 | 0.97 | 10.25% |
| 3 | 90 | 10 | 20 | 2 | 2311 | 14.7 | 1.19 | 11.05% |
| 4 | 90 | 10 | 15 | 1.5 | 2475 | 15.3 | 0.92 | 14.9% |
| 5 | 90 | 10 | 10 | 1 | 2250 | 13.4 | 0.81 | 18.5% |
| 6 | 92 | 8 | 8 | 0.64 | 2002 | 11.4 | 0.67 | 27.25% |
| 7 | 92 | 8 | 6 | 0.48 | 1902 | 10.3 | 0.54 | 34.2% |

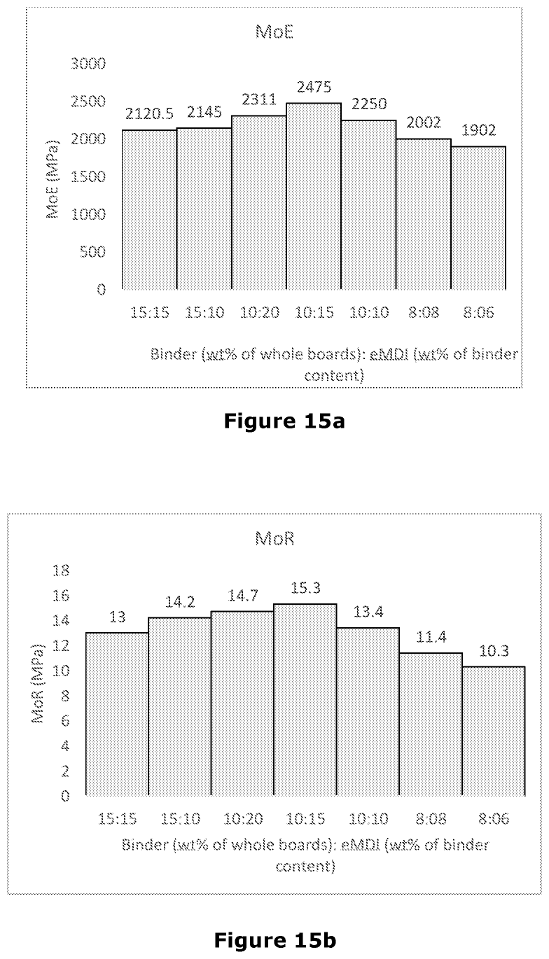

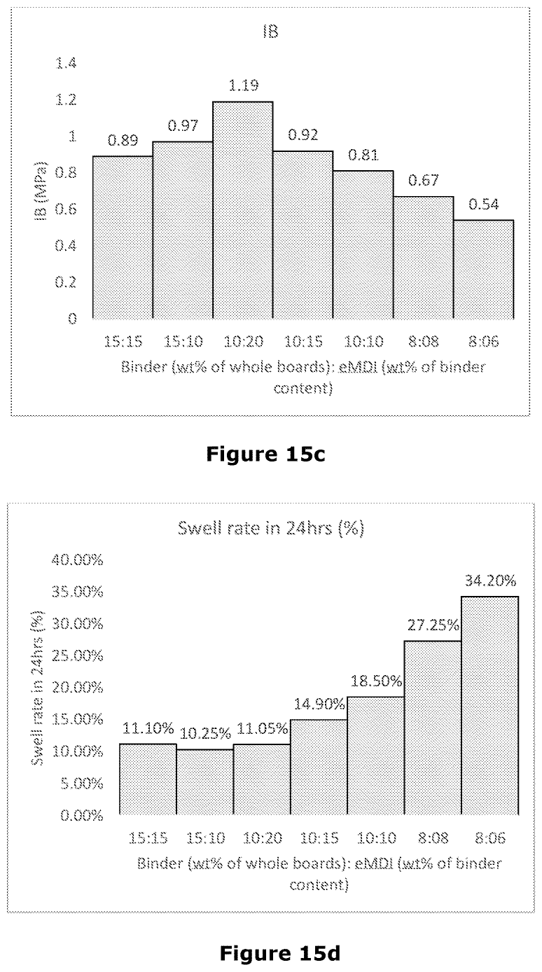

FIG. 15A shows variation of modulus of elasticity (MoE) across different board treatments.

FIG. 15b shows variation in modulus of rupture (MoR) across different board treatments.

FIG. 15c shows internal bonding strength (IB) across different board treatments.

FIG. 15d shows swelling rate (SB) in 24 hrs across different board treatments.

### Discussion

The results show that the high concentration of isocyanate (sample 4) provided best mechanical performance (MoE and MoR). This board comprised 90% by weight of lignocellulosic material. Thermoplastic dispersion and isocyanate mixing provided good dispersion throughout the board and resulted in high strength.

The internal bond strength is determined by the interaction between the lignocellulosic fibres and the binder comprising thermoplastic dispersion. The optimal performance, with a strength of 1.19 MPa, was achieved with 10% binder and 2% isocyanate. The relatively high content of the isocyanate enhances the adhesion between the wood fibre and the binder.

The swell rate of wood particle board is dependent on the wood chip content. FIG. 15d shows that increased wood chip content and decreased binder leads to increased swell rate. This is partly due to the binder providing reduced porosity and therefore increased water resistance within the board. Isocyanate content was a significant contributor to mechanical strength of boards.

1. A method of producing a thermoplastic binder comprising obtaining a processed thermoplastic as
1. a functionalised thermoplastic, the functionalised thermoplastic having been processed by substantially melting a thermoplastic in an extruder to define an extruder melt zone, and reacting the thermoplastic with a coupling agent in the extruder,
2. a thermoplastic dispersion, the thermoplastic dispersion having been processed by substantially melting a thermoplastic in an extruder to define an extruder melt zone, and subsequently dispersing the thermoplastic in water under agitation in an extruder emulsification zone, or
3. a functionalised thermoplastic dispersion, the functionalised thermoplastic dispersion having been processed by
1. substantially melting a thermoplastic in an extruder to define an extruder melt zone,
2. reacting the thermoplastic with a coupling agent in an extruder to produce a functionalised thermoplastic, and
3. subsequently dispersing the functionalised thermoplastic in water under agitation in an extruder emulsification zone; and
subsequently adding a crosslinker to the processed thermoplastic to produce a binder, and wherein the binder does not comprise wood fibre.

2. A method of producing a thermoplastic composite product comprising:
providing a source of thermoplastic,
introducing the thermoplastic into an inlet end of one or more extruders,
within the one or more extruders, substantially melting the thermoplastic to define a melt zone,
wherein
a) at least a portion thereof of the thermoplastic is reacted with a coupling agent to produce a functionalised thermoplastic,
b) dispersing the thermoplastic in water under agitation to produce a thermoplastic dispersion, or
c) performing (a) and subsequently (b) to produce a functionalised thermoplastic dispersion; and
subsequently adding a crosslinker to the functionalised thermoplastic or thermoplastic dispersion, the cross linker being added to the extruder, or to the extruded functionalised thermoplastic or thermoplastic dispersion, to produce a binder, and
mixing the binder with a substrate in the form of a fibre to form a composite mixture and applying heat and pressure to the composite mixture in a press or mould to form a thermoplastic composite product.

3. (canceled)

4. (canceled)

5. (canceled)

6. The method of claim 1 wherein the source of thermoplastic comprises waste thermoplastic.

7. The method of claim 1 wherein the thermoplastic is subjected to a pre-processing step comprising
a) increasing the melt flow index of the thermoplastic,
b) washing the thermoplastic,
c) comminuting the thermoplastic to reduce the variance of a particle size of the thermoplastic,
d) standardisation of the particle size and/or density,
e) palletisation to a particle size of 2-8 mm, or
f) any combination of one or more of (a) to (e).

8. The method of claim 1 wherein the thermoplastic is subjected to a characterising step that analyses one or more physical property of the thermoplastic.

9. (canceled)

10. (canceled)

11. (canceled)

12. (canceled)

13. The method of claim 1 comprising the characterising step, and wherein the physical property of the thermoplastic is selected from the melt-flow index, melting point, viscosity, glass transition temperature, density, tensile strength or crystallinity of the thermoplastic.

14. The method of claim 1 wherein the coupling agent is selected from a grafting compatibiliser or a reactive hydrogen provider.

15. The method of claim 1 wherein the coupling agent is selected from glycidyl methacrylate, maleic anhydride, acrylic acid, glycidyl methacrylate, N-vinylformamide, bismaleimide or a silane.

16. (canceled)

17. The method of claim 1 wherein the thermoplastic is dispersed in water with the addition of a surfactant.

18. The method of claim 1, wherein the cross linker is selected from an organic peroxide or an isocyanate.

19. The method of claim 18 wherein isocyanate is added at 5% to 20% by weight of the binder.

20. (canceled)

21. (canceled)

22. (canceled)

23. The method of claim 1 wherein the moisture content of the binder is about 25% to about 75%.

24. The method of claim 1 wherein the emulsification zone comprises a dilution zone for the addition of further water, to obtain a ratio of thermoplastic to water of about 0.8:1 to 1.8:1.

25. The method of claim 2 wherein the binder and the substrate fibre are mixed in a mixer to form a substantially homogeneous mixture.

26. The method of claim 2 wherein the substrate fibre is selected from glass fibre, carbon fibre, aramid fibre, sawdust, wood fibre, wood particles, wood chips, wood sheets, coconut husk, rice straw or husk, barley straw, bamboo, and a combination thereof.

27. (canceled)

28. The method of claim 2 further comprising the step of forming a thermoplastic composite product, wherein the composite mixture has a moisture content of around 5% to around 15%.

29. The method of claim 1 wherein the plastic particles in the thermoplastic dispersion or the binder have a particle size of less than 0.5 mm in length in any orientation or axis.

30. (canceled)

31. (canceled)

32. (canceled)

33. The method of claim 2 in the manufacture of
a) a lignocellulosic thermoplastic composite product,
b) a synthetic fibre composite product, or
c) a concrete composite product.

34. The method of claim 2 in the manufacture of a lignocellulosic thermoplastic composite board having
a) a modulus of elasticity of between about 1,000 to about 4,000 MPa
b) a modulus of rupture of about 10 to about 25 MPa
c) a screw holding of about 200 to about 500 N
d) a density of about 550 to about 1,100 kg/m3, or
e) any combination of one or more of (a) to (d).

35. A composite board comprising:
a) waste thermoplastic;
b) lignocellulosic material; and
c) a cross-linker,
wherein the lignocellulosic material comprises at least 75% of the composite board.

36. The composite board of claim 35, wherein the cross-linker comprises an organic peroxide or isocyanate-based cross-linker.

37. The composite board of claim 35, wherein the waste thermoplastic comprises at least one of waste polyethylene or waste polypropylene.

38. The composite board of claim 35, wherein the composite board comprises at least one of the following:
a) MoR greater than 1000 MPa,
b) MoE greater than 8 MPa,
c) IB greater than 0.2,
d) moisture content of greater than about 5%, or
e) moisture content of less than about 15%.

39. (canceled)

40. (canceled)
